(19) United States
(12) Patent Application Publication
(10) Pub. No.: US 2011/0166998 A1
(43) Pub. Date: Jul. 7, 2011

(54) METHOD OF CAPTURING INTEREST ON THE VALUE OF TRANSFERRED MONETARY RIGHTS MANAGED ON AN INTERNET-BASED MONETARY RIGHTS TRANSFER NETWORK, AND ASSOCIATED WITH AN AMOUNT OF MONEY HELD IN AN ACCOUNT AND HAVING A MONETARY VALUE REPRESENTED ON A STORED VALUE DEVICE

(76) Inventor: Joseph H. Hardison, III, Darien, CT (US)

(21) Appl. No.: 12/987,255

(22) Filed: Jan. 10, 2011

Related U.S. Application Data
(63) Continuation of application No. 11/328,433, filed on Jan. 9, 2006, now abandoned.

(51) Int. Cl. G06Q 40/00

(52) U.S. Cl. 705/41; 705/39

(57) ABSTRACT

Method of capturing interest on the value of transferred monetary rights managed on an Internet-based Monetary Rights Transfer Network, and associated with an amount of money owned by an owner and held in a first account and having a monetary value represented on a stored value device held by a holder and provided by an issuer. While the owner of the amount of money earns an amount of interest on the value of the transferred monetary rights, and the amount of interest is deposited in a second account, the holder of the stored value device enjoys full use of the monetary value represented in the stored value device, and held in the first account represented by the non-transferred subset of monetary rights associated with the amount of money, including the right to make payments, the right to make purchases, and the right to hold money as a store of value.

### RELATED CASES

The Present application is a Continuation of copending application Ser. No. 11/328,433 filed Jan. 9, 2006, which is commonly owned by Interest Capturing Systems, LLC, and incorporated herein by reference as if fully set forth herein.

### BACKGROUND OF INVENTION

1. Field of Invention

The present invention relates to an Internet-based method of, and system for, enabling the customers of banks, brokerage firms, insurers and other financial institutions the freedom to exercise the rights they possess as holders of money so that they can optimize the utility and value of their money in the global financial marketplace.

2. Brief Description of the State of Knowledge in the Art

FIG. 1 is a schematic representation of the conventional “Uses of Money” where the “Specific Functions of Money” represent the general purposes of money in an economic framework. The “Specific Functions of Money” include all uses of money, from its inception to the present day, and define money's role in local, national and global economies; all economies using any form of money incorporate some and/or all of these functions in their use(s) of money.

FIGS. 2A and 2B, taken together, set forth a schematic representation illustrating the various conventional uses of/for money in the marketplace, including, but not limited to: purchasing and paying for goods and services, investing, earning interest, lending, borrowing, storing as value, and gifting.

FIG. 3 is a schematic representation illustrating the flow of money associated with conventional money transfer systems utilized in both physical money transfers and electronic money transfers in the global financial system. Money is transferred to another institution(s) and, at the end of the transfer period, the money and any accrued interest are transferred back to the owner of the money and/or the owner's bank or other financial institution.

Owners of money have many options from which to choose when selecting a bank or other type of financial institution for depositing (and subsequently investing) their money. Traditionally, owners of money usually choose their “home” financial institution based on physical location and on an institution's presence in their local market. “Home” bank(s) or financial institution(s) are defined as a customer's regular bank(s) or institution(s) where the customer maintains checking, savings, money market, credit/debit card accounts, etc., are maintained. Owners of money who choose to utilize financial institutions via the Internet do so primarily due to the inherent convenience and, due to the lower fees and the higher rates/yields offered by such institutions. Businesses and other entities choose their “home” institution(s) on location, services and products offered and, importantly, on borrowing capability. Rarely does either type of customer choose its “home” financial institution(s) based solely on the opportunity to optimize interest rates/yields paid on monies held by the institution(s) in either demand deposits, time deposits, or other types of accounts and products. Thus, the vast majority of financial institution customers are not maximizing the utility of the money they place in financial institutions.

Most financial institution customers assume (and rightfully so) that there is a tremendous amount of time and effort involved in first trying to ascertain where the opportunities exist to earn higher interest rates/yields on their money and, second, in actively transferring their money into and back out of those institutions' accounts and products to capture the higher rates offered. Several internet sites have aggregated financial information for consumers, with Bankrate.com (www.bankrate.com) being the most popular and oft-cited of these sites. Bankrate.com ranks financial institutions' on rates offered on/for various accounts and products (and on other criteria), and provides hyperlinks for, and toll-free phone numbers to, the listed institutions. However, Bankrate.com does not offer any transactional capability leaving all of the actual transfer work to the consumer. Several of the banks and institutions offering the higher interest rates/yields, like ING Bank, will facilitate transfers from a consumer's “home” bank(s) or institution(s) into accounts/products that offer better rates/yields. However, these banks and institutions only facilitate transfers from, and back to, the “home” institution(s). Furthermore, there is are time lags, ranging from a couple of days to longer, during which time the consumer is not earning interest on the transferred monies as they are deemed “in transit” and unavailable for use. Finally, Citibank offers a feature where customers can transfer, at regular intervals, monies from a checking account to a savings account or money market account, but Citibank limits the number of transfers and the amounts for set periods, and Citibank does not offer highly competitive interest rates for these accounts.

Due to the difficulties in finding better interest rates/yields and in transferring money, owners of money experience depositor/investor burnout (similar to mortgage burnout where mortgagees, after a certain period of time, cease searching for better mortgage rates, even though they exist in the marketplace, due to the amount of work involved) as they tire of seeking higher interest rates/yields and accept those, though almost always sub-optimal, offered by their “home” financial institution(s). Because of these factors, there is little incentive for the “home” financial institution(s) to offer highly competitive interest rates and yields for their accounts and products. As an example of this gross inefficiency in the financial marketplace, George Schaefer, Jr., President and CEO of Fifth Third Bancorp, told Reuters, when asked about Fifth Third's 2002 first quarter earnings, “When checking accounts are growing by 30% . . . and again, most of this is free money . . . but when we're getting good deposit growth, making those margins and spreads is a lot easier.” (Apr. 16, 2002).

This situation is only marginally better for wealthy individuals and institutional customers who may enjoy enhanced, but still sub-optimal, interest rates and yields on accounts and products offered by banks and other financial institutions. Through cash management, or “sweep”, accounts, financial institutions “sweep” customers' unused, available monies into other accounts and products that enable the customers to earn higher interest rates and yields on their monies than if those monies were left in a standard account/product. But even though these customers are considered more sophisticated than the average financial institution customer, recent evidence suggests that many financial institutions haven't been paying the appropriate (or advertised) rates on these accounts and products. (“Investors Get Shortchanged on Interest”, The Wall Street Journal, Feb. 15, 2005, p. D1 and “Savings: Sweep Yields Can Make You Weep”, Kiplinger's Personal Finance, May 2005, p. 92).

Many recent articles have highlighted the problems financial institution customers encounter when seeking higher interest rates/yields on their money. The article “Wall Street Cuts Yields on Investors' Cash” (The Wall Street Journal, Aug. 31, 2005, p. D1) states, “In a development that hurts investors, brokerage firms are quietly moving their clients' cash from money market mutual funds—the traditional default option—into lower-yielding bank accounts.” The brokerage firms are shifting their clients' monies into lower-yielding accounts at the same time the Federal Reserve is raising interest rates! This practice allows the brokerage firms to capture the widening interest rate differential at their own customers' expense.

Many systems have been designed to address the problems associated with freely transferring money. These range from systems that facilitate simple transfers of cash between parties, to complex systems consisting or electronic money systems (EMS) designed to transfer money electronically. Systems like Electronic Funds Transfer (EFT) and the Automated ClearingHouse (ACH) help to facilitate funds transfers between financial institutions, as they transmit funds electronically. However these systems are also inefficient as there are time lags when an owner of money does not have access to the transferred money and, thus, misses an opportunity to earn interest on the transferred money. There are also costs associated with these transfers (although some institutions will absorb these costs in order to attract funds) as many institutions charge large fees to accommodate outgoing funds transfers.

Finally, these electronic and automated systems share a common shortcoming which is best illustrated in U.S. Pat. No. 6,868,408 (Rosen) which discloses an Electronic Money System (EMS) in which banks and financial institutions use a “money generator device” to issue electronic money that is backed by demand deposits and electronic credit authorizations. Per Rosen, “an important aspect of the electronic currency is that it is the equivalent of bank notes and is interchangeable with conventional paper money through claims on deposits in an issuing bank, but can be withdrawn or deposited both at an issuing bank and at a correspondent bank.” Because the electronic currency envisioned in the Rosen patent “is the equivalent of money, is interchangeable with money and is fungible”, it suffers from the same major inefficiencies as other electronic money systems: it can only be in one place at any given point in time and can only be utilized for one purpose to the exclusion of all other possible uses of the money. So while these electronic and automated monetary transfer methods have greatly improved the speed and efficiency with which money can be transferred, they still have some major shortcomings, which have yet to be addressed in the global financial marketplace.

There have been many attempts, through new technologies, to address these financial industry shortcomings. A brief review of the following U.S. patents and Publications will provide a good overview of the state of knowledge in the art attempting to address the various problems recognized in the fields of finance, banking and investment management: U.S. Pat. No. 6,868,408 (Rosen), U.S. Pat. No. 6,609,113 (O'Leary, et al), U.S. Pat. No. 6,324,525 (Kramer, et al), U.S. Pat. No. 6,304,860 (Martin, et al), U.S. Pat. No. 6,240,399 (Frank, et al), U.S. Pat. No. 6,233,566 (Levine, et al), U.S. Pat. No. 6,112,189 (Rickard, et al), U.S. Pat. No. 6,049,782 (Gottesman, et al), U.S. Pat. No. 6,021,397 (Jones, et al), U.S. Pat. No. 5,933,817 (Hucal), U.S. Pat. No. 5,924,082 (Silverman, et al), U.S. Pat. No. 5,911,135 (Atkins), U.S. Pat. No. 5,852,811 (Atkins), U.S. Pat. No. 5,839,118 (Ryan, et al), U.S. Pat. No. 5,832,461 (Leon, et al), U.S. Pat. No. 5,297,026 (Hoffman), U.S. Pat. No. 5,082,275 (Nilssen), U.S. Pat. No. 4,751,640 (Lucas, et al), U.S. Pat. No. 4,507,745 (Agrawal), 20040153403 (Sadre), 20040044632 (Onn, Liav, et al), 30030236726 (Almonte, et al), 20030212641 (Johnson), 20030097331 (Cohen), 20030070080 (Rosen), 20020185529 (Cooper), 20020116331 (Cataline, et al), 20020091635 (Venkatachari, et al), 20020087461 (Ganesan, et al), 20020022966 (Horgan), and 20020013767 (Katz), each incorporated herein by reference as if set forth fully herein.

In addition to the problems individuals, businesses and other entities encounter in finding (and securing) higher interest rates and yields in the financial marketplace, there are other shortcomings in the financial marketplace which are not currently being addressed. Yet these shortcomings, like those already discussed, serve to rob consumers of additional interest that they could be earning on their money.

When a mortgagee make periodic mortgage payments to a mortgage holder or a mortgage service provider, these payments often contain monies for contingent obligations such as property taxes, property insurance, etc. However, many of these contingent obligations are not due at the time of the regularly scheduled mortgage payments, but are actually due at a future date allowing the mortgage holder or mortgage service provider to earn additional interest on monies held to pay the mortgagee's future obligations. Yet these monies, until paid out to satisfy the mortgagee's contingent obligations, legally belong to the mortgagee. So the mortgage holders and mortgage service providers are earning interest on monies that do not legally belong to them.

Similar to the aforementioned mortgage problem, many employees have monies regularly withheld from their periodic paychecks to make payments for other obligations including taxes (Social Security, federal, state and local), insurance (health, dental, life, legal), and other benefits obligations. These withheld monies are either held by an employer or, as is often the case, this process is subcontracted out to a payroll service provider that will collect the monies and make the employee's benefits, tax and other payments in a timely manner. However, as is the case in the mortgage problem, many of these payments are not due at the time they are withheld from an employee's paycheck, but instead are due at some future date. This allows an employer or a payroll service provider to earn interest on these monies, which still legally belong to the employee, until they are ultimately disbursed to satisfy the employee's obligations. So the employee is losing all of the potential interest income on these monies.

When consumers, businesses or other entities (collectively consumers) make payments for goods and services they often remit payment for these goods and services ahead of the actual “payment due date” on a bill or invoice. By paying early, consumers provide the payment recipient with extra time to earn interest on these monies. Yet, even by utilizing electronic bill payment (EBP), a consumer cannot always gain assurance that payment will be effected on the “payment due date” and thus assuring that the consumer can earn interest on those monies until the last possible moment.

Also, when consumers purchase stored value cards or products (gift cards, prepaid cards, etc.) the consumer effects payment to the seller of the stored value card at the time of purchase. However, many stored value cards are not utilized for long periods after they are purchased. Some are lost or forgotten, and many are simply never redeemed or are only partially redeemed. In all of these instances, the seller of a stored value card has use of the purchaser's money on which the seller can earn interest, even though the value stored on a card or other product may not be utilized for a long time or may never be fully utilized. Irrespective of the circumstances behind the delayed usage or under usage (to any degree) of a stored value product, the buyer is surrendering to the seller the ability to earn additional interest even though the value stored on may not be immediately (or never) utilized.

Another problem that exists in the financial marketplace involves physical and electronic money transfers from “home” financial institutions to other “external” institutions that may offer higher interest rates and/or yields for various accounts and products. Once a financial institution customer decides to effect a physical or electronic funds transfer (EFT), the “home” financial institution(s) has no means of immediately offering higher interest rates and/or yields to entice a customer to maintain its funds in the “home” financial institution's account(s)/product(s) and preclude a funds transfer to an “external” financial institution. Yet, given the opportunity, many financial institutions would welcome the opportunity to improve interest rates and/or yields offered to avoid losing a customer's funds and possibly, to avoid losing the customer altogether. Furthermore, many financial institution customers would welcome to opportunity to avoid transferring their funds to another institution if their “home” institution(s) could improve interest rates and/or yields offered for various accounts and products.

Even though many foreign institutions, due to their countries' domestic monetary policies, offer higher interest rates/yields for various accounts and products, U.S. consumers have no easy way to transfer their monies abroad to capture these higher rates and yields. Furthermore, short of exotic derivatives transactions, foreign money transfers involve physically or electronically transferring funds to foreign institutions. However, in effecting such foreign funds transfers, consumers are undertaking a myriad of risks they do not experience domestically. Some of these risks include: sovereign risks, foreign tax policy idiosyncrasies, deposit insurance thresholds, minimum account balances, funds transfer delays, money laundering suspicions, etc. After taking into account the time, costs and risks associated with a foreign funds transfer, many consumers decide it's not worth their time and effort to undertake a foreign transfer.

In view of all of the aforementioned shortcomings, deficiencies and inefficiencies that exist in the local, national and global financial marketplaces, there is still a great need in the art for an improved system and methods for solving the problem(s) of surrendered interest-capturing opportunities while avoiding the shortcomings and drawbacks of the prior art apparatus and methodologies heretofore known.

### OBJECTS AND SUMMARY OF THE INVENTION

Accordingly, it is a primary object of the present invention to provide a method of and system for solving the inefficiencies of prior art financial systems, while avoiding the shortcomings and drawbacks of the prior art apparatus and methodologies.

Another object of the present invention is to achieve this objective by providing an Internet-based method of and system which inherently recognizes the separate and transferable rights associated with money (cash) ownership, thereby enabling the maximization of economic value that such personal property can support within society.

Another object of the present invention is to provide such an Internet-based method and system, wherein the rights that customers of banks, brokerage firms, insurers and other financial institutions possess as owners, holders (fiduciary), and borrowers of money are automatically unbundled (i.e. individually separated) and ready to be transferred to other institutions offering more attractive financial terms in an effort to optimize the utility and economic value of their money.

Another object of the present invention is to provide such an Internet-based method and system, wherein the customers of financial and non-financial institutions are afforded the opportunity to freely transfer the rights they possess as owners, holders (fiduciary), and borrowers of money (e.g. the right to earn interest (R (β, $)), between various institutions and also within their own institutions, so as to take advantage of better rates and yields.

Another object of the present invention is to provide such an Internet-based method and system, wherein, in situations where other entities collect monies for future payments on behalf of an individual or business, the rightful owner of the money is able to benefit from the transfer and/or use of such monetary rights until such payments are effected.

Another object of the present invention is to provide such an Internet-based method and system, wherein one (or more) of the monetary rights associated with owning, holding and/or borrowing money can be transferred in a financial marketplace so as to assure that individuals, businesses and other entities do not violate the minimum deposit/account requirements imposed by financial institutions.

Another object of the present invention is to provide such an Internet-based method and system, wherein accountholders at banks and within other financial institutions can manually or automatically transfer monetary rights without violating the minimum deposit requirements imposed by such banks and/or financial institutions.

Another object of the present invention is to provide such an Internet-based method and system, wherein the monetary right to earn interest (R (β, $)) can be transferred easily and automatically among institutions belonging to the financial network of the present invention, and offering higher interest rates or innovative products.

Another object of the present invention is to provide such an Internet-based method and system, wherein an employee is able to transfer the monetary right to earn interest (R (β, $)), associated with the actual money being held by a payroll service provider, to any institution offering higher interest rates until such time as the payroll service provider effects payment(s) on the employee's behalf.

Another object of the present invention is to provide such an Internet-based method and system, wherein a payroll service provider can hold the subset of rights {R (α . . . ι, $)−R (β, $)} the actual monies to facilitate timely payments on behalf of the employee.

Another object of the present invention is to provide such an Internet-based method and system, wherein as the payroll service provider pays out the monies, the transferred monetary right(s) are reduced commensurately and ultimately cancelled when all of the underlying money has been paid out on behalf of the employee.

Another object of the present invention is to provide such an Internet-based method and system, wherein consumers and businesses are able to transfer only the right to earn interest (R (β, $)) associated with holding their monies to any institution offering higher interest rates until such time as the mortgage servicer effects payment(s) on the consumer's or business's behalf.

Another object of the present invention is to provide such an Internet-based method and system, wherein consumers, businesses and other institutions are able to freely transfer their monetary rights to any other institution, in order to perpetually seek out optimal, and/or higher, rates of interest available in the markets.

Another object of the present invention is to provide such an Internet-based method and system, wherein in lieu of transferring actual monies, consumers have the ability to make transfers of the right to earn interest (R (β, $)) on their monies, which constitutes a transfer of the right to earn interest possessed by the owner, holder (fiduciary), or borrower of money without the actual transfer of the monies, and yet still receive all of the benefits and protections such as deposit insurance that accompany the rights to those monies.

Another object of the present invention is to provide such an Internet-based method and system, wherein customers have the ability to specify other important factors when seeking those rates such as: credit quality/rating of an institution, various types of deposit insurance available, size of the institution, location of the institution, duration of deposit or investment, size of the deposit or investment, type of instrument or account, minimization of penalties or fees for early or partial withdrawals, minimization or elimination of minimum required balances at both the “home” bank or institution and at the bank or institution to which those funds are transferred, tax minimization (where applicable), type of funds/monies transferred (personal, business, retirement, educational, charitable, investment, savings, escrow, religious, government, foreign, funds and monies of other financial institutions and non-financial institutions).

Another object of the present invention is to provide such an Internet-based method and system, wherein any subset of the entire set of monetary rights {R (α . . . ι, $)} possessed by an owner, holder or borrower of money, and all rights associated with money, can be transferred among institutions within a global financial marketplace, including: the right to invest, the right to earn interest, the right to use money as collateral, the right to use money as security (store of value), the right to make purchases, the right to make payments, the right to lend, the right to borrow and, the right to gift.

Another object of the present invention is to provide such an Internet-based method and system, wherein the various rights associated with money are recognized individually, unbundled and separated, and then transferred individually or in groups that comprise a fraction of the total bundle of rights and, that allow a holder of those rights to maximize their utility and thus the utility of money.

Another object of the present invention is to provide such an Internet-based method and system, wherein the set of rights associated with money (R (α . . . ι, $)) possessed by a holder of money, are separate and divisible, and such individual rights can be more fully utilized in separate form such that the system user derives greater utility from money.

Another object of the present invention is to provide such an Internet-based method and system, wherein the set of rights possessed by a holder of money can be utilized in non-mutually exclusive manners and, by not precluding other associated rights, allows a system user to fully maximize the use of monies held.

Another object of the present invention is to provide such an Internet-based method and system, wherein one (or more) of the rights associated with holding money can be transferred by a system user, while simultaneously allowing the system user to derive the associated benefits and uses from the remaining rights that have not been transferred, thereby permitting some of the rights of money that have been transferred to be reduced or cancelled while/when certain other rights are being exercised.

Another object of the present invention is to provide such an Internet-based method and system, wherein a system user is allowed to automatically transfer various rights associated with money whereby a system user provides pre-selected investment criteria, objectives and instructions, and the system effects transfers accordingly.

Another objective of the system and methods of the present invention is to allow users to transfer only the right to earn interest (R (β, $)) possessed by a holder of money in order to obtain higher interest rates and/or higher yields than those offered by the user's “home” financial institution(s).

Another object of the present invention is to provide such an Internet-based method and system, wherein system users can transfer the right to earn interest on monies held between “external” institutions that have no connection to the user's “home” institution.

Another object of the present invention is to provide such an Internet-based method and system, wherein system users can establish and modify separate networks of institutions to which they would like to transfer one or more of the monetary rights associated with owning, holding or borrowing money.

Another object of the present invention is to provide such an Internet-based method and system, wherein such a network of institutions might consist only of institutions pre-chosen by the system user to supply interest rates, yields and other information about accounts and products they offer.

Another object of the present invention is to provide such an Internet-based method and system, wherein all participating institutions (financial and non-financial) are allowed to provide information concerning interest rates, yields and other information about accounts and products offered directly to the system of the invention's database for ranking, and other, purposes in order to better inform users of the system about all potential transfer opportunities.

Another object of the present invention is to provide such an Internet-based method and system, wherein all participating institutions feed, directly, interest rate, yield, and other product information into a database maintained by the system, for the purpose of allowing the system of the invention to recommend certain accounts and products to users of the system.

Another object of the present invention is to provide such an Internet-based method and system, wherein a process allows the system to rank various accounts and products for a system user's benefit under criteria that may differ vastly from that employed by a system user.

Another object of the present invention is to provide such an Internet-based method and system, wherein institutional users are provided with a means, either automatic or manual (or variations thereof), for accessing the universe of participating institutions' accounts and products thereby insuring that they fulfill their fiduciary duty to their investors who seek the highest available interest rates/yields.

Another object of the present invention is to provide such an Internet-based method and system, wherein financial institutions and any investment entity holding a fiduciary responsibility have the capacity to fulfill their obligations to their investors by seeking better financial (or other) terms, thereby reducing potential legal liability associated with failure to fulfill attendant fiduciary responsibilities and obligations.

Another object of the present invention is to provide such an Internet-based method and system, wherein users can establish and rank criteria which they deem important in making an investment decision including, but not limited to, interest rates, yields, credit ratings, products, fees, penalties, taxes, length of investment, required minimum balances, deposit insurance provided, etc.

Another object of the present invention is to provide such an Internet-based method and system, wherein a system user has the ability to program the system to make automatic transfers of one or more of the monetary rights associated with owned, held or borrowed money based on pre-specified criteria provided by the system user.

Another object of the present invention is to provide such an Internet-based method and system, wherein under such a scenario, the system user can rank the aforementioned criteria in order of importance, and the system and methods of the invention would make automatic monetary right(s) transfers on the user's behalf whenever the pre-specified criteria are met, thereby allowing a system user to set all of the parameters of a right(s) transfer and then allow the system to make such transfer automatically.

Another object of the present invention is to provide such an Internet-based method and system, wherein a system user has the option to rely solely on automatic transfers conducted by the system based on the criteria established as having priority by the system.

Another object of the present invention is to provide such an Internet-based method and system, wherein another separate set of investment alternatives are provided for a system user and, which, may vary greatly from the criteria and investment choices deemed important by a system user.

Another object of the present invention is to provide such an Internet-based method and system, wherein a system user would still be able to establish one or more important criteria and then allow the system to take over and operate based on the limited criteria provided by a system user.

Another object of the present invention is to provide such an Internet-based method and system, wherein a bank or financial institution that currently holds all of a customer's rights associated with monies held in that institution (“home” bank), and that may not want to forfeit or lose to transfer one or more of those rights (expressly the right to earn interest on monies held by a system user), would have the “right-of-first-refusal” on a customer's monetary right to earn interest (or other rights) which would enable the “home” bank to improve on rate(s), yield(s) or term(s) offered or, to match or beat the rate(s), yield(s) or term(s) offered by competitors.

Another object of the present invention is to provide such an Internet-based method and system, wherein the duration of the “right-of-first-refusal” can be dictated by the customer, as can the terms that will preclude a transfer of a system user's monetary right(s).

Another object of the present invention is to provide such an Internet-based method and system, wherein if the “home” bank fails to meet the user's criteria then the system will automatically effect a transfer on behalf of the system user.

Another object of the present invention is to provide such an Internet-based method and system, wherein this process allows the user's “home” bank(s) and/or institution(s) to compete to keep all of a customer's monetary rights in their institution.

Another object of the present invention is to provide such an Internet-based method and system, wherein a system user can automatically reduce or cancel transfers of monetary right(s) in a one-step process.

Another object of the present invention is to provide such an Internet-based method and system, wherein should a system user decide to change the terms of an existing transfer of one or more monetary rights, the system user can notify the system which will automatically contact each institution where the user's monetary right(s) resides and notify each institution of the user's desired change.

Another object of the present invention is to provide such an Internet-based method and system, wherein its users can transfer the monetary right to earn interest internally, within their “home” bank(s), in an effort to earn higher interest rates and yields than those offered by the account(s) in which they presently hold their monies.

Another object of the present invention is to provide such an Internet-based method and system, wherein system users are allowed to transfer the monetary right to earn interest associated with their monies held into accounts and products that offer better financial terms than those accounts and products where their monies currently reside.

Another object of the present invention is to provide such an Internet-based method and system, wherein its users can effect demand transactions on accounts at their “home” bank(s) while simultaneously transferring the right to earn interest on those monies backing the demand transactions, i.e. by reducing or canceling the transferred monetary right(s) to earn interest commensurate with the amount of any demand transaction, thereby allowing the user to maximize the utility of money held. Such transactions include those involving a debit card, any transaction involving a checking account, ATM withdrawal transactions, physical withdrawals transactions, and any and all other demand transactions.

Another object of the present invention is to provide such an Internet-based method and system, wherein full tax documentation is provided to a system user regarding any interest earned via the transference of the right to earn interest on monies held.

Another object of the present invention is to provide such an Internet-based method and system, wherein system users can earn interest on their monies held by payroll benefits providers, mortgage service providers, and other intermediaries that might hold the system user's monies in order to make future payments on the user's behalf.

Another object of the present invention is to provide such an Internet-based method and system, wherein the legal owners of these monies are allowed to unbundle the right to earn interest and transfer it, via the system, to another financial institution in order to earn the highest possible interest rate or yield until the actual payments are effected by a payroll service provider or by a mortgage service provider.

Another object of the present invention is to provide such an Internet-based method and system, wherein at the time a payment is made on a system user's behalf, the amount of the transferred right to earn interest is reduced or cancelled commensurately, thereby assuring that the actual monies always stay with the payor and, that the interest earned on these monies accrues to the legal owner of those monies.

Another object of the present invention is to provide such an Internet-based method and system, wherein system users are able to seek higher yields and interest rates through accounts and products offered by foreign financial institutions.

Another object of the present invention is to provide such an Internet-based method and system, wherein users can transfer the right to earn interest on the system user's money to a foreign bank and at the same time providing the currency conversion to facilitate such transfer. When the transferred interest rights are ultimately reduced or cancelled, the system and method provides a means for converting the foreign currency-denominated interest rights back to U.S. dollars and converting back to U.S. dollars the accrued interest on those rights which is also denominated in foreign currency.

Another object of the present invention is to provide such an Internet-based method and system, wherein consumers, businesses and other institutions are enabled to freely transfer their monetary right to earn interest associated with holding money between various institutions or even intra-institution for the purpose of obtaining higher yields, greater safety, lower fees and increased transparency in a financial infrastructure.

Another object of the present invention is to provide such an Internet-based method and system, wherein consumers, businesses and all financial system participants are afforded the opportunity to transfer one or more monetary rights associated with holding money (R (α . . . ι, $)), via their demand deposits, time deposits, and other monies held as cash or in investment accounts at their “home” bank(s) or financial institution(s), to other institutions, or within their own institution, for the purpose of earning higher interests rates on their monies.

Another object of the present invention is to provide such an Internet-based method and system, wherein participants can utilize the system to transfer their monetary right to earn interest (R (β, $)) (and/or other rights), as frequently as every day (or even intra-day), to other financial or non-financial institutions that afford consumers and businesses the opportunity to earn higher interest rates on their monies than the consumer's or business's “home” bank pays on those same monies.

Another object of the present invention is to provide such an Internet-based method and system, wherein a customer's monetary right to earn interest (R (β, $)) can be transferred freely, either manually or automatically, through either user choices, user-predetermined choices or choices selected by the system and methods of the invention, between accounts of different financial and non-financial institutions constantly seeking higher interest rates and yields for different accounts and products.

Another object of the present invention is to provide such an Internet-based method and system, wherein consumers, businesses, and any and all entities have the ability and opportunity to transfer their monetary right to earn interest (R (β, $)) possessed by owning, holding, or borrowing money, automatically or through pre-determined choices, inter-institution and/or intra-institution to optimize rates of return on their monies.

Another object of the present invention is to provide such an Internet-based method and system, wherein consumers, businesses and other parties (charities, government entities, trusts, pension funds, investment funds, individual retirement accounts (IRA's), church organizations, insurers, brokerage firms, banks, savings and loans, educational institutions, etc.) are given a way of and means for unbundling the monetary rights associated with holding money (R (α . . . ι, $)), and transferring these monetary rights so as to earn interest (R (β, $)) associated with their money outside of their “home” (or own) banking institution to other institutions, or transferring R (β, $) within their “home” financial institution(s) in effort to seek higher rates of interest on their monies over any time period.

Another object of the present invention is to provide such an Internet-based method and system, wherein consumers, business and all others financial market participants have the ability to utilize system-selected investment opportunities and the system automatically transfers the participant's monetary right to earn interest (R (β, $)) based on system-selected or user-selected criteria.

Another object of the present invention is to provide such an Internet-based method and system, wherein consumers, businesses, financial institutions, and any other potential users of the system, are given the ability to segregate their monetary right to earn interest (R (β, $)), and for that monetary right to be automatically redirected from a “resident” account(s) to any other account or instrument, offered by any institution, offering a higher rate of interest or yield over any time period.

Another object of the present invention is to provide such an Internet-based method and system, wherein consumers are provided the opportunity to automatically, and instantaneously, transfer their monetary right to earn interest (R (β, $)) either to like instruments of structure and duration or to instruments of completely different structure and duration.

Another object of the present invention is to provide such an Internet-based method and system, wherein consumer participants are provided the opportunity to choose between federal and state insured interest-bearing instruments and non-insured instruments, for the purpose of seeking optimal return(s) on invested monies.

Another object of the present invention is to provide such an Internet-based method and system, wherein the user can opt for system-selected investment opportunities whereby the system will automatically transfer a user's monetary right to earn interest (R (β, $)) either to various financial institutions or within the user's “home” institution(s) for the purpose of seeking higher interest rates and/or more optimal accounts/terms for the user's monies.

Another object of the present invention is to provide such an Internet-based method and system, wherein the users are automatically notified of any transfer of monetary rights (R (β, $)), and for users to establish networks consisting of user-chosen institutions to which to transfer their monetary right to earn interest (R (β, $)).

Another object of the present invention is to provide such an Internet-based method and system, wherein a user's right to earn interest (R (β, $)) can be simultaneously transferred to multiple institutions in amounts that fully qualify for all federal, state and private deposit insurance.

Another object of the present invention is to provide such an Internet-based method and system, wherein participants are provided with the ability to continually shift their monetary right to earn interest (R (β, $)) to accounts that are federally or state insured, so there is no increase in risk to a participant's monetary right to earn interest (R (β, $)) that is transferred via the invention. Banks and other financial institutions will be encouraged to pay interest on more accounts and products, and in the cases where they already pay interest, they will be encouraged to increase the interest they pay on those accounts and products, provided that they want to maintain their customers' monies. Again the consumer/business is the beneficiary.

Another object of the present invention is to provide such an Internet-based method and system, wherein the monies (monetary right(s)) of consumers and businesses are no longer “locked-up” by banks, so that the consumers and businesses can receive higher rates of interest on their invested monies.

Another object of the present invention is to provide such an Internet-based method and system, wherein consumers are allowed to dictate terms to the banks or financial institutions, thereby allowing consumers to automatically avoid those institutions that charge fees greater than the federally mandated minimum withdrawal penalty, and other penalties, on certain investment products and accounts.

Another object of the present invention is to provide such an Internet-based method and system, wherein relational databases automatically receive rate feeds from all participating institutions, rank them by a number of different standards (yield, credit rating, penalties for early withdrawals, etc.), and display the optimal interest rates and financial terms according to the user's preferences, the system's preferences or, which are offered by participating institutions.

Another object of the present invention is to provide such an Internet-based method and system, whereby early withdrawal fees are curtailed as more financial institutions adopt the system and method for awarding their existing customers, and potential new customers, higher interest rates with reduced associated costs.

Another object of the present invention is to provide such an Internet-based method and system, wherein customers are provided with a choice of selecting their own types of investments and institutions to which to transfer their monetary right to earn interest (R (β, $)) or, of using system-selected investments utilizing pre-determined criteria established either by the customer and/or by the system.

Another object of the present invention is to provide such an Internet-based method and system, wherein it is a primary goal of the system to level the playing field between consumers and businesses, and the banks and financial institutions to whom they entrust their monies, by allowing the banks' and financial institutions' customers to earn optimal rates of interest on their invested funds by allowing for the separation of the individual rights possessed by an owner, holder (fiduciary) or borrower of money. Consumers and businesses, for various reasons, leave money in unproductive or sub-optimal interest-bearing accounts, which allow the bank or financial institution to earn interest on these monies while paying sub-optimal interest rates or zero interest to the customer.

Another object of the present invention is to provide such an Internet-based method and system, wherein consumers and businesses are given the ability to transfer their monetary right to earn interest (R (β, $)) between accounts offered by their “home” financial institution(s) in order to seek higher interest rate-bearing instruments and accounts.

Another object of the present invention is to provide such an Internet-based method and system, whereby the customers of banks and financial institutions (including managers of money market funds and others with fiduciary responsibilities) are given the opportunity to transfer the monetary right to earn interest (R (β, $)) on a daily (or intra-day basis) to higher-yielding accounts and investment instruments among those offered by the “home” institution, thereby encouraging the “home” financial institution (i) to allow the customer to automatically transfer the monetary right to earn interest (R (β, $)), when desired, to higher-yielding accounts and instruments internally or possibly suffer the loss of the customer or of the customer's funds, or (ii) match the higher rates available to the customer externally or risk losing the customer and/or the customer's monies to invest.

Another object of the present invention is to provide such an Internet-based method and system, wherein the customer (account holder) can transfer only its right to earn interest (R (β, $)) that exceeds, for demand and time accounts, an account's minimum required balance, thereby assuring that the participant's account remains in good standing and is not subjected to any penalties which may be levied on accounts in which the balance falls below the minimum required balance.

Another object of the present invention is to provide such an Internet-based method and system, wherein the customer (accountholder) can transfer the entire set of monetary rights associated with holding money (R (α . . . ι, $)) out of an account at its “home” financial institution and still maintain that account at the “home” financial institution.

Another object of the present invention is to provide such an Internet-based method and system, wherein customers of brokerage firms, insurers, banks and other financial institutions (and non-financial institutions) are provided with the ability to automatically transfer their monetary right to earn interest (R (β, $)) associated with monies held in interest-bearing mutual funds or money market funds and accounts outside those mutual funds or investment capital pools. Many banks, brokerage firms, insurers and mutual fund companies offer funds in which investors earn interest rates based on the type of instruments held in a particular fund. An example would be a short-term government bond fund or a money market fund in which consumers, businesses and other entities invest. Some funds, due to the instruments held or fees charged, are able to deliver higher returns than funds that hold similar or even identical instruments; the difference can result from purchase price, holding period, management fees, marketing fees, etc. It is an objective of the invention to allow users of the system to manually or automatically transfer their monetary right to earn interest (R (β, $)) within various funds or, out of the funds and into higher-yielding accounts at other institutions or even within the same institution. There is no reason a customer of any financial institution (or non-financial institution) should not be able to earn optimal rates of interest on monies invested or deposited.

Another object of the present invention is to provide such an Internet-based method and system, wherein businesses and other entities have the ability to automatically transfer their monetary right to earn interest (R (β, $)) within their “home” financial institution. There are many reasons why a customer of a financial institution, or an investor in a mutual fund or other investment pool, may desire to transfer one or more of their monetary rights within the “home” institution, including: loyalty, safety, equity interest(s) (stock ownership), investment and/or credit ratings, maintaining financial relationships with the same institution, etc.

Another object of the present invention is to provide such an Internet-based method and system, wherein depositors of any type can automatically transfer the monetary right to earn interest (R (β, $)) yet still maintain full deposit insurance, regardless of the type of deposit insurance or institutions involved.

Another object of the present invention is to provide such an Internet-based method and system, wherein depositors can automatically transfer the monetary right to earn interest (R (β, $)) while at the same time maintaining enough money in the “home” bank account(s) to satisfy minimum deposit requirements to avoid paying any type of penalty for falling below the minimum deposit balance threshold.

Another object of the present invention is to provide such an Internet-based method and system, wherein government entities are provided with a “window” to monitor the transfers of the monetary right to earn interest (R (β, $)) within the system to prevent any type of illicit transfers, money laundering or terrorist funding activities.

Another object of the present invention is to provide such an Internet-based method and system, wherein a customer's monetary right to earn interest (R (β, $)) is transferred between any two or more institutions and, even intra-institution, based on system-provided options or on the customer's pre-selected criteria.

Another object of the present invention is to provide such an Internet-based method and system, wherein the system automatically notifies both the “home” institution and the “external” or destination institution(s) of the customer's desired transfer(s), and at that point, the “home” institution transfers the right to earn interest associated with holding money (R (β, $)) to the destination institution(s) in the required amounts and for the required time periods as chosen by the customer or the system, but never transferring the actual funds/currency, but only the monetary right to earn interest (R (β, $)) associated with those monies.

Another object of the present invention is to provide such an Internet-based method and system, wherein customers can avoid paying any fees and charges associated with actual money transfers while still deriving the benefits of higher rates offered by other institutions.

Another object of the present invention is to provide such an Internet-based method and system, that obviates the need for an actual recall/transfer back of needed funds, as the actual funds, less any transferred monetary right(s), are already held by the “home” institution.

Another object of the present invention is to provide such an Internet-based method and system, wherein in the event of the need for a reduction or cancellation of the transfer of the right to earn interest, the system immediately reduces or cancels the “external” institution's access to this right (R (β, $) and notifies both the customer and appropriate taxing authorities of interest earned on transferred right to earn interest (R (β, $)) for reporting purposes. Transfers of R (β, $)) receive full deposit insurance and other protections provided by the institution(s) receiving the right to earn interest (R (β, $)) associated with the system user's monies and investments.

Another object of the present invention is to provide such an Internet-based method and system, wherein there is no period during which the user's monies are not earning interest.

Another object of the present invention is to provide such an Internet-based method and system, wherein a customer can request, in one process, that all transferred monetary right(s) to earn interest (R (β, $)) held at “external” institutions be immediately cancelled thus restoring full interest-earning rights to the customer's remaining subset of monetary rights {R (α . . . ι, $)−R (β, $)} at the “home” institution or intermediary.

Another object of the present invention is to provide such an Internet-based method and system, wherein a consumer can request that the monetary value of a transferred monetary right to earn interest (R (β, $)) be automatically reduced when the customer writes a check on, or makes any type of withdrawal from or demand on, the account(s) at the “home” bank(s) such that the remaining balance would be insufficient to meet minimum deposit requirements or in the event an overdraft would occur.

Another object of the present invention is to provide such an Internet-based method and system, wherein consumers and businesses have the ability to earn interest on monies paid into escrow accounts and collected for tax payments, insurance payments, social security payments and other payments collected from a system user for future disbursement by the collector.

Another object of the present invention is to provide such an Internet-based method and system, wherein account holders (users) can easily establish a network or networks of participating institutions for the purpose of transferring the monetary right to earn interest (R (β, $)) of consumers, businesses and any and all other entities, between participants to allow their customers to obtain optimal rates of interest on any monies held within those institutions.

Another object of the present invention is to provide an Internet-based method of, and system for, representing and accounting for the monetary right to earn interest (REI) (R (β, $)) held of consumers, businesses and any and all other entities, and the transfers of such REIs among a network of financial institutions registered to deliver financial products and/or services with interest-capturing services (ICS) provided by the Internet-based system and method of the present invention.

Another object of the present invention is to establish a network or networks of participating institutions, wherein the network comprises two or more institutions facilitating the transfer of the monetary right to earn interest (R (β, $)) associated with monies held by a system user.

Another object of the present invention is to provide an Internet-based method of, and system for, representing and accounting for the monetary right to earn interest (REI) (R (β, $)) held of consumers, businesses and any and all other entities, and the transfers of such REIs among a network of financial institutions registered to deliver financial products and/or services with interest-capturing services provided by the Internet-based system and method of the present invention,

Another object of the present invention is to allow participating financial institutions to trade the various monetary rights between themselves.

Another object of the present invention is to provide a transparent earned interest “netting” process by which participating financial institutions net settle earned interest (Cash ($)) on transferred monetary rights between themselves as opposed to remitting individual cash amounts representing earned interest on accountholders' individual right(s) transfers.

Another object of the present invention is to provide a transparent “netting” process to accountholders so that they always know in which institutions' accounts and products their money and their monetary rights reside at all times.

Another object of the present invention is to provide individual products, to users/accountholders within the MRTS Network, which utilize the various monetary right(s) transfer processes described herein. Examples would include: checking accounts, debit and credit cards, stored value products, ATM products, and other financial accounts and products, which can be more productive by utilizing (or embedding) various iterations of the monetary right(s) transfer processes.

These and other objects of the present invention will become more apparent from the descriptions and drawings contained herein, and are, by no means, confined or limited by other improvements or advantages that may be realized.

### BRIEF DESCRIPTION OF THE DRAWINGS

In order to understand more fully the Objects of the Invention, the following Detailed Description of the Illustrative Embodiments should be read in conjunction with the appended figure drawings, wherein:

FIG. 1 is a schematic representation of the conventional “Uses of Money” where the “Specific Functions of Money” represent the general purposes of money in an economic framework, while the “Set of Rights Possessed by a Holder of Money” represents the different rights or uses attendant with holding money;

FIGS. 2A and 2B, taken together, set forth a schematic representation illustrating the various uses money in the marketplace, including purchasing and paying for products and services, lending, borrowing, and gifting;

FIG. 2C is a tabular representation of the gross discrepancies that exist between the highest interest rates and the average interest rates for the same accounts and products on a nationwide basis;

FIG. 3 is a schematic representation illustrating the flow of money associated with conventional money transfer systems, wherein at the end of the transfer period, principle money and accrued interest are transferred back to owner of money, or its bank;

FIGS. 4A and 4B, taken together, set forth a set of equations that formally recognize and describe that a broad set of monetary rights possessed by an owner of money can be separated into individual rights (R (α . . . ι, $)) in accordance with the principles of the present invention, and illustrating that, in accordance with the principles of the present invention, this set of individual rights is divisible, and each individual right is separately transferable, in a non-mutually exclusive manner, so as to maximize the utility of money in the global marketplace, in a manner akin to the bundle of rights possessed through ownership of land, including rights pertaining to minerals, timber, agriculture, riparian rights, surface and ground water, air, and development, to name the most common rights here;

FIG. 5 is a schematic representation of the money rights transfer (MTS) process carried out by the Internet-based Monetary Rights Transfer System (MRTS) Network of the present invention, wherein, in this illustrative embodiment, only the right to earn interest (R (β, $)) possessed by an owner of money is transferred from a “home” financial institution to either an “external” institution(s) or internally within the “home” institution's accounts and products, while all other monetary rights within the bundle {R(α . . . ι)} possessed by the holder of money remain at the “home” institution for full use by the holder, thereby allowing the holder to maximize the utility of the money held in the global marketplace, accordance with the principles of the present invention;

FIG. 6 is a schematic representation of the Internet-based MRTS Network of the present invention, showing its various components interacting so as to enable a system-user (i.e. account holder) to transfer one (or more) of the individual rights (in this representation the right to earn interest (R (β, $))) associated with money ownership (whether owned outright, held in a fiduciary capacity, or borrowed) to one or more participating institutions that feed (to the MRTS's information servers) information on interest rates/yields, accounts and products, and other information relevant to helping a system user make investment decisions with regard to right(s) transfers;

FIG. 7A is a high-level systems block diagram representation of the Internet-based MRTS Network of the present invention, realized as an industrial-strength, carrier-class, globally-extensive packet-switched financial information management and communications network, designed and implemented as an object-oriented system on a Java-based object-oriented integrated development environment (IDE) such as, for example, WebObjects 5.2 IDE by Apple Computer Inc, Websphere IDE by IBM, or Weblogic IDE by BEA, or the Microsoft® Visual Studio 2005.NET IDE;

FIGS. 7B1 and 7B2 are schematic representations of two alternative implementations of the enterprise-level MRTS Network of the present invention using Apple's WebObjects™ and its Java Application Server as an exemplary systems deployment environment;

FIG. 8A is an exemplary chart describing various kinds of Accountholder Services that can be supported on the MRTS Network of the present invention;

FIG. 8B is an exemplary list of the potential users/accountholders on the MRTS Network of the present invention;

FIG. 8C is exemplary list describing the diverse provisions which the MRTS Network of the present invention seeks to provide to all its users/accountholders;

FIG. 9 is a schematic representation depicting a systems-level architecture of the various services supported by the MRTS Network of the present invention, including (i) management services for financial institutions who have registered with the MRTS Network, interest-capturing products and services offered to clients over the MRTS Network, as well as (ii) management services for clients holding accounts on interest capturing products and services, registered on and supported by the MRTS Network;

FIG. 10A is a schematic representation depicting the various management services supported for any financial product registered and offered on the MRTS Network of the present invention, including financial institution configuration and maintenance, consumer metrics, continual interest rates and product/account updates, provide deposit and account insurance;

FIG. 10B is a schematic representation depicting the various management services supported for any ICS-enabled financial account associated with a ICS-product registered on the MRTS Network, including the client's right to initiate the transfer of his/her right to earn interest (REI), check all account balances, update user preferences, review updated rate feed information, and other MRTS services, as well as the various REI transfer methods supported on the illustrative embodiment of the MRTS Network;

FIG. 11 is schematic representation illustrating in greater detail, the structure of the REI Transfer Method A″ of the present invention indicated in FIG. 10B, showing three different kinds of processes by which an account holder on the MRTS Network can manually transfer ones right to earn interest (R (β, $)) including (i) the unrestricted manual transfer process, (ii) the semi-restricted manual transfer process, and (ii) the restricted manual transfer process;

FIGS. 12A and 12B, taken together, set forth a schematic representation of the REI Transfer Method A depicted in FIG. 11, illustrating that a system user/accountholder can manually review and effect transfers of R (β, $) via the methods of the present invention, wherein each step in the method shows the various account balances and transfer choices and then, at the completion of the R (β, $) transfer, shows the confirmation with all of the details related to each transfer and an “Accounts Status (New)” that shows all of the user's various new account balances post-transfer;

FIG. 13 is a flow chart depicting the various steps carried out during Transfer Method A illustrated in FIGS. 12A and 12B, allowing a system user to manually transfer R (β, $) via the MRTS Network of the present invention;

FIG. 14 is a schematic representation illustrating, in greater detail, the structure of the Accountholder-Specified Criteria Right to Earn Interest (REI) Transfer Method “B” indicated in FIG. 10B, showing various processes by which an accountholder can effect both manual and automatic transfer transfers of the right to earn interest (R (β, $)) on the MRST Network;

FIGS. 15A and 15B, taken together, set forth a schematic representation illustrating REI Transfer Method “B depicted in FIG. 10, illustrating that a system user/accountholder can pre-specify criteria by which the system will rank participating institutions' accounts/products for the system user, and then the system user can either effect a manual transfer of R (β, $) using the system's rankings, or the system user can, via pre-specification, allow the system to effect transfers automatically based on rankings of the user's pre-specified criteria, and throughout the process the system provides data regarding account balances, the transfer process and an “Accounts Status (New)” at the completion of the process;

FIGS. 16A and 16B, taken together, sets forth a flow chart depicting the various steps in REI Transfer Method B of FIGS. 15A and 15B, allowing a system user to transfer R (β, $), either manually or automatically, after pre-specifying R (β, $) transfer criteria and receiving rankings of various institutions' accounts and products based on the pre-specified criteria via the system of the present invention;

FIG. 17 is a schematic representation, illustrating, in greater detail, the structure of the Preferred Partner Network (PPN) REI Transfer Method “C” indicated in FIG. 10B, and showing various processes by which an accountholder can effect both manual and automatic transfers of the right to earn interest (R (β, $)) over the MRTS Network;

FIGS. 18A and 18B, taken together, set forth a schematic representation depicting various steps in the REI Transfer Method C illustrated in FIG. 17, and allowing a user to pre-specify certain participating institutions (preferred partners) to which to transfer R (β, $) based on the system's rankings of those institutions' accounts and products, with the actual transfer either being effected manually by the system user or automatically by the system based on the user's pre-specified criteria and, as with other transfer methods, the system provides account balances, (R (β, $)) transfer progress and an “Accounts Status (New)” at the completion of the process;

FIGS. 19A and 19B, taken together, set forth a flow chart depicting the various steps in REI Transfer Method C that allow a system user to pre-specify institutions (or products/accounts) to which to transfer R (β, $), either manually or automatically, after pre-specifying R (β, $) transfer criteria and receiving rankings of the pre-specified institutions' accounts and products based on the pre-specified criteria via the MRTS Network of the present invention;

FIG. 20 is a schematic representation, illustrating in greater detail, the structure of the System-Selected REI Transfer Method “D” of FIG. 10B, showing various processes by which an accountholder can effect both manual and automatic transfers of the right to earn interest (R (β, $));

FIGS. 21A and 21B, taken together, set forth a schematic representation of the System-Selected REI Transfer Method “D”, allowing a system user to turn over the entire right(s) transfer process to the system of the present invention with automatic transfers of R (β, $) based on the system's own criteria, to pre-specify transfer criteria and then allow the MRTS to effect transfers of R (β, $) automatically based on the user's pre-specified criteria or, to receive the rankings based on the system-selected criteria and then effect manual right(s) transfers, with the MRTS providing account balances, transfer progress and an “Account Status (NEW)” at the end of the right(s) transfer process;

FIGS. 22A and 22B, taken together, set forth a flow chart that depicts the various steps in the System-Selected REI Transfer Method “D”, allowing a system user to automatically, semi-automatically or manually transfer R (β, $) based on system-selected criteria that ranks various participating institutions' accounts and products based on the MRTS' own internal criteria, and features constant updates on account balances, transfer progress and an “Accounts Status (NEW)” at the completion of the transfer process;

FIG. 23 is a schematic representation, illustrating in greater detail, the structure the Internal REI Transfer Method “E” of FIG. 10B, showing various processes by which an accountholder can effect both manual and automatic transfers of the right to earn interest (R (β, $));

FIGS. 24A through 24B is a schematic representation of the Internal REI Method “E” of FIG. 23, allowing a system user to transfer the right to earn interest (R (β, $)) (or other right(s)) internally within the “home” or “external” institution's accounts/products where the R (β, $) resides, wherein the method/process allows a system user to manually transfer R (β, $) or semi-automatically transfer R (β, $) or, specify that the system automatically transfer R (β, $) based on user's pre-specified transfer criteria, while providing the system user with account balances, transfer progress and, at completion, an “Accounts Status (NEW)” showing update account balances;

FIGS. 25A through 25B, taken together, set forth a flow chart depicting the various steps in the REI Method E, allowing a system user to automatically, semi-automatically or manually transfer R (β, $) internally within the “home” or “external” institution(s) accounts and products in which R (β, $) resides, and allows for the constant updating on account balances, transfer progress and an “Accounts Status (NEW)” at the completion of the REI transfer process;

FIG. 26 is a schematic representation of the Rate Collection and Display Process supported on the MRTS Network of the present invention, whereby participating institutions provide information to the relational database management systems (RDBMS) of the MRTS Network, and wherein these RDBMSs then sort and rank such data inputs and display the ranked data in different ways according to the user/accountholder's preference(s) so that the system user/accountholder can then effect a transfer of the right to earn interest (R (β, $)) on monies owned, using the various RE5 transfer methods supported on the MRTS Network;

FIG. 27 is a flow chart describing the steps involved in the MRTS Rate Collection and Display Process depicted in FIG. 26, beginning with the step of the financial institution feeding rates/yields to the RDBMSs of the MRTS Network, and culminating in the transfer of the right to earn interest (R (β, $)) by the system user/accountholder using one of the preferred REI transfer methods disclosed herein;

FIGS. 28A through 28C-2, taken together, set forth a schematic representation of a Commerce-Enabling REI Transfer Process supported on the MRTS Network of the present invention, wherein a user/accountholder's monetary right to earn interest (R (β, $)) is transferred in a time-coincident manner with his/her exercise of the right to make purchases (R (ε, $)) (via his/her right to make payments (R (φ, $) and the right to make withdrawals (e.g. hold money as a store of value) (R (δ, $)), specifically, a user/accountholder transfers R (β, $) in order to earn higher interest rates/yields but, as the user utilizes other, non-mutually exclusive rights associated with holding money through demand account transactions (e.g. R (ε, $)), (R (φ), $)), and (R (δ, $)), the amount of R (β, $) is automatically reduced or cancelled commensurately, thereby allowing a user to maximize the utility and value of money held;/owed;

FIG. 29 is a flow chart depicting the various steps carried out by the Commerce-Enabling REI Transfer Process shown in FIGS. 28A through 28C-2, allowing a system user/accountholder to both transfer the right to earn interest R (β, $) and, at the same time, conduct commerce by utilizing other, separable rights associated with money ownership;

FIG. 30 is a schematic representation of the Tax Recognition and Reporting Process supported by the MRTS Network of the present invention, whereby the MRTS Network automatically coordinates the collection and distribution of information pertaining to taxable interest earned by users on the MRTS Network;

FIG. 31 is a flow chart describing the various steps involved in the Tax Recognition and Reporting Process depicted in FIG. 30.

FIGS. 32A through 32C-3, set forth a schematic representation of the Mortgage REI Transfer Process supported on the MRTS Network of the present invention, enabling a system user/accountholder to transfer the right to earn interest (R (β, $)) on monies paid to, and escrowed by, a mortgage issuer or mortgage service provider so as to cover the user/accountholder's future obligations with regard to property taxes, insurance and other mortgage related expenses, and thereby allowing a user/accountholder to earn additional interest on monies prior to the individual payment(s) due date(s);

FIG. 33 is a flow chart depicting the various steps in the Mortgage Interest Right Process for the MRTS that allow system user/accountholder to transfer the right to earn interest (R (β, $)) on monies paid to a mortgage issuer or to a mortgage service provider.

FIGS. 34A through 34C-3, taken together, set forth a schematic representation of Human Resources Interest Right Process for supported on the MRTS Network of the present invention, enabling a system user to transfer the right to earn interest (R (β, $)) on monies collected from an employee (system user/accountholder) by an employer or payroll services provider to pay the employee's future obligations for such things as taxes, insurance, and other employee-related expenses, and thereby allowing the employee to earn additional interest on the monies collected to pay for future employee obligations by an employer or payroll services provider until each individual payment due date;

FIGS. 35A through 35B, taken together, set forth a flow chart depicting the Human Resources Interest Right Process represented in FIGS. 34A through 34C, enabling an employee to transfer the right to earn interest (R (β, $)) on monies (still owned by the employee) collected and held by an employer or payroll services provider to pay an employee's future obligations until each individual payment due date;

FIGS. 36A through 36C-3 is a schematic representation of the Payment Method Withholding the Right to Earn Interest (R (β, $)) until Payment Due Date supported on the MRTS Network of the present invention, enabling a system user/accountholder to remit payment on a bill received at any date prior to the bill's due date such that the payment remitted consists of R (α . . . ι, $)−R (β, $) allowing the system user/accountholder to transfer R (β, $) and earn additional interest up to a bill's payment due date at which time R (β, $) is restored to the user's original payment and, simultaneously, the user's R (β, $) transfer is cancelled with any accrued interest being returned to the user's account in the user's “home” and/or “external” institution(s) registered on the MRTS Network of the present invention;

FIG. 36D1 through 36D2, sets forth a flow chart describing the steps carried out during the Payment Method Withholding the Right to Earn Interest R (β, $) until Payment Due Date, depicted in FIGS. 36A through 36C-3;

FIG. 37A is a schematic representation describing the “Account-Specific” Payment Method Withholding the Right to Earn Interest (R (β, $)) until Payment Due Date supported on the MRTS Network of the present invention, enabling a system user/accountholder to remit payment on a bill received at any date prior to the bill's due date such that the payment remitted consists of R (α . . . ι, $)−R (β, $), and thereby allowing the system user/accountholder to transfer R (β, $) and earn additional interest up to a bill's payment due date at which time R (β, $) is restored to the user's original payment and, simultaneously, the user's R (β, $) transfer is cancelled with any accrued interest being returned to the user's account in user's “home” and/or “external” institution(s) maintained on the MRTS Network of the present invention;

FIG. 37B1 through 37B2-2, taken together, sets forth a flow chart describing the steps carried out by the Payment Method Withholding the Right to Earn Interest R (β, $) until Payment Due Date, depicted in FIG. 37B1-37B2-2;

FIGS. 38A through 38D is a schematic representation of the Right-of-First-Refusal Process supported on the MRTS Network of the present invention, wherein both “home” and “external” banks and financial institutions holding an accountholder's R (β, $) on the MTRS Network are automatically notified that the user has requested a transfer of such rights R (β, $), and at which point, the financial institution may, at the discretion of the system user, have an opportunity to improve, match, beat or counter the interest rate/yield being offered a competitor's offer determined by the system user, and if the system user accepts the offer, then no transfer is effected over the MRTS Network;

FIG. 39 is a flow chart describing the steps carried out during the Right of First Refusal Process depicted in FIGS. 38A through 38D, supported on the MRTS Network of the present invention;

FIG. 40A is a schematic representation of the Foreign Entities and Foreign Exchange Conversion (GBP) Process supported on the MRTS Network of the present invention, enabling a system user/accountholder to transfer R (β, $) to foreign participating institutions that provide rate feeds to the MRTS by first converting the R (β, $) to R (β, GBP) via a market-based foreign exchange conversion rate and then, upon transfer back to a domestic institution by converting R (β, GBP)+(i, GBP) back to R (β, $)+(i, $) via a similar foreign exchange market-based conversion rate;

FIG. 40B is a schematic representation of the Foreign Entities and Foreign Exchange Conversion (JPY) Process supported on the MRTS Network of the present invention, enabling a system user/accountholder to transfer R (β, $) to foreign participating institutions that provide rate feeds to the MRTS by first converting the R (β, $) to R (β, JPY) via a market-based foreign exchange conversion rate and then, upon transfer back to a domestic institution by converting R (β, JPY)+(i, JPY) back to R (β, $)+(i, $) via a similar foreign exchange market-based conversion rate;

FIG. 41 is a flow chart describing the steps carried out during the Foreign Entities and Foreign Exchange Conversion Process, illustrated in FIGS. 40A and 40B;

FIG. 42 is a schematic representation of an exemplary transaction log based on hypothetical transfers of the right to earn interest R (β, $) by an user/accountholder on the MRTS Network;

FIG. 43 is a schematic representation of an exemplary Accountholder Information Collection and Storage form that can be used by the MRTS Network of the present invention, in order to collect and store relevant information relating to the opening and maintenance of an account on the MRTS Network of the present invention;

FIG. 44 is a schematic representation of an exemplary Accountholder Preference Collection and Storage form that can be used by the MRTS Network to allow an accountholder to supply account data to the system, rank display and transfer criteria, and provide institution and/or account/product data for the accountholder's Preferred Partner Network (PPN) maintained on the MRTS Network;

FIG. 45 is a schematic representation illustrating the architecture of the various control panels available to account-holders on the MRTS Network, illustrated in FIGS. 46 through 62, for purposes of carrying out the principles of the present invention;

FIG. 46 is a schematic representation of a Web-based control panel that allows an accountholder on the MRTS Network to specify the method(s) by which to transfer the accountholder's right to earn interest (R (β, $)) on accounts maintained on and registered with the MRTS Network;

FIG. 47 is a schematic representation of a Web-based control panel that allows an accountholder on the MRTS Network to specify which institutions to include when the MRTS Networks automatically ranks participating financial institutions via absolute rate/yield, the accountholder's pre-specified criteria, and/or the system's criteria, for the purpose of effecting transfers of R(β, $);

FIG. 48 is a schematic representation of a Web-based control panel that allows an accountholder on the MRTS Network to specify which banks and/or institutions, and/or accounts and products, to include in the accountholder's Preferred Partner Network (PPN), for the purpose of effecting transfers of R (β, $);

FIG. 49 is a schematic representation of a Web-based control panel that allows an accountholder on the MRTS Network to exclude certain institutions from consideration for ranking and from consideration for receiving R (β, $) transfers;

FIG. 50 is a schematic representation of a Web-based control panel that allows an accountholder on the MRTS Network to specify the various interest rate/yield criteria as they relate to transfers of R (β, $) transfers via the MRTS Network of the present invention;

FIG. 51 is a schematic representation of an Web-based control panel that allows an accountholder on the MRTS Network to specify the frequency with which automatic R (β, $) transfers are effected on the accountholder's behalf by the system;

FIG. 52 is a schematic representation of a Web-based control panel that allows an accountholder on the MRTS Network to specify minimum safety/credit criteria for institutions and/or accounts and products to which to transfer accountholder's R (β, $);

FIG. 53 is a schematic representation of a Web-based control panel that allows an accountholder on the MRTS Network to establish R (β, $) transfer risk levels that will serve to govern automatic (and other) transfers of R (β, $) via the MRTS Network;

FIG. 54 is a schematic representation of a Web-based control panel for a Deposit Insurance Filter supported on the MRTS Network, allowing an accountholder on the MRTS Network to establish parameters regarding deposit insurance afforded to the transfers of the right to earn interest (R (β, $));

FIG. 55 is a schematic representation of a Web-based control panel for the MRTS Minimum Account Balance Filter supported on the MTLRS Network, allowing an accountholder to establish parameters related to minimum account balances for effecting transfers of the accountholder's right to earn interest (R (β, $));

FIG. 56 is a schematic representation of a Web-based control panel for Notification Preferences that allows an accountholder on the MRTS Network to establish criteria, for notification of opportunities and offers supported on the MRTS Network;

FIG. 57 is a schematic representation of a Web-based control panel for Preferred Notification Methods that allows an accountholder to specify method(s) by which an accountholder on the MRTS Network prefers to be contacted/notified;

FIG. 58 is a schematic representation of a Web-based control panel for the Fees, Charges and Penalties Filter that allows an accountholder on the MRTS Network to establish criteria related to fees, charges and penalties for notification and transfer of the accountholder's right to earn interest (R (β, $));

FIG. 59 is a schematic representation of Web-based control panel for the Preferred Transfer Method(s) that allows an accountholder on the MRTS Network to specify the preferred method(s) by which to transfer the accountholder's right to earn interest (R (β, $));

FIG. 60 is a schematic representation for a Web-based control panel for the Accountholder Right of First Refusal Right(s) (R (β, $)) Transfer Criteria that allows an accountholder on the MRTS Network to establish criteria which will (will not) allow “home” bank(s)/institution(s) to match, beat, or counter, offers received by an MRTS accountholder from “external” bank(s)/institution(s);

FIG. 61 is a schematic representation for a Web-based control panel for the Account-Specific Payment Method Withholding the Right to Earn Interest (R (β, $)) until payment Due Date Pre-Specifications that allows an accountholder on the MRTS Network to pre-specify from which account(s) to make payments withholding R (β, $) until a payment's due date, and to pre-specify whether to make said payment by electronic means or by manual means; and

FIG. 62 is a schematic representation for a Web-based control panel for the Right(s) Transfer Preferred Accounts and Products List that allows an accountholder on the MRTS Network to specify to which accounts and products the accountholder prefers to transfer the accountholder's monetary right to earn interest R (β, $) possessed by an owner (or borrower) of money.

### DETAILED DESCRIPTION OF ILLUSTRATIVE EMBODIMENTS OF THE PRESENT INVENTION

Referring now to the figures in the accompanying Drawings, the illustrative embodiments of the present invention will now be described in great technical detail, wherein like parts are indicated by like reference numbers.

### Overview of the Method of Monetary Rights Transfer According to the Principles of the Present Invention

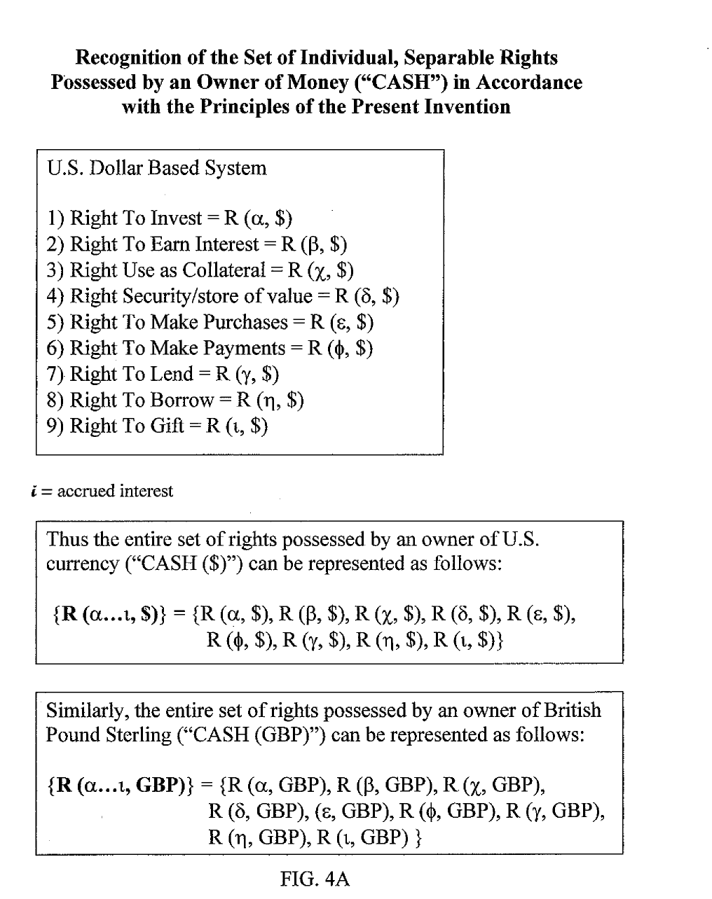

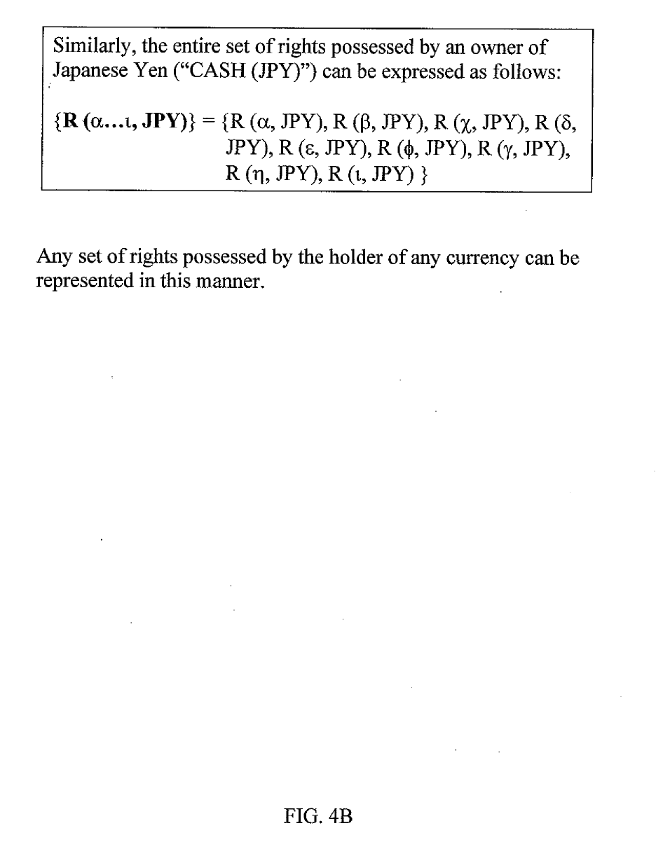

Referring to FIGS. 4A and 4B, there is presented an important set of equations that formally recognizes a broad set of monetary rights, possessed by an owner of any amount of money, that can be separated into individual rights (R (α . . . ι, $)) and effectively transferred in the marketplace in accordance with the principles of the present invention. As will be described in great detail hereinafter, the transfer of such monetary rights is carried out using the Internet-based Monetary Rights Transfer System (MRTS) Network of the present invention which recognizes and ensures that the above-identified set of individual rights is divisible, and each individual right is separately transferable on the MRTS Network, in a non-mutually exclusive manner, so as to maximize the utility and value of money in the global marketplace. Such divisibility of rights is akin to the bundle of rights possessed through ownership of land, including rights pertaining to minerals, timber, agriculture, riparian rights, surface and ground water, air, and development, to name the most common rights.

### Overview of Internet-Based MRTS Network of the Present Invention

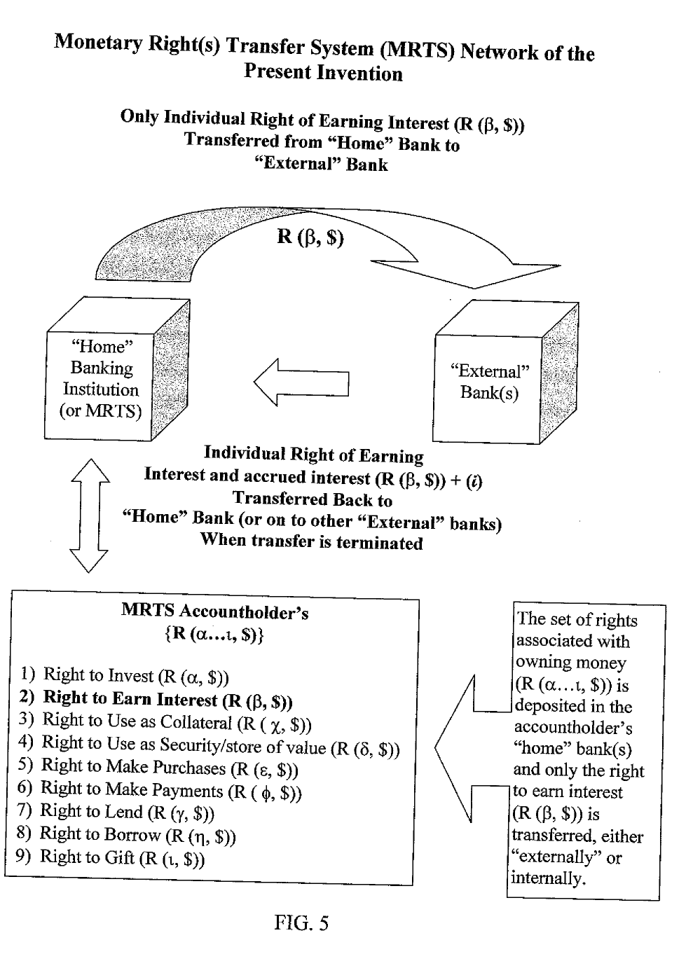

As shown in FIG. 5, the Internet-based MRTS Network of the present invention, represents a significant improvement on the “Conventional Money Transfer Systems” as illustrated in FIG. 3. In this figure, the MRTS Network is shown transferring only the right to earn interest (R (β, $)) possessed by an owner of money, from a “home” financial institution to either an “external” institution(s) or internally within the “home” institution's accounts and products, in order to allow the owner to receive better rate(s)/yield(s) at an “external” institution than that offered at the owner's “home” institution. while all other monetary rights within the bundle {R(α . . . ι)} possessed by the holder of money remain at the “home” institution for full use by the holder, thereby allowing the holder to maximize the utility of the money held in the global marketplace, accordance with the principles of the present invention. For the purpose of the present invention, an “external” bank(s) or financial institution(s) is defined as any other bank or financial institution to which a user of the MRTS Network and methods described herein, might transfer monies and investments, either manually or automatically and, either through an actual transfer of a user's monies or investments or through a transfer of the user's monetary right to earn interest which constitutes a transfer of the right to earn interest associated with a user's monies and investments, but not the user's actual monies and/or investments.

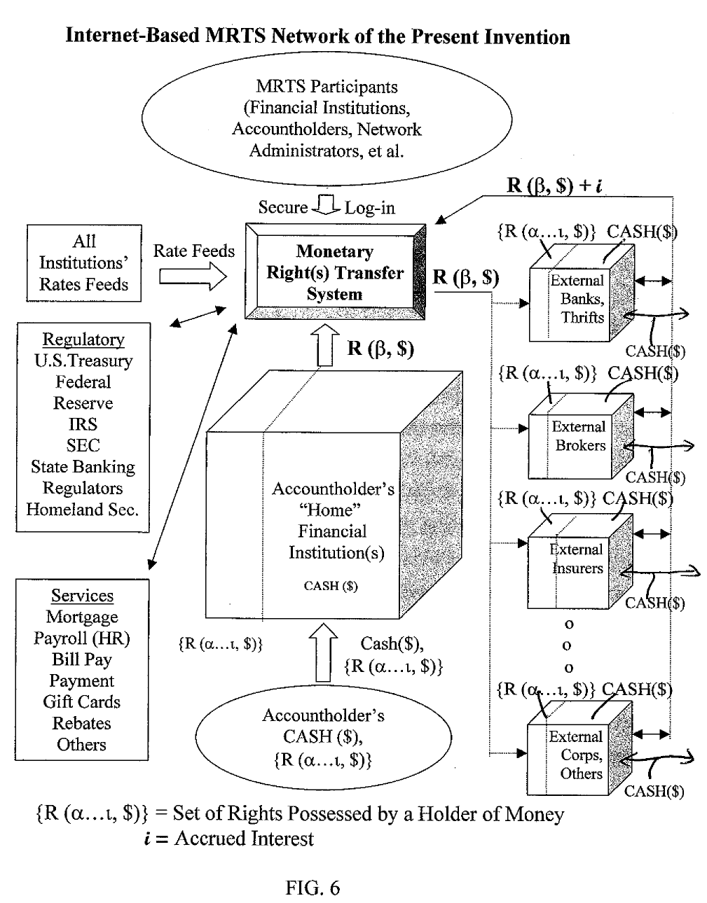

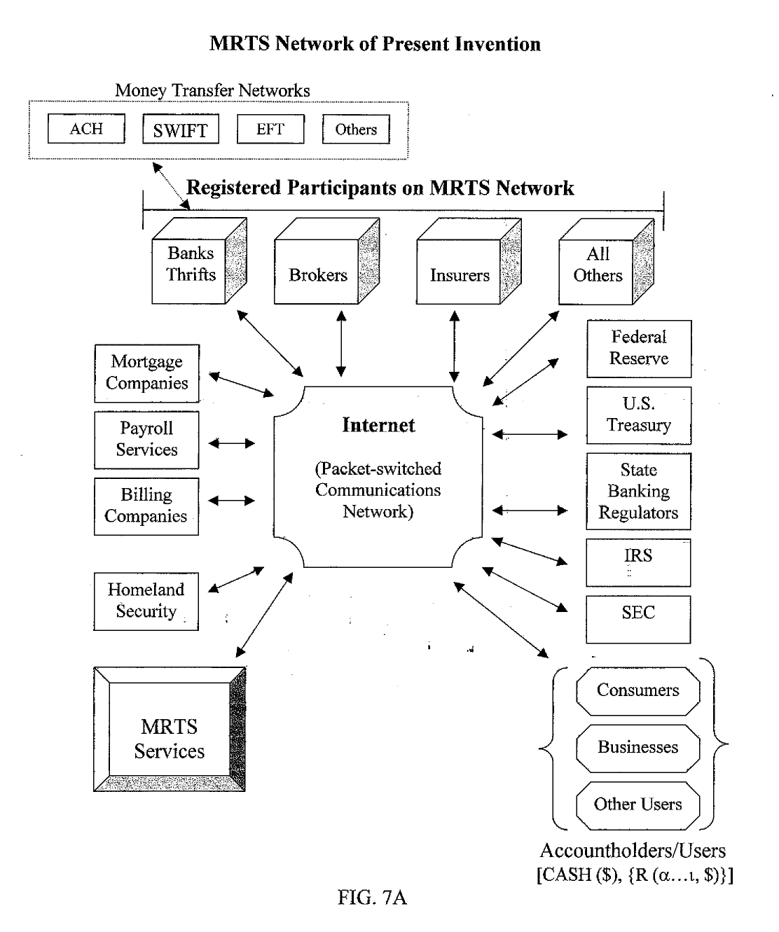

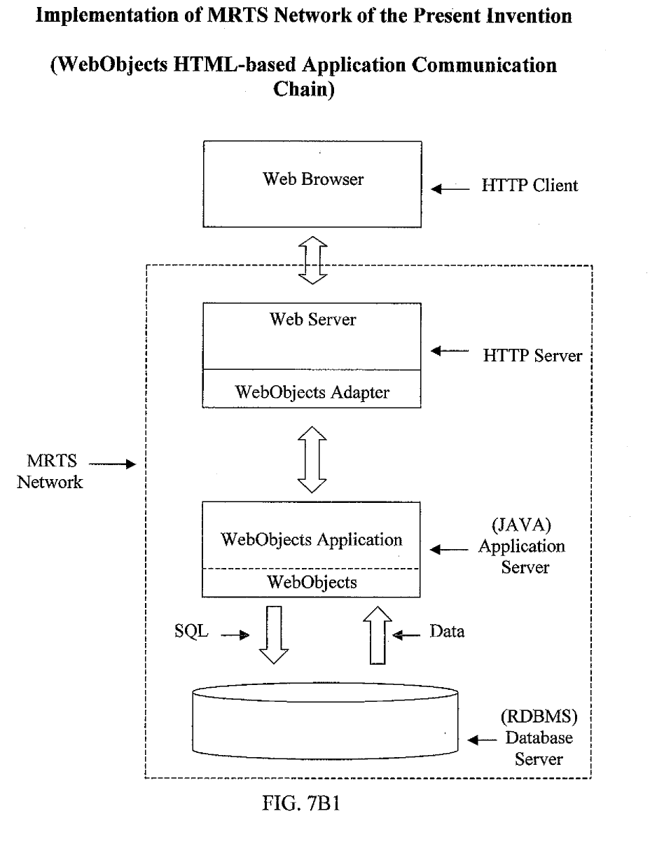

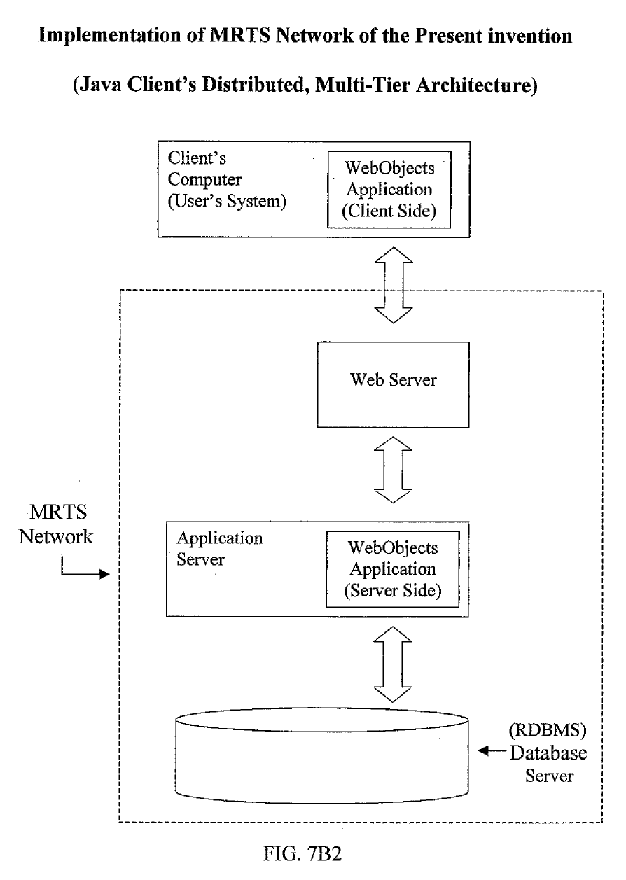

As shown in FIG. 6, the Internet-based MRTS Network of the present invention is shown comprising various enterprise-level information systems and supporting global financial information services, for each financial institution registered as a participating member of its MRTS Network (e.g. Banks, Thrifts, Brokers, Insurers, Mortgage companies, Payroll services companies, Billing companies, and other institutions including Homeland Security, Federal Reserve, US Treasury, State Banking Regulators, IRS, SEC, et al). As shown, each of these enterprise-level information management and transaction supporting systems is integrated with the information infrastructure and services of the MRTS Network, including its web, application and database servers (FIGS. 7B1 and 7B2) configured according to a multi-tier network architecture supported with packet-switched firewall, switch and router technology well known in the networking communications art.

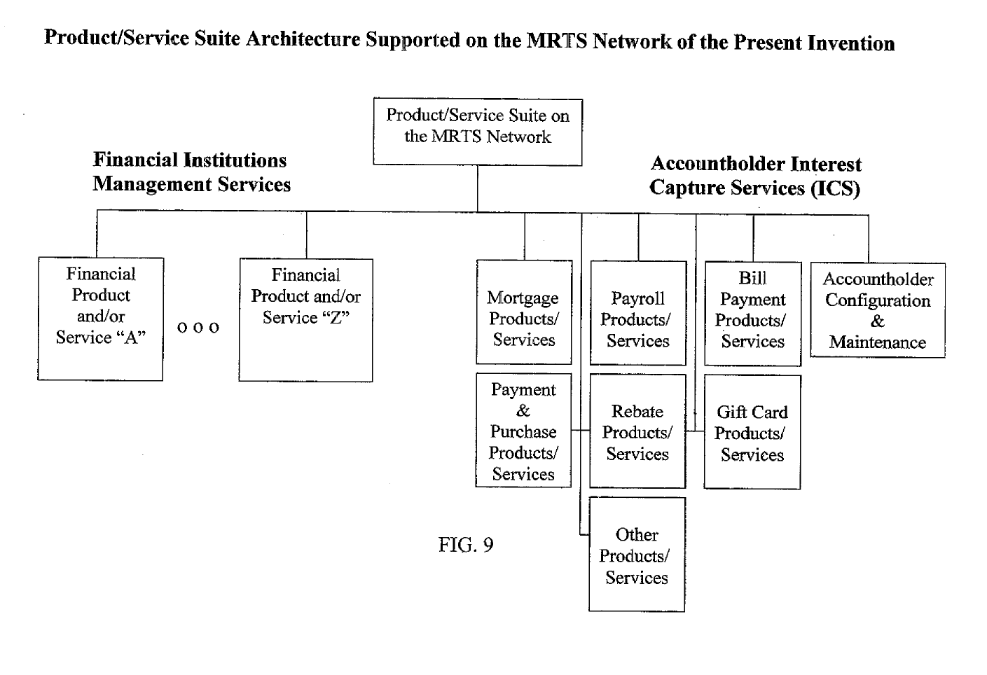

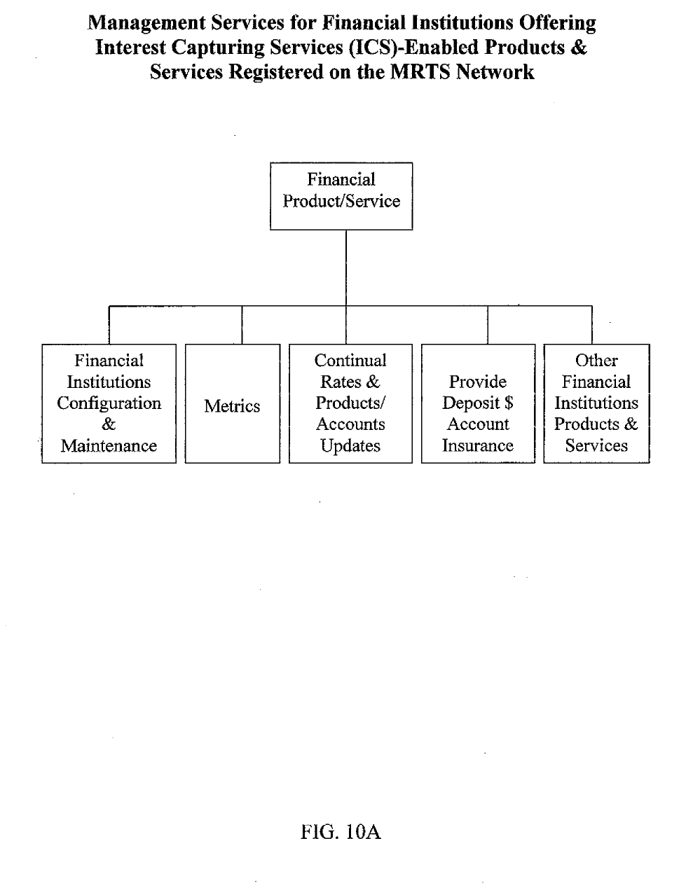

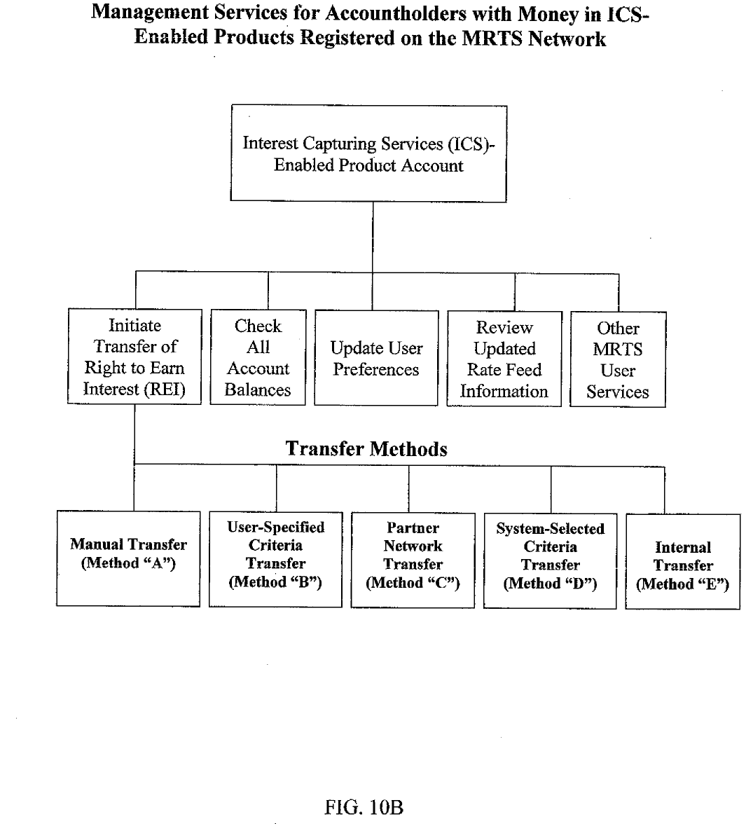

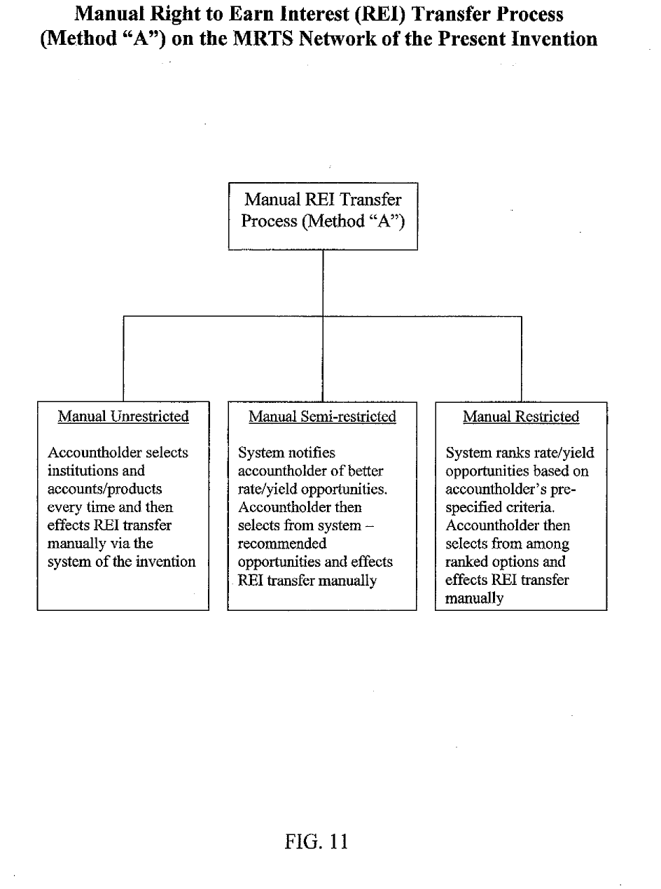

As will be described in greater detail hereinafter, web, application and database servers at each node in the MRTS Network cooperate so as to support and deliver the various suites of information services on the MRTS Network, depicted in FIG. 9 through 10B. Among such services are the interest-capturing service (ICS) of the present invention, wherein a system-user (i.e. account holder) is capable of transferring one (or more) of his or her monetary rights (i.e. the right to earn interest (R (β, $)) associated with money ownership) to one or more participating financial institutions registered on the MRTS Network. As will be described in greater detail hereinafter, this service involves each financial institution registered on the MRTS Network, and offering a ICS-enabled financial product or service, to automatically feed (to the MRTS Network's information servers) various kinds of time-varying information relating to interest rates/yields, accounts and products, and other information relevant to helping a system user make investment decisions with regard to interest right(s) transfers.

As illustrated in FIG. 6, an owner of money that has established an account(s) within a “home” bank(s) is also an MRTS accountholder. As shown, the MRTS servers (which are mirrored at various locations around the globe) receives, via the Internet's IP infrastructure, rate/yield, account/product, and other information fed to the MRTS's databases by all participating financial institutions. At the end of the R (β, $) transfer period, which may be determined by the accountholder or by the MRTS Network, the accountholder's R (β, $)+/−(i) may then be either returned to the MRTS servers or may be transferred on to another “external” institution. Even if the accountholder chooses to transfer the R (β, $) to another institution, the accountholder can choose to transfer the accrued interest (i) along with the R (β, $) either to another “external” institution or back to the MRTS accountholder's account(s) at the “home” institution. At the end of the monetary right(s) transfer process R (β, $)+(i) is returned to the MRTS accountholder's account(s) at the accountholder's “home” institution.

### Cash Deposit Requirements of Participating Financial Institutions Registered on the MRTS Network of the Present Invention

In much the same manner as banks and other financial institutions account for derivatives, participating banks and financial institutions will have to maintain adequate reserves (Cash ($)) to facilitate the monetary right(s) transfer process. Presently, banks are required to hold a certain percentage of their total assets as reserves (reserve requirements) in order to assure their financial health and to demonstrate their liquidity. While holding these reserves, banks try to invest (lend, purchase securities, etc.) the remainder of the funds in order to earn a return higher than that which they are paying out to their depositors and investors in interest, dividends, etc. Transferring funds under this regime is straightforward; Cash ($) moves, primarily by electronic means. Thus as an investor transfers cash or electronic money out of a “home” bank or financial institution to an “external” bank or financial institution, the “home” bank or financial institution is no longer required to reserve against those funds, as they are no longer domiciled within the institution from which they were transferred. But, due to a physical or electronic transfer of funds out of a “home” bank or financial institution, the “home” bank or financial institution may be required to sell investments or loan out less money in order to satisfy the aforementioned reserve requirements as there are less total assets against which to lend, invest, etc.

Internally, within the MRTS Network, the right(s) transfer processes (notably the right to earn interest (R (β, $))), participating “home” banks and financial institutions may have to hold a portion of reserves (Cash ($)) against which such monetary right(s) transfers are made. However, this process represents a vast improvement for the “home” banks and financial institutions. In cases where only the right to earn interest (R (β, $)) is being transferred out of the “home” bank or financial institution, even though the “home” institution must reserve against these monies as they are held, and it may have to liquidate investments, lend out less money, etc., if the right to earn interest (R (β, $)) is transferred to another MRTS Network participant similar to a wholesale transfer of funds out of the “home” institution, as opposed to a wholesale transfer of funds to another institution, the “home” institution still holds the remaining set of rights {R (α . . . ι, $)−R (β, $)} which the retained customer can utilize via the “home” institution's accounts and products. Furthermore, by facilitating the transfer of only one (or more) monetary right, the “home” institution virtually is assured of retaining the customer.

The important difference between physical or electronic monetary transfers between institutions outside the MRTS Network and those participating in the MRTS Network is that when transfers occur between institutions outside the network, cash ultimately moves in one iteration or another, reserves adjustments (and the aforementioned implications) occur based on the cumulative inflows and outflows of cash and, in many cases, customers are lost to other financial institutions. With monetary right(s) transfers that occur within the MRTS Network, cash does not move; only the desired monetary right(s) are transferred. While the right to earn interest (R (β, $)) is in transfer, the “home” institution may or may not lose the right to invest (R (α, $)) depending on its reserve situation (in a wholesale transfer of cash the right to invest (R (α, $)) is lost forever), but the “home” institution may be required to reserve against a percentage of the right to earn interest (R (β, $)) in transfer. Most importantly, for a “home” institution where the right to earn interest (R (β, $)) and the right to invest (R (α, $)) have been transferred, although those two rights are “dead” to the “home” institution, the transferor still has remaining rights which can be exercised during the transfer process which provide economic value to the “home” institution.

Finally, as is the case with banks and financial institutions today, participating financial institutions within the MRTS Network of the present invention will utilize an accounting method whereby all transferred rights are segregated and accounted for, as the participating institutions' customers (and possibly the institutions themselves) transfer monetary rights between institutions.

MRTS Network of the Present Invention Enabling “Netting” of Earned Interest between Participating Financial Institution Members Registered on the MRTS Network While Being Totally Transparent to the End-User Accountholder on the MRTS Network

As consumers (individuals, businesses and other entities) who are MRTS Network accountholders utilize the system and methods of the present invention to transfer their monetary right(s) to capture additional interest offered by other institutions' accounts and products (and by other accounts and products offered within their “home” institution(s)), they earn interest in the form of cash ($). This cash ($) then needs to be accounted for by the various participating institutions participating in the MRTS Network. As is the case in present-day banking, this cash representing earned interest on right(s) transfers will be “netted” between participating institutions and then distributed internally to the consumers to whom it belongs.

This netting process is important as it obviates the need for individual cash transfers back to the MRTS Network accountholder's account(s). Furthermore, as the MRTS accountholder may desire not to receive the earned interest from an “external” financial institution but may, instead, opt to transfer the right to earn interest (R (β, $) (i)) associated with the earned interest as well as the originally transferred right to earn interest (R (β, $)) to another “external” financial institution, participating institutions can easily net settle the earned interest between themselves.

The MRTS Network accountholder is, from the beginning of the transfer process to its completion, always provided with various screens that show all cash balances and right(s) balances, along with the institutions' accounts and products where those various balances reside. However, the right(s) transfer process and the earned interest netting process are completely transparent to the MRTS Network accountholder in that all of the accounting for the actual right(s) transfers and the earned interest is conducted solely and, invisibly, between the MRTS Network of the present invention and participating financial institutions with the accountholder only. On the other hand, the same processes that seamless and invisible to an accountholder/user are highly visible to any and all pertinent regulatory bodies/agencies.

### Implementation of the MRTS Network of the Present Invention

As shown in FIGS. 7A, the MRTS Network of the present invention is preferably designed and implemented as an industrial-strength, carrier-class Internet-based financial information communications network of object-oriented system engineering (DOSE) design. Using available object-oriented technology, this system can be developed in various ways: for example, using any suitable Java-based object-oriented integrated development environment (IDE) e.g. WebObjects 5.2 by Apple Computer Inc, Websphere IDE by IBM, or Weblogic IDE by BEA; or using another object-oriented programming language such as C sharp, supported by the Microsoft® Visual Studio 2005.NET IDE. FIGS. 7B1 and 7B2 show two alternative implementations of the enterprise-level MRTS Network of the present invention using the WebObjects IDE and Java Application Server.

### Overview of the Services Supported on the MRTS Network of the Present Invention

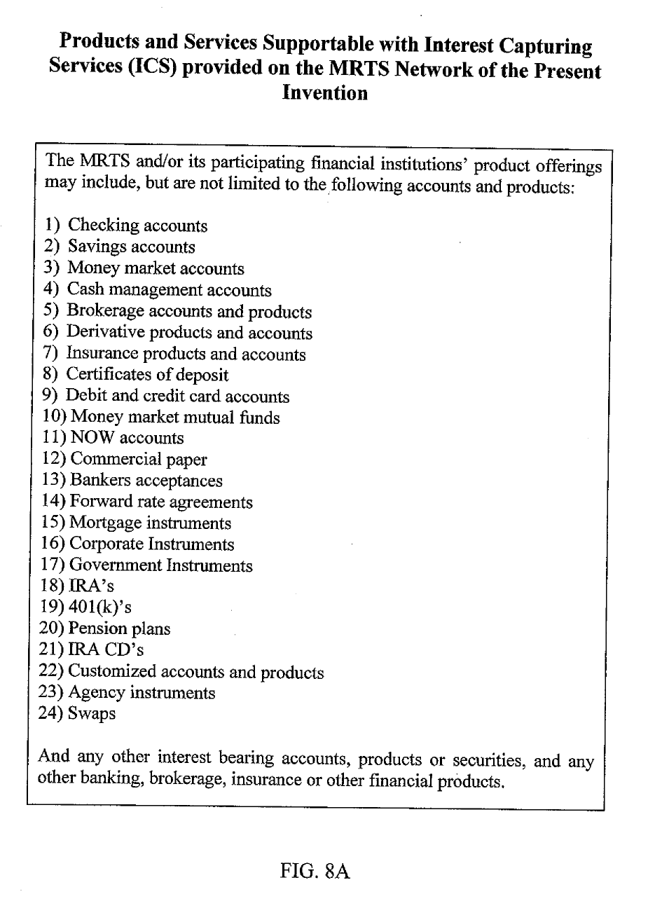

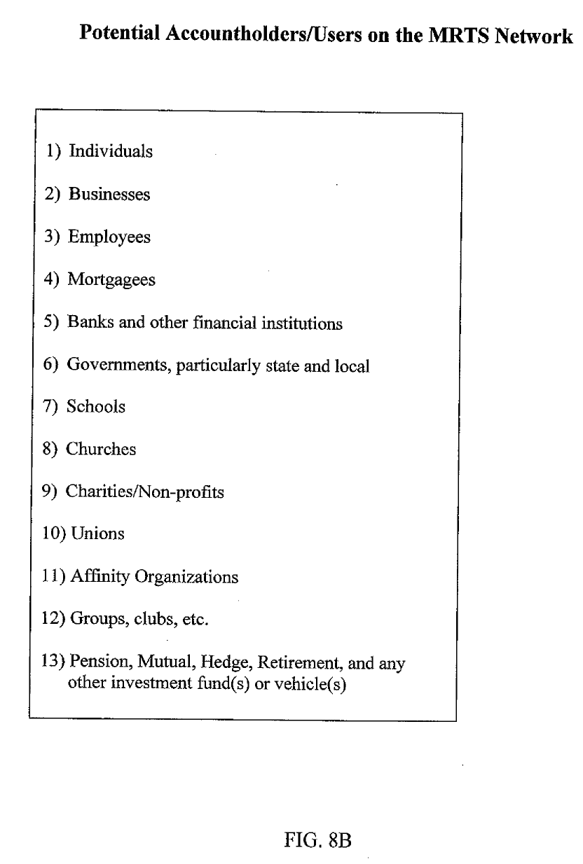

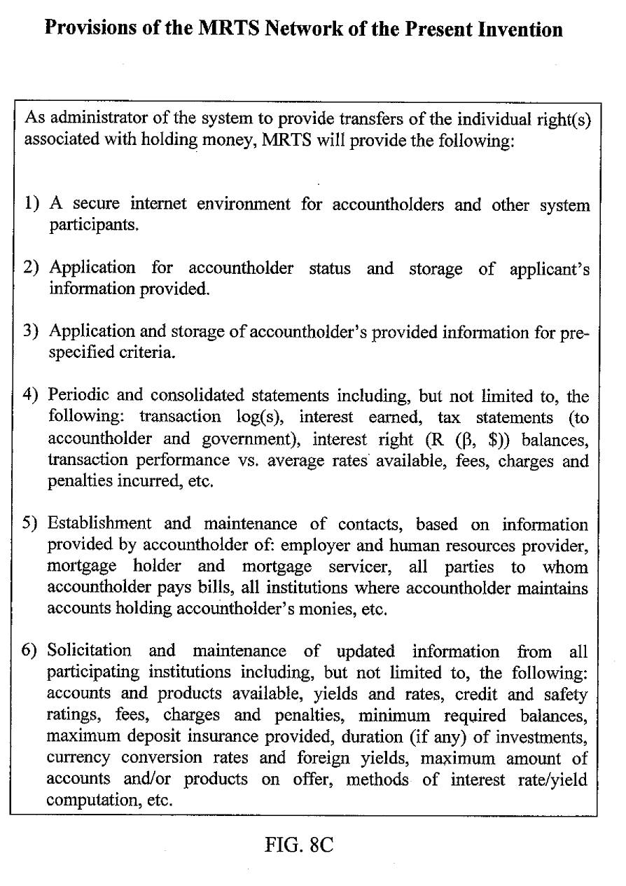

FIG. 8A is an exemplary chart describing various kinds of Accountholder Services that can be supported on the MRTS Network of the present invention. This list is representative of the many kinds of the accounts and products that various participating institutions (including the MRTS Network administrator) may offer on MRTS Network to accountholders. FIG. 8B provides an exemplary list of the potential users/accountholders on the MRTS Network of the present invention. Notably, many of these listed users have implicit/explicit fiduciary responsibilities to their clients, requiring them to obtain the best possible terms for their accountholders/customers, which is one of the primary goals of the MRTS Network. FIG. 8C describes the diverse provisions which the MRTS Network of the present invention seeks to provide to all its users/accountholders.

As shown in FIG. 9, the MRTS Network of the present invention supports and delivers various financial information and accounting services to both its institutional members as well as its accountholders, namely: (i) management services for financial institutions who have registered and are supporting their “interest-capturing” products and services on the MRTS Network; as well as (ii) management services for clients holding accounts on “interest capturing” products and services, registered on and supported by the MRTS Network.

In FIG. 10A, the various management services supported for any financial product offered on and registered with the MRTS Network of the present invention, are shown to include: financial institution configuration and maintenance; consumer metrics; continual interest rates and product/account updates; deposit and account insurance; etc. In FIG. 10B, the various management services supported for any client financial account associated with a ICS-product/service registered on the MRTS Network, are shown to include: the client's right to initiate the transfer of his/her right to earn interest (REI); check all account balances; update user preferences; review updated rate feed information; as well as the various REI Transfer Methods (Methods A through E) supported on the MRTS Network of the present invention. Through the “Update user preferences services, an accountholder provides all relevant personal/business information including, but not limited to accountholder: name, address, city, state, zip code, country, email address, home phone, business phone, mobile phone, date of birth, employer, mortgage holder/servicer, human resource administrator, existing “home” accounts and products, passwords, etc. Additionally, an accountholder can establish, save and change preferences related to right(s) transfers. Such transfer preferences may include, but are not limited to, institutions, accounts, products, transfer methods, preferred partner networks (PPN), criteria by which institutions/accounts and products are ranked, criteria by which transfers are effected, etc. Through “Review Updated Rate Fee Information” Services, accountholders can also review updated rate feed information from all participating institutions, with the system databases constantly receiving, ranking and displaying all incoming data as it relates to rates/yields, accounts and products, institutions, expenses, etc. In addition to the basic REI Transfer Methods, there are additional services supported by the MTRS Network which allow an accountholder to transfer the monetary right to earn interest on monies owned by an accountholder until either transactions are effected by the accountholder, or by others effecting payments on behalf of the accountholder. These services will be described in greater detail hereinafter. “Manual” Right To Earn Interest (REI) Transfer Process According To the Present Invention (Method A)

### Manual REI Transfer Processes According To the Present Invention (Method A)

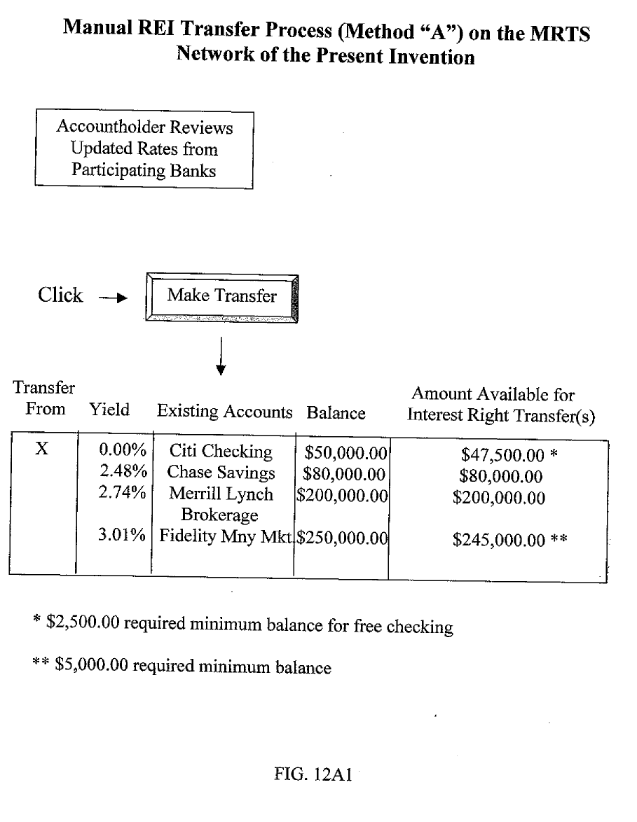

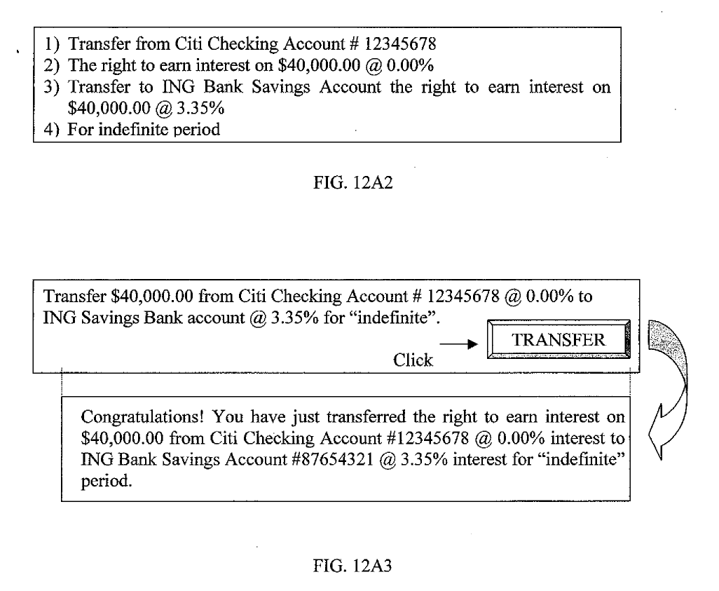

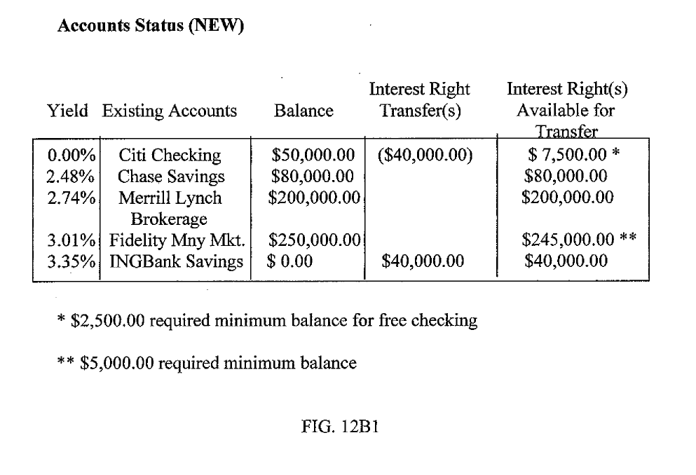

Referring to FIGS. 11, 12A, 12B and 13, the REI Transfer Method “A” will be described in greater detail.

As shown in FIG. 11, the Manual Transfer Process (Method “A”) of the present invention, includes three different kinds of processes by which an accountholder on the MRTS Network can manually transfer ones right to earn interest (R (β, $)) namely: the “Manual Unrestricted” Method; the “Manual Semi-Restricted” Method; and the “Manual Restricted” Method.

As shown in FIG. 11, when using the “Manual Unrestricted” Method, the accountholder selects from among the ranked institutions' accounts and products every time the accountholder accesses the system. The accountholder then selects from among the participating institutions' accounts and products and manually effects the R (β, $) transfer(s) receiving confirmation from the MRTS of the completed transfer.

When using the “Manual Semi-Restricted” Method, the MRTS Network notifies an accountholder (via email or other method) of better rate/yield opportunities available to the accountholder and to which, the accountholder can transfer the right to earn interest (R (β, $)). After such system notification, the accountholder then selects from among either the opportunities of which the system notified the accountholder or, from the ranked institutions' accounts and products, and effects the R (β, $) transfer(s) manually. The accountholder then receives confirmation, via the accountholder's preferred means, of the completed transfer(s).

When using the “Manual Restricted” Method, the MRTS Network ranks institutions' rate(s)/yield(s) accounts and products based on an accountholder's pre-specified transfer criteria. The accountholder then manually selects from among the ranked, displayed options and effects the manual transfer of right to earn interest (REI) (R (β, $)). The accountholder then receives confirmation, via the accountholder's preferred means, of the completed REI transfer(s).

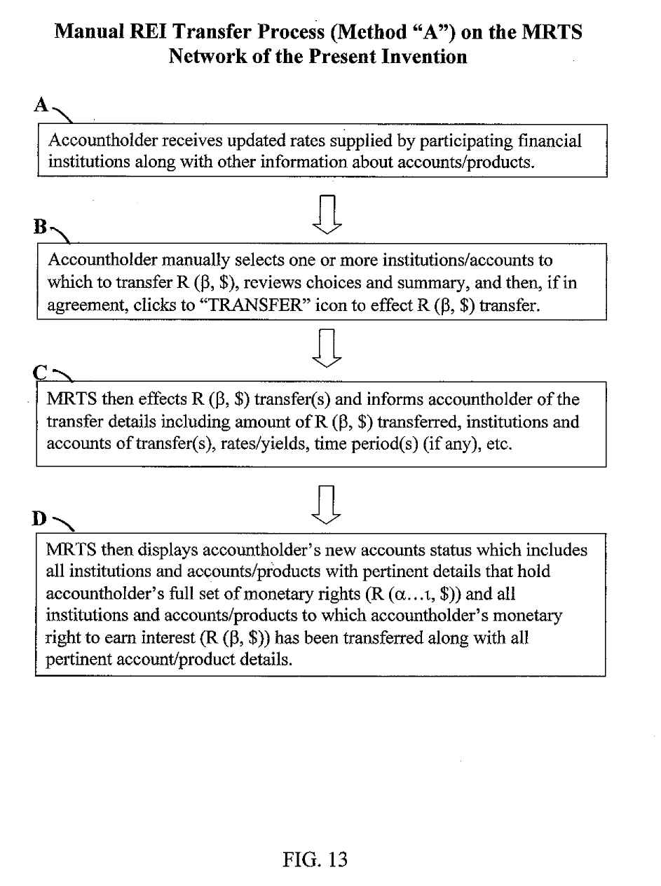

As indicated at Block A in FIG. 13, the accountholder receives updated rate rates supplied by participating financial institutions registered as members on the MRTS Network, along with other information about accounts and products. At Block B, the accountholder manually selects one or more institutions/accounts to which to transfer R (β, $), reviews choices and summary, and then if in agreement, clicks TRANSFER icon on a control panel so as to effect the R (β, $) transfer. At Block C, the MRTS then effects R (β, $) transfer(s) and informs accountholder of the transfer details including the amount of R (β, $) transferred, institutions and accounts of transfers, rate/yields, time periods(s), if any, etc. At Block D, the MRTS then displays the accountholder's new accounts status which includes all institutions and accounts/products with pertinent details that holds accountholder's full set of monetary rights (R (α . . . ι, $) and all institutions and accounts/products to which accountholder's monetary right to earn interest (R (β, $)) has been transferred along with all pertinent account/product details. This method is particularly suited for those accountholders who wish to exercise a high degree of control over all aspects of REI transfer.

### “Accountholder-Specified Criteria” REI Transfer Processes According To the Present Invention (Method B)

Referring to FIGS. 10B, 14, 15A, 15B, 16A, 16B, 47, 48, 51 and 59, the REI Transfer Method “B” will be described in greater detail.

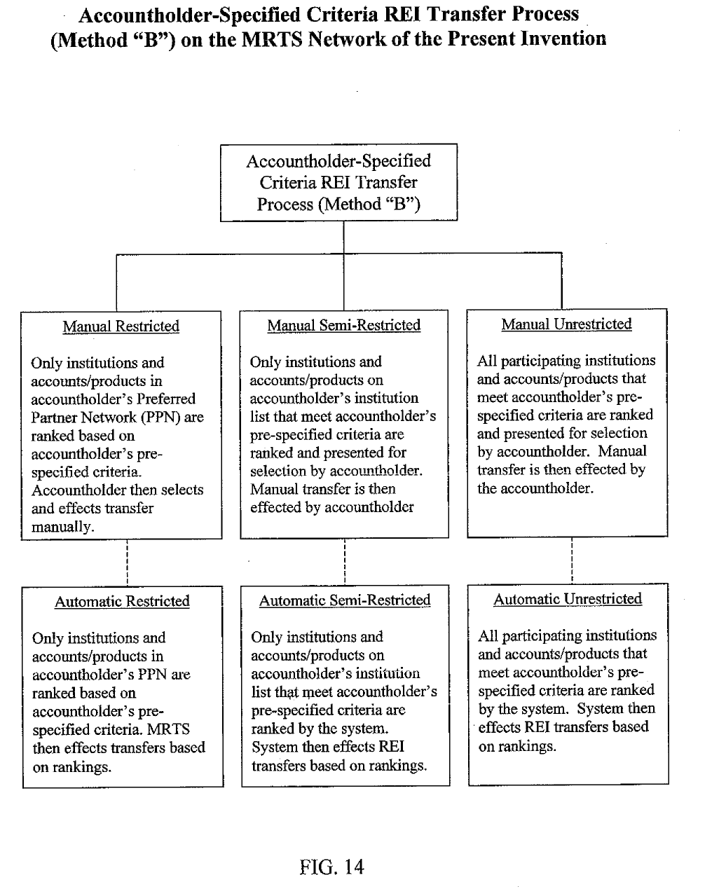

As shown in FIG. 14, the Accountholder-Specified Criteria REI Transfer Process (Method “B”) of the present invention, includes six different kinds of processes by which an accountholder on the MRTS Network can manually transfer one's right to earn interest (R (β, $)) namely: “Manual Restricted” Method; “Manual Semi-Restricted” Method; “Manual Unrestricted” Method; “Automatic Restricted” Method; “Automatic Semi-Restricted” Method; and the “Automatic Unrestricted” Method. In each method shown, the accountholder pre-specifies criteria that determine how the MRTS Network of the present invention will rank and display institutions' accounts and products based on factors ranked by the accountholder. Establishing (and updating) R (β, $) transfer criteria requires an accountholder to rank variables related to participating institutions' accounts and products, and to the accountholder's own interests including, but not limited to, interest rates/yields, safety and credit ratings, deposit insurance afforded, transfer frequency, types of accounts/products, specific types of institutions, specific institutions, tax treatment, duration, fees, charges and penalties, local, national and/or international institutions, and establishment of various idiosyncratic formulas for governing transfers. The MRTS will rank and display R (β, $) transfer opportunities among participating institutions based on an accountholder's rankings. An accountholder can employ multiple rankings of transfer criteria to further diversify transfer opportunities. Furthermore, this process is not limited only to transfers of the right to earn interest (R (β, $)), but is applicable to any of the other individual, separable rights possessed by an owner of money.

Once the accountholder has established the R (β, $) transfer criteria, there are then at least six different iterations of the Accountholder-Specified Criteria REI Transfer Process that an MRTS Network accountholder may employ.

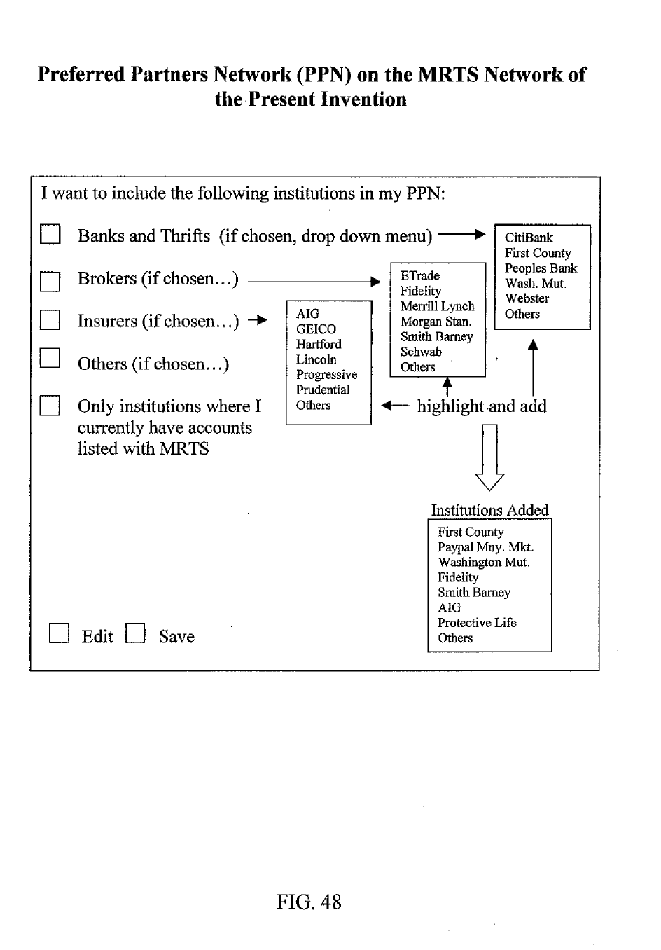

As shown in FIG. 14, when using the “Manual Restricted” Method, the accountholder pre-specifies criteria (highest rate/yield, credit, local, etc.), based upon only accounts and products offered by institutions in the accountholder's “Preferred Partner Network” (PPN) as shown in FIG. 48, that the accountholder deems important with regard to effecting an REI transfer. The MRTS Network then ranks and displays institutions' accounts and products based on the accountholder's pre-specified transfer criteria. The accountholder then selects from among the ranked and displayed accounts and products and effects the REI transfer(s) manually via the system of the present invention. The accountholder then receives confirmation, via the accountholder's preferred means, of the completed REI transfer(s).

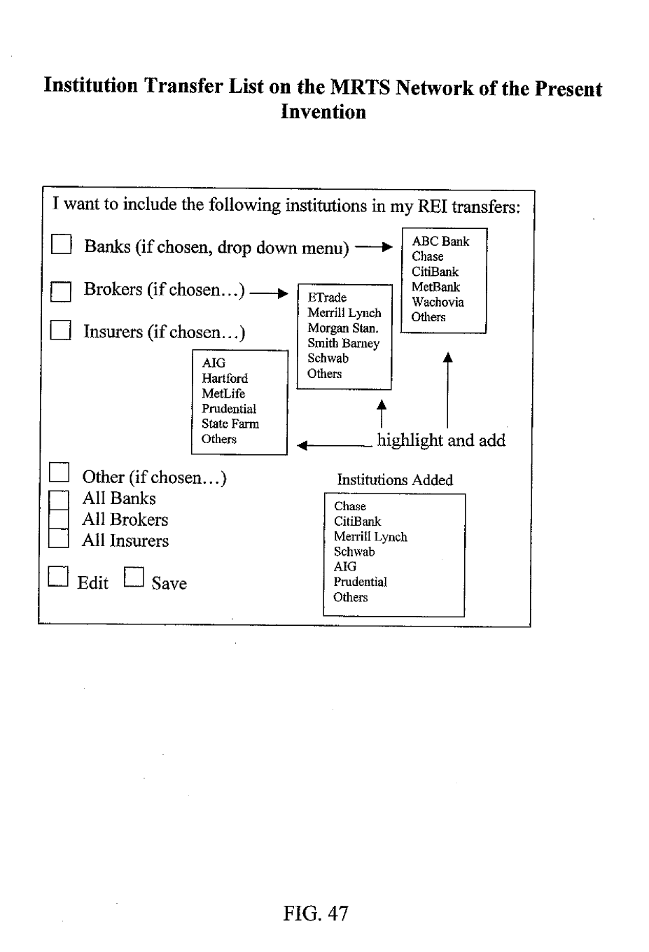

When utilizing the “Manual Semi-Restricted” transfer option on the MRTS Network, the accountholder, having pre-specified REI transfer criteria, is shown only institutions' accounts and products from institutions on the accountholder's “Institutions List”, as shown in FIG. 47. These institutions' accounts and products are ranked and displayed based on the accountholder's pre-specified REI transfer criteria. The accountholder then selects from among the ranked products and accounts and effects the REI transfer(s) manually via the MRTS Network of the present invention. The accountholder then receives confirmation, via the accountholder's preferred means, of the completed REI transfer(s).

The MRTS accountholder, when using the “Manual Unrestricted” Method, has all registered institutions' accounts and products ranked and displayed based on the accountholder's pre-specified REI transfer criteria. The accountholder then selects from among the ranked products and accounts and effects the REI transfer(s) manually via the MRTS Network of the present invention. The accountholder then receives confirmation, via the accountholder's preferred means, of the completed REI transfer(s).

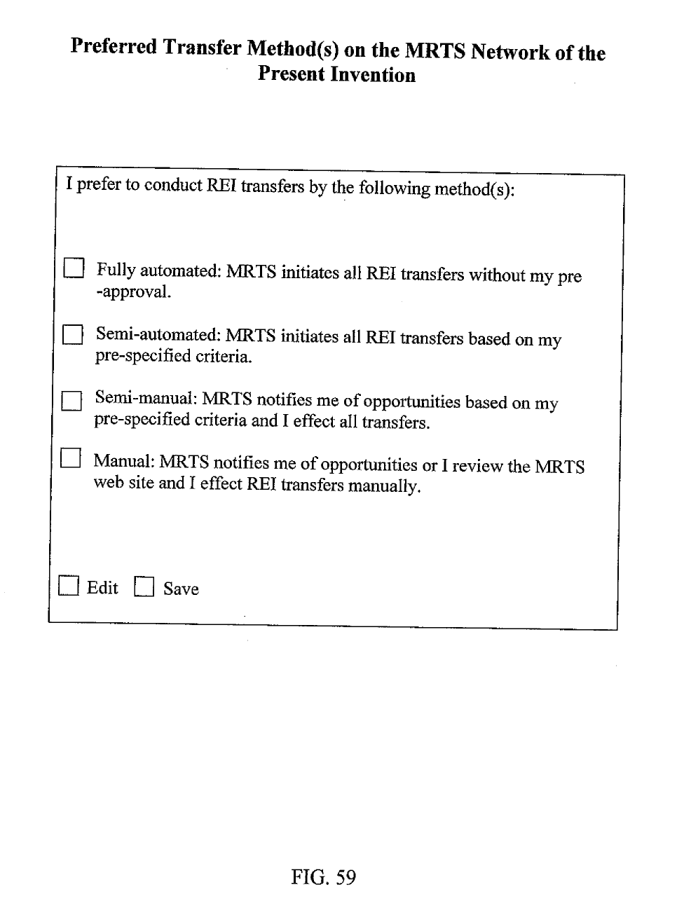

Prior to utilizing any of the automated REI transfer options provided by the MRTS Network, the accountholder has to elect to give the MRTS Network the authority to make automated transfers on the accountholder's behalf via the control panel provided by the MRT Network in FIG. 59.

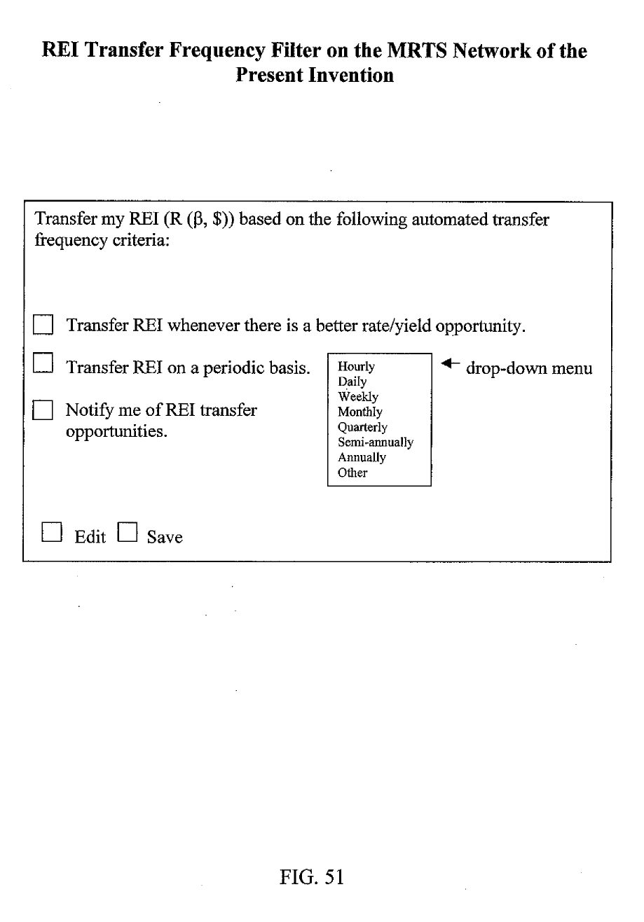

When using the “Automatic Restricted” Method, the MRTS Network continually ranks only those institutions' accounts and products that are included in the accountholder's PPN (FIG. 48), based on the accountholder's pre-specified REI transfer criteria. The MRTS Network of the present invention then effects REI transfers automatically, with the frequency of the REI transfers pre-determined by the accountholder via the control panel shown in FIG. 51. The accountholder then receives confirmation, via the accountholder's preferred means, of the completed REI transfer(s).

When using the “Automatic Semi-Restricted” Method, only institutions' accounts and products on the accountholder's “Institutions List” (FIG. 47) are continually ranked by the MRTS based on the accountholder's pre-specified REI transfer criteria. Based upon the desired REI transfer frequency, as indicated by the accountholder in the “REI Transfer Frequency Filter” control panel (FIG. 51), the MRTS Network automatically effects REI transfers on the accountholder's behalf. The accountholder then receives confirmation, via the accountholder's preferred means, of the completed REI transfer(s).

In the “Automatic Unrestricted” Method, all participating, registered institutions' accounts and products, that meet the accountholder's pre-specified REI transfer criteria, are continually ranked by the MRTS Network. The MRTS Network then effects REI transfers on the accountholder's behalf, with the frequency of such transfers pre-determined by the MRTS accountholder via the control panel shown in FIG. 51. The accountholder then receives confirmation, via the accountholder's preferred means, of the completed REI transfer(s).

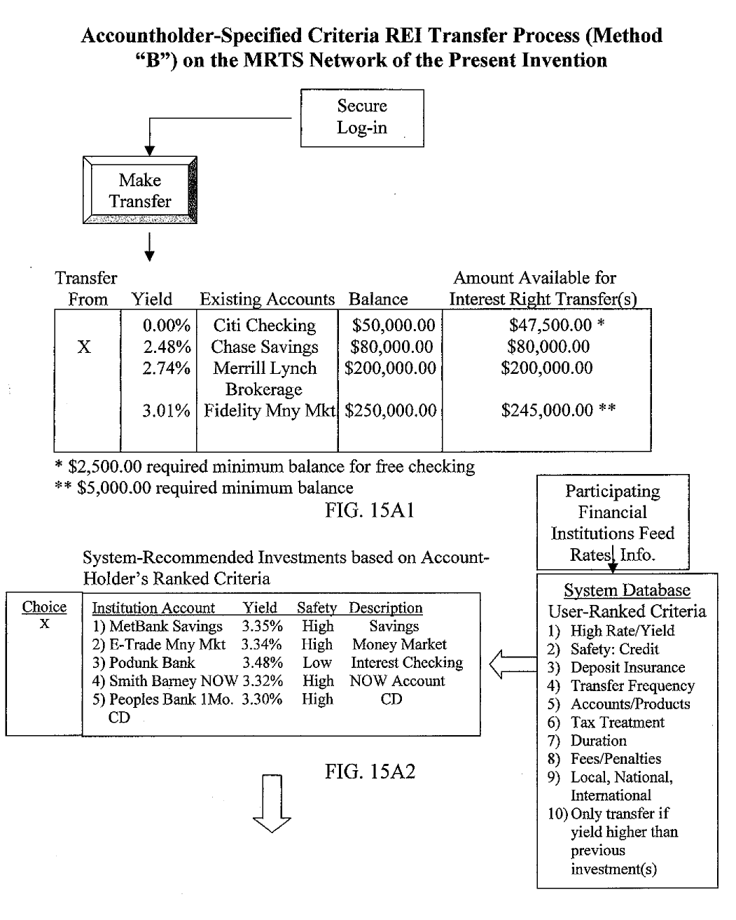

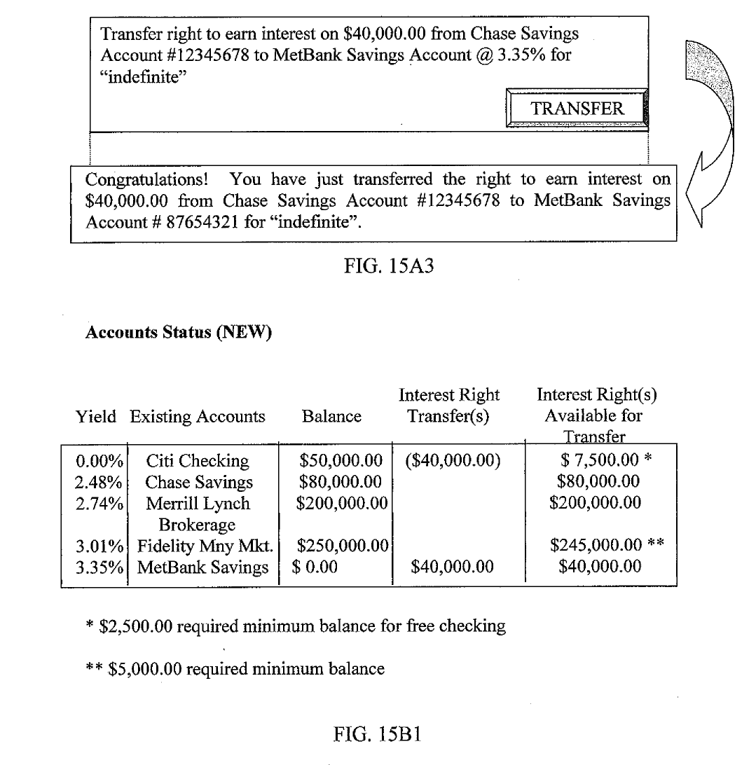

FIGS. 15A and 15B, taken together, set forth a schematic representation illustrating the User-Specified Criteria Right(s) Transfer Process (Method “B”) depicted in FIG. 14, illustrating that a system user/accountholder can pre-specify criteria by which the system will rank participating institutions' accounts/products for the system user, and then the system user can either effect a manual transfer of R (β, $) using the system's rankings, or the system user can, via pre-specification, allow the system to effect transfers automatically based on rankings of the user's pre-specified criteria, and throughout the process the system provides data regarding account balances, the transfer process and an “Accounts Status (New)” at the completion of the process.

After securely logging-in to the MRTS Network of the present invention, an accountholder chooses to “Make Transfer” and is then shown various balances held in the accountholder's various financial accounts and products at various financial institutions (FIG. 15A1). The accountholder then sees a screen (FIG. 15A2) that displays the system-ranked and recommended accounts and products, which are based on criteria pre-specified by the MRTS accountholder and, which, are derived from the various rate feeds supplied by participating financial institutions on the MRTS Network. From this screen the accountholder then selects the institution(s)/account(s) and/or product(s) to which to transfer the right to earn interest (R (β, $)).

The accountholder then sees a screen (FIG. 15A3) confirming the accountholder's choice(s); if correct the accountholder clicks the “TRANSFER” icon and receives a message confirming that the right transfer has been effected.

The accountholder then sees a new screen (FIG. 15B1) “Accounts Status (NEW)” which provides updated information on the accountholder's various balances in institutions' accounts and products.

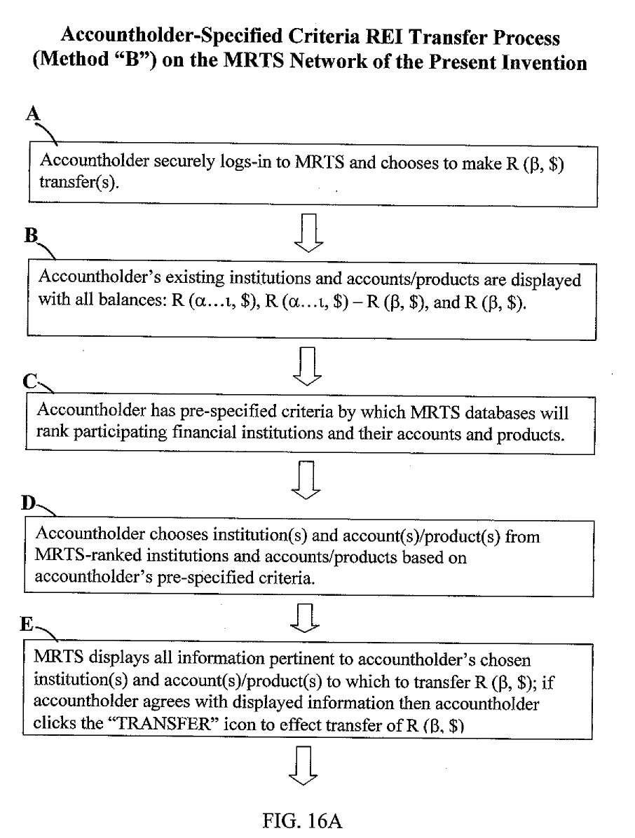

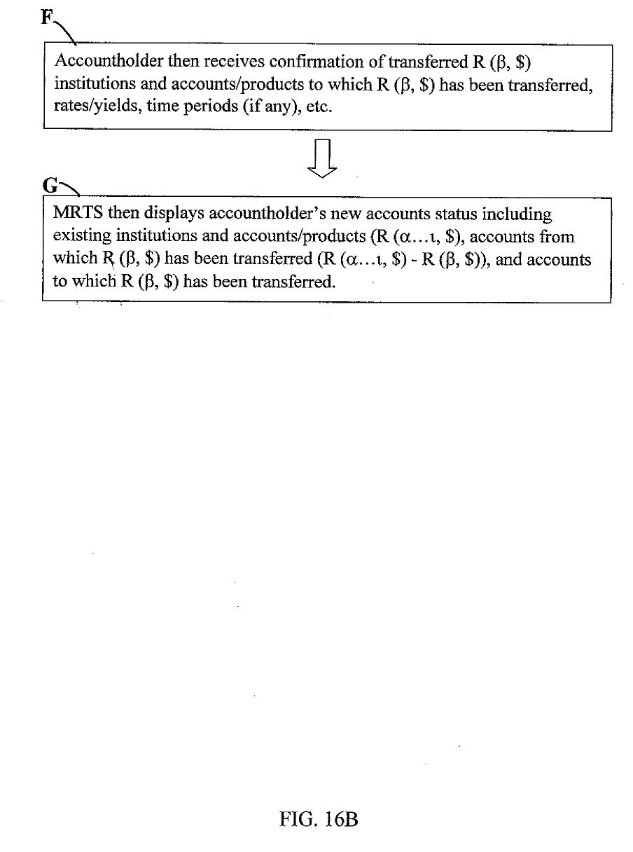

FIGS. 16A and 16B, taken together, set forth a flow chart that depicts the various steps in Method “B” illustrated in FIGS. 15A and 15B that allow a system user to transfer R (β, $), either manually or automatically, after pre-specifying R (β, $) transfer criteria and, in the manual iterations, receiving rankings of various institutions' accounts and products based on the pre-specified criteria via the system of the present invention. In the automated iterations, the MRTS Network automatically effects transfers on an accountholder's behalf based on the accountholder's pre-specified REI transfer criteria.

As indicated at Block A in FIGS. 16A and 16B, the accountholder securely logs-in to the MRTS Network of the present invention and chooses to make an REI (or other monetary right) transfer via the MRTS Network. At Block B, the accountholder's existing institutions and accounts/products are displayed with all balances: R (α . . . ι, $), R (α . . . ι, $)−R (β, $), and R (β, $). At Block C, the accountholder has pre-specified REI transfer criteria by which the MRTS Network databases will rank participating financial institutions and their accounts and products. At Block D, the MRTS accountholder, in the manual iterations of Method “B”, chooses an institution(s) and account(s)/product(s) from MRTS-ranked institutions and accounts/products based on the accountholder's pre-specified REI transfer criteria. At Block E, the MRTS Network displays all information pertinent to the accountholder's chosen institution(s) and account(s)/product(s) to which to transfer the accountholder's right to earn interest (R (β, $)); if the accountholder agrees with the displayed information, then the accountholder clicks the “TRANSFER” icon to effect a manual transfer of the right to earn interest (R (β, $)). At Block F, the accountholder receives confirmation of the transferred R (β, $), the names of the institutions' account(s)/product(s) to which the accountholder's R (β, $) has been transferred, and all of the pertinent information with regard to the account(s)/product(s) including: rate(s)/yield(s), time periods (if any), etc. At Block G, the MRTS Network then displays the accountholder's new accounts status including existing institutions and accounts/products' R (α . . . ι, $), accounts from which R (β, $) has been transferred (R (α . . . ι, $)−R (β, $)), and accounts to which R (β, $) has been transferred.

Notably, for the automatic REI transfer iterations of Method “B”, Blocks A-C are the same as in the manual iterations; however, Block D and Block E will consist of the MRTS Network effecting the REI transfer automatically on the MRTS accountholder's behalf based on the accountholder's pre-specified REI transfer criteria. Block F and Block G will remain the same.

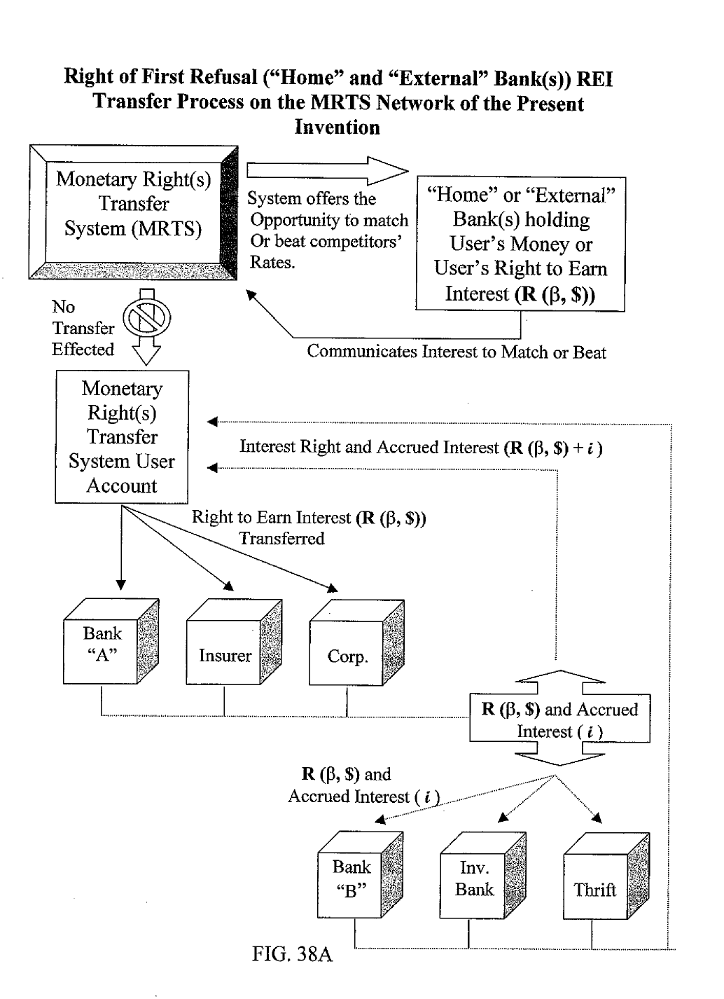

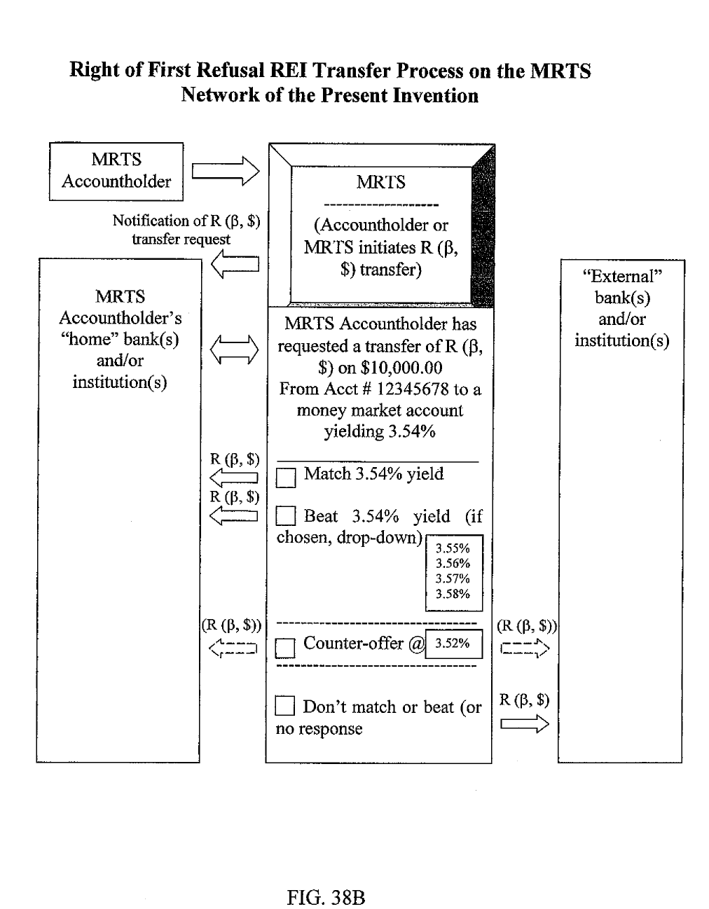

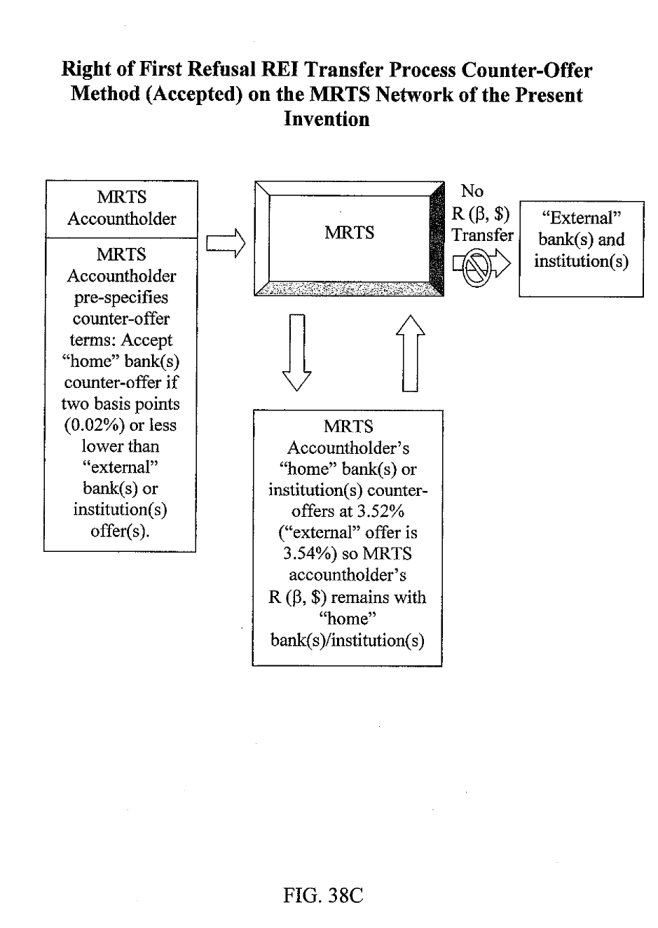

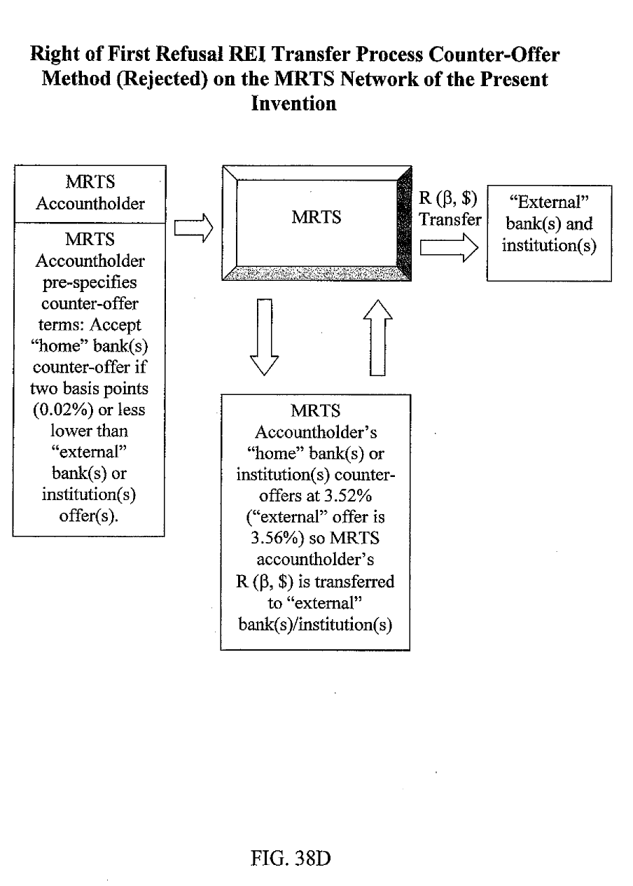

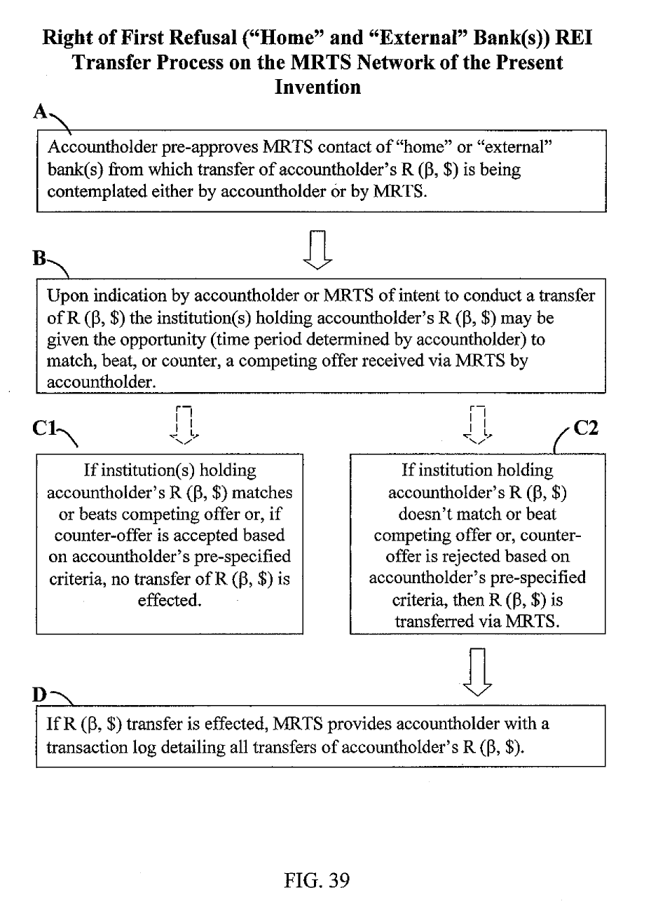

The system and method of the invention may provide a “right of first refusal” (See FIGS. 38 and 39) option to the system user's “home” institution(s) whereby the “home” institution would have a finite time period, determined by the system user, to decide whether or not to match competitors' offers prior to having the user's monetary right to earn interest (R (β, $)) transferred. Furthermore, the system would provide to the user's “home” institution(s) the opportunity to match or beat a competing offer even after the user's monetary right to earn interest (R (β, $)) had been transferred to an “external” institution(s). In such a case, the user would be apprised of the “home” institution's offer and would then have the option as to whether or not to accept said offer. The “home” institution would then facilitate (pay) for any transfer costs associated with transferring the system user's monetary right to earn interest (R (β, $)) back to the “home” institution.

One reason banks and other institutions may participate is because they may be able to provide their customers with higher rates of interest through a right-of-first-refusal option (See FIGS. 38 and 39) whereby the “home” or “external” bank(s) holding the system user's monies would have the opportunity to improve its own terms or, match or beat other offers from any other banks or financial institutions before the system user's monetary right to earn interest (R (β, $)) is transferred to other institutions. This would allow any bank or financial institution to compete on an individualized basis for a system user's monies as opposed to offering the same rate to the universe of potential customers. A bank might be willing to match or beat an offer from a competitor if it thought it might be able to sell the system user other, more lucrative, financial products and services. Obviously, banks offering higher rates of interest are trying to attract additional monies to their accounts and products. As an example, ABC Bank, which may offer a full range of banking and other financial products and services, may not be able to offer optimal interest rates on a range of accounts and instruments due to its high overhead and fixed costs. XYZ Bank may only offer checking, savings, CD's and other accounts on which it can pay much higher, or even optimal, interest rates because it doesn't have high overhead and fixed costs. Through use of the system of the invention, ABC Bank's customers can receive higher rates on their monies and investments at ABC Bank if ABC Bank chooses to match or beat XYZ Bank's (or any other bank's or institution's offer(s)) through the system's right-of-first-refusal feature.

### “Preferred Partner Network (PPN)” Right To Earn Interest (REI) Transfer Processes According To the Present Invention (Method C)

Referring to FIGS. 10B, 17, 18A, 18B, 19A, 19B, 46, 51 and 59 the REI Transfer Method “C” will be described in greater detail.

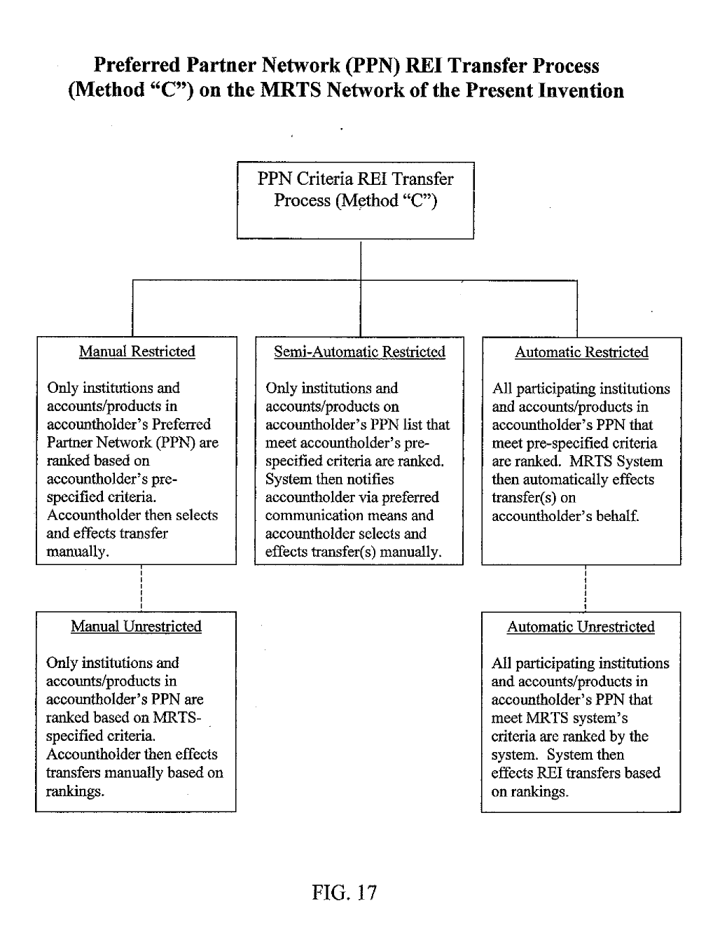

FIG. 17 is a flow chart depicting the MRTS Network Preferred Partner Network (PPN) REI Transfer Process and five of the different iterations of Method “C” including both manual and automatic REI transfer options. The MRTS accountholder begins by pre-establishing R (β, $) transfer criteria based on select institutions (or select accounts/products) with whom (which) the accountholder prefers to conduct all R (β, $) transfers via the MRTS.

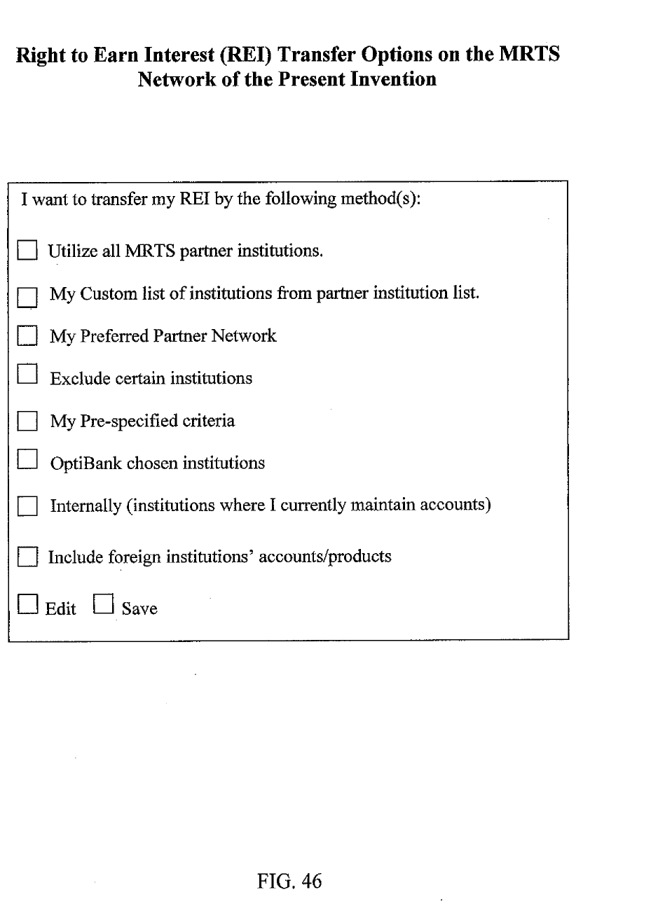

The accountholder then pre-specifies, via the control panel shown in FIG. 46, chooses to make a PPN criteria (Method “C”) REI transfer and has an option of picking between five separate iterations of this R (β, $) transfer process.

The first is the “Manual Restricted” iteration, by which an accountholder, after having logged-in to the MRTS Network, requests rankings of only pre-chosen institutions' accounts and products based on pre-specified REI transfer criteria. Only institutions' accounts/products (or accounts/products) in the accountholder's PPN are ranked and displayed based on an accountholder's pre-specified REI transfer criteria. The accountholder then selects from among the displayed ranked choices and effect an R (β, $) transfer(s) manually. The accountholder then receives confirmation, via the accountholder's preferred means, of the completed REI transfer(s).

In the “Semi-Automatic Restricted” iteration, only institutions' accounts/products (or accounts/products) that meet an accountholder's pre-specified R (β, $) transfer criteria are ranked by the MRTS. The MRTS then notifies the accountholder, via the accountholder's preferred contact method of a transfer(s) opportunity, and the accountholder then selects and effects the R (β, $) transfer manually from the MRTS Network ranked and displayed institutions' accounts/products (or accounts/products). The accountholder then receives confirmation, via the accountholder's preferred means, of the completed REI transfer(s).

In the “Automatic Restricted” R (β, $) transfer iteration of Method “C”, all participating PPN institutions' accounts/products that meet the accountholder's pre-specified R (β, $) transfer criteria are ranked by the MRTS Network. Then, based on pre-approval to make automatic REI transfers given by the accountholder in the control panel shown in FIG. 59, the MRTS effects the R (β, $) transfer automatically on behalf of the accountholder. The accountholder then receives confirmation, via the accountholder's preferred means, of the completed REI transfer(s).

In the “Manual Unrestricted” R (β, $) transfer iteration, only institutions' accounts/products in the accountholder's PPN are ranked based not on the MRTS accountholder's pre-specified REI transfer criteria, but on MRTS-specified REI transfer criteria. The accountholder then chooses from among the MRTS-ranked PPN accounts/products and effects the R (β, $) transfer manually. The accountholder then receives confirmation, via the accountholder's preferred means, of the completed REI transfer(s).

Finally, in the “Automatic Unrestricted” R (β, $) transfer process, all participating, registered PPN institutions' accounts/products that meet the MRTS R (β, $) transfer criteria are ranked by the MRTS. The MRTS, having received accountholder pre-approval via the control paned shown in FIG. 59, then effects the R (β, $) transfer(s) automatically on behalf of the MRTS accountholder. The accountholder then receives confirmation, via the accountholder's preferred means, of the completed REI transfer(s).

As in previous embodiments of the present invention, throughout the transfer process the accountholder is presented with different screens apprising the accountholder of the status of the transfer process.

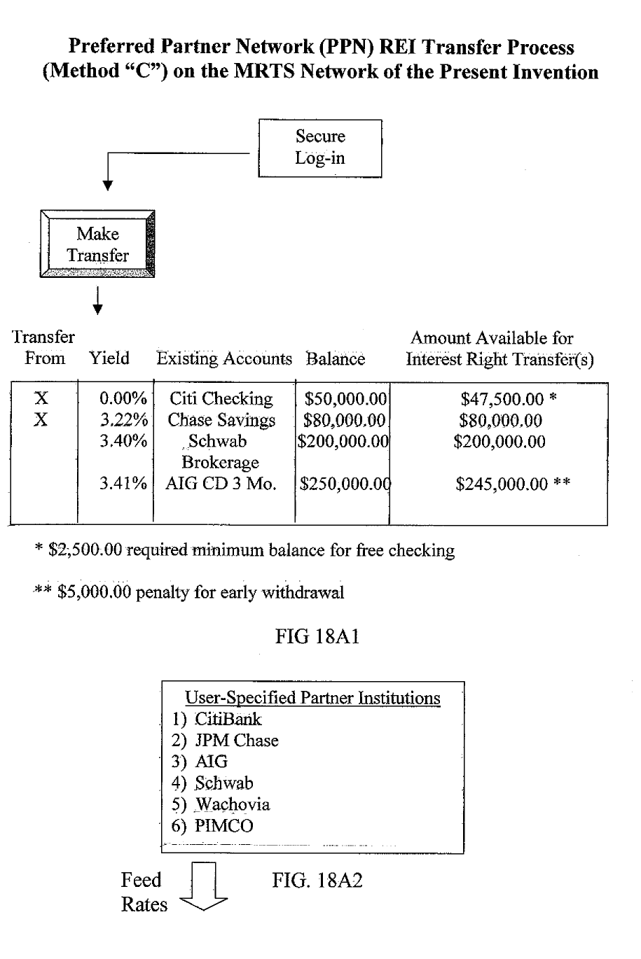

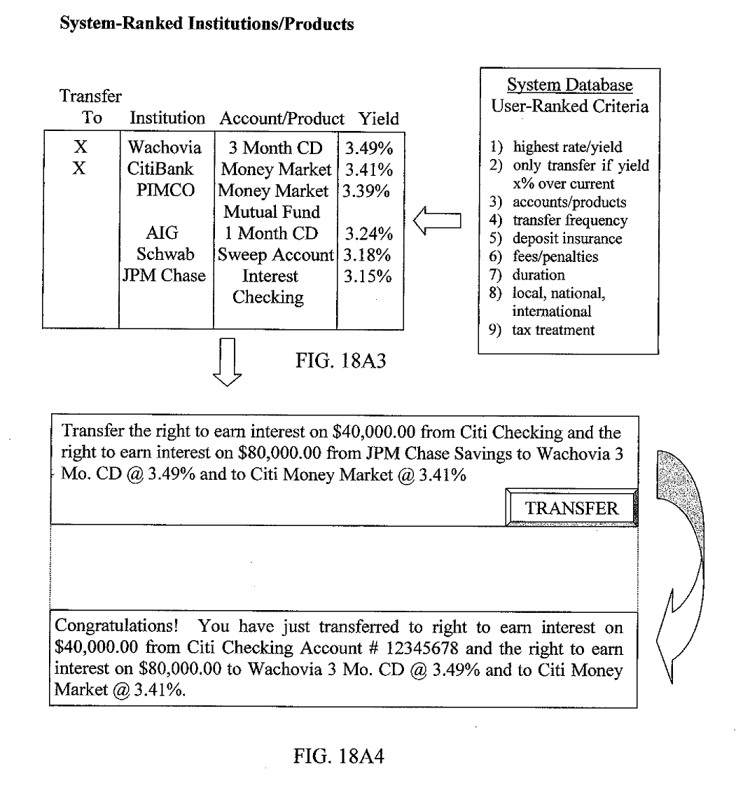

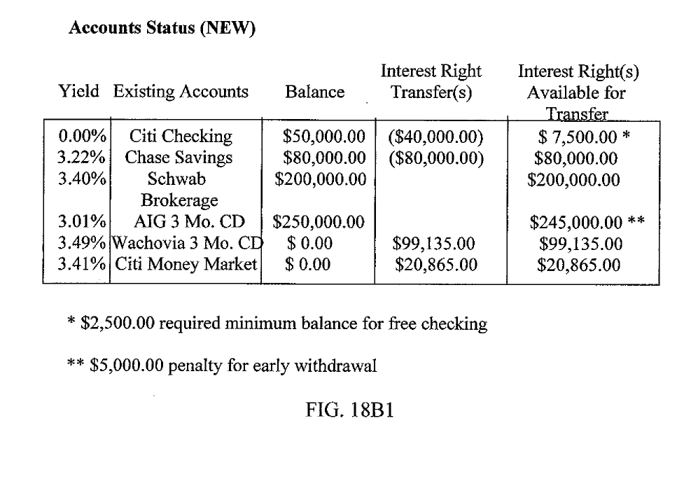

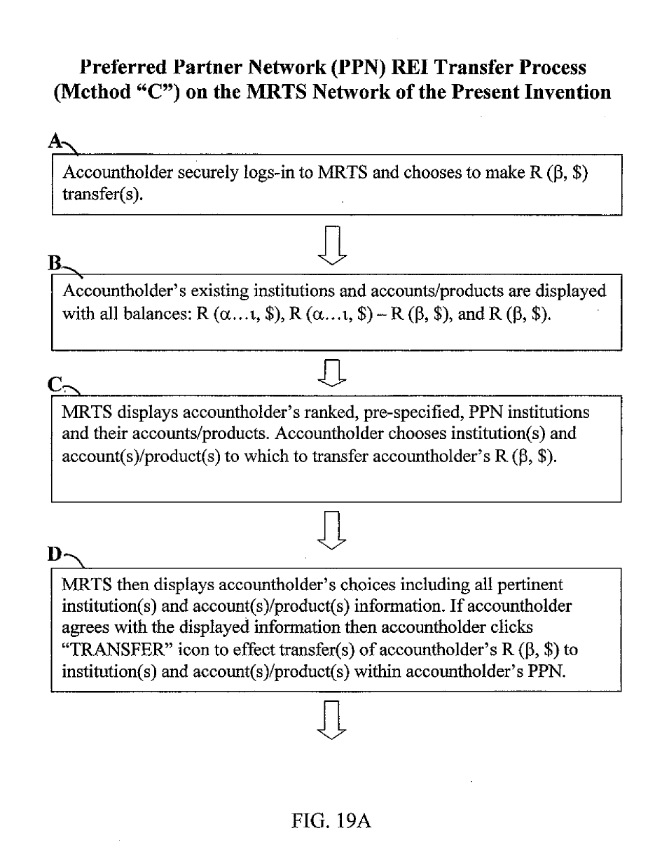

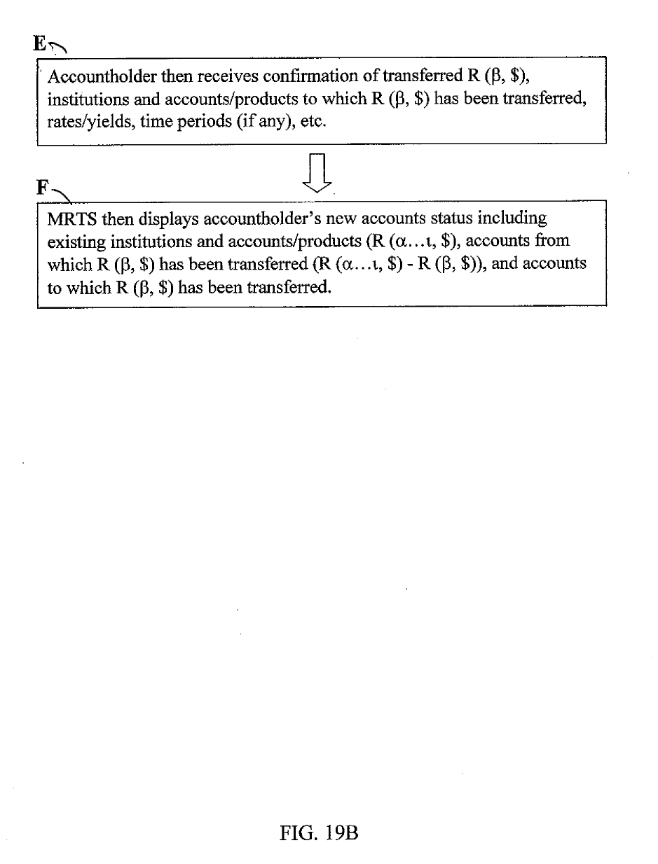

FIGS. 18A1 through 18B1, taken together, set forth a schematic representation depicting the various steps in the Method “C” illustrated in FIGS. 19A and 19B that allow a user to pre-specify certain participating institutions (preferred partners) to which to transfer an MRTS accountholder's R (β, $) based on the accountholder's or the system's rankings of those institutions' accounts and products, with the actual transfer(s) either being effected manually by the system user or, automatically by the system based on the user's (or system's) pre-specified REI transfer criteria and, as with other transfer methods, the system provides account balances, (R (β, $)) transfer progress and an “Accounts Status (New)” at the completion of the process.

After securely logging-in to the MRTS Network, the MRTS accountholder is presented with a screen (FIG. 18A1) that shows the accountholder's existing institutions' accounts and products, existing balances, and the amount available for interest right (R (β, $)) transfer(s). From this screen the MRTS accountholder chooses from which accounts to transfer the accountholder's REI. (In the automatic transfer iterations, the accountholder will pre-choose from which accounts the MRTS Network will effect automatic REI transfers on the accountholder's behalf).

FIG. 18A2 shows a screen that provides an MRTS accountholder's Preferred Partner Network (PPN) institutions, as pre-chosen by the MRTS accountholder.

The accountholder is presented with a new screen (FIG. 18A3) that has ranked the accountholder's PPN institutions' accounts/products based on the accountholder-specified R (β, $) transfer criteria. From this screen the accountholder indicates to which institutions' accounts/products to transfer the accountholder's right to earn interest (R (β, $)).

The accountholder is then presented with a screen (FIG. 18A4) that confirms all of the relevant details of the accountholder's intended R (β, $) transfer(s), and if the accountholder agrees with the information presented by the MRTS, the accountholder then clicks on the “TRANSFER” icon to effect the intended R (β, $) transfer(s).

The accountholder immediately receives a message confirming all of the details of the just-executed R (β, $) transfer(s). The accountholder is then presented with a new screen (FIG. 18B1), “Accounts Status (NEW)”, that displays all of the accountholder's accounts/products, balances, interest rates/yields, etc., post-R (β, $) transfer(s).

FIGS. 19A and 19B, taken together, set forth a flow chart that depicts the various steps in Method “C” illustrated in FIGS. 18A and 18B that allow an accountholder to transfer R (β, $) via the accountholder's pre-established PPN, either manually or automatically, after pre-specifying R (β, $) transfer criteria (or utilizing the MRTS Network's REI transfer criteria) and receiving rankings of various institutions' accounts and products, based on the accountholder's pre-specified criteria, via the system of the present invention. In the automated iterations of Method “C”, the accountholder doesn't receive the PPN institutions' accounts/products rankings, as the MRTS Network either utilizes the accountholder's pre-specified REI transfer criteria, or that REI transfer criteria proprietary to the MRTS Network, to effect REI transfers.

As indicated in Block A of FIGS. 19A and 19B, an MRTS Network accountholder securely logs-in to the MRTS Network and chooses to make an R (β, $) transfer(s). At Block B the MRTS accountholders' existing institutions and account/products are displayed with all balances: R (α . . . ι, $), R (α . . . ι, $)−R (β, $), and R (β, $). At Block C the MRTS Network displays an accountholder's ranked, pre-specified, PPN institutions and their accounts/products (or accounts/products). The accountholder then chooses institution(s) and account(s)/products (or account(s)/product(s) to which to transfer the accountholder” REI (R (β, $)). At Block D the MRTS Network then displays the accountholder's REI transfer choices, including all pertinent institution(s) and account(s)/product(s) (or account(s)/product(s)). If the MRTS accountholder agrees with the displayed information, then the accountholder clicks the “TRANSFER” icon to effect transfer(s) of the accountholder's REI (R (β, $)) to the chosen institution(s) and account(s)/product(s) (or account(s)/product(s)) within the accountholder's PPN. At Block E, the accountholder then receives confirmation of the transferred R (β, $), institution(s) and account(s)/product(s) to which the accountholder's R (β, $) has been transferred, and all relevant information relating to rates/yields, time periods (if any), etc. At Block F, the MRTS Network then displays the accountholder's new accounts status including existing institutions and accounts/products R (α . . . ι, $), accounts from which the accountholder's R (β, $) has been transferred (R (α . . . ι, $)−R (β, $)), and accounts to which the accountholder's R (β, $) has been transferred.

NOTE: For the automatic REI transfer iterations of Method “C”, the Blocks A-C are the same as in the manual iterations; however, Block D will consist of the MRTS Network effecting the REI transfer automatically on the MRTS accountholder's behalf based on the accountholder's pre-specified REI transfer criteria or, on the MRTS Network's REI transfer criteria. Block F will remain the same.

### “System-Selected” REI Transfer Processes According To the Present Invention (Method “D”)

Referring to FIGS. 10B, 20, 21A, 21B, 22A, 22B, 47, 48, and 59. REI Transfer Method “D” will be described in greater detail.

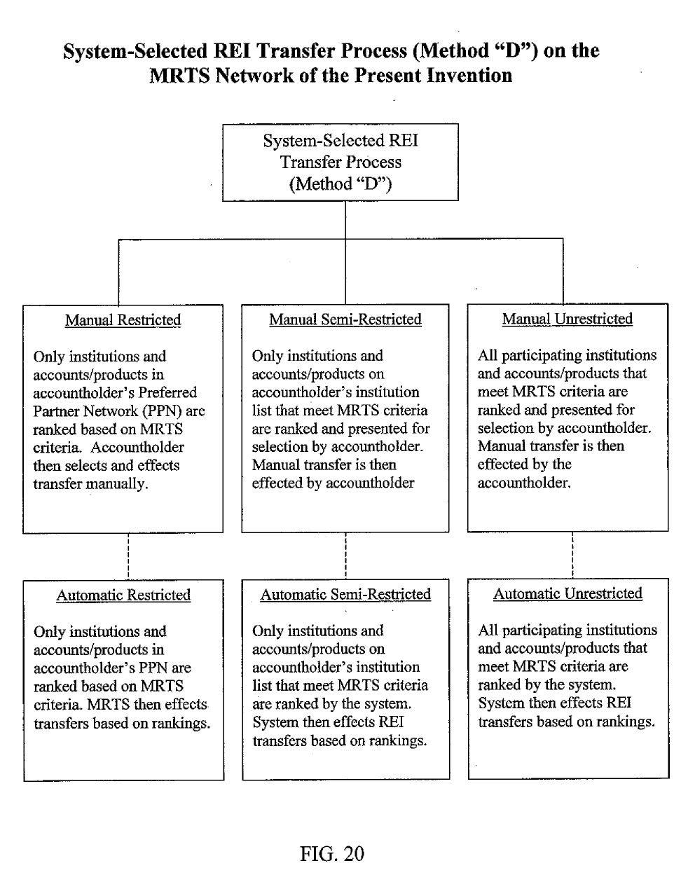

FIG. 20 is a flow chart is a flow chart depicting the MRTS Network System-Selected REI Transfer Process and six of the different iterations of Method “D”, including both manual and automatic REI transfer options. As opposed to using accountholder pre-established REI transfer criteria as shown in previous REI transfer methods, this process uses the MRTS Network's REI transfer criteria to recommend institutions' accounts/products for manual REI transfers and, by which, to effect automatic REI transfers on the accountholder's behalf. Under this R (β, $) transfer method, the accountholder can still pick preferred institutions (PPN), a broader list of institutions, or open up the ranking process to all participating institutions.

In the “Manual Restricted” iteration of Method “D”, only institutions' accounts/products pre-specified in the accountholder's PPN (see FIG. 48) are ranked and displayed based on the MRTS Network's REI transfer criteria. From these rankings, the accountholder then selects institutions' account(s)/product(s) to which to transfer the accountholder's R (β, $), and then the MRTS accountholder effects the R (β, $) transfer manually. The accountholder then receives confirmation, via the accountholder's preferred means, of the completed REI transfer(s).

Under the “Manual Semi-Restricted” iteration of Method “D”, only the institutions' accounts/products on the accountholder's Institutions List, as shown in the “Institution Transfer List” control panel in FIG. 47, that meet the MRTS R (β, $) transfer criteria are ranked and displayed for perusal by the accountholder. The accountholder then selects and effects the R (β, $) transfer(s) manually. The accountholder then receives confirmation, via the accountholder's preferred means, of the completed REI transfer(s).

In the “Manual Unrestricted” iteration of Method “D” all participating, registered institutions' accounts/products that meet the MRTS R (β, $) transfer criteria are ranked and presented for selection by the accountholder. The MRTS Network accountholder then selects and effects the R (β, $) transfer(s) manually. The accountholder then receives confirmation, via the accountholder's preferred means, of the completed REI transfer(s).

In the “Automatic Restricted” iteration of Method “D” only institutions' accounts/products pre-specified in the accountholder's PPN (see FIG. 48) are ranked based on the MRTS R (β, $) transfer criteria. The MRTS Network then effects R (β, $) transfer(s) automatically on behalf of the accountholder, as pre-approved by the accountholder via the control panel shown in FIG. 59. The accountholder then receives confirmation, via the accountholder's preferred means, of the completed REI transfer(s).

In the “Automatic Semi-Restricted” iteration of Method “D” only institutions' accounts/products on the accountholder's “Institution Transfer List” control panel (see FIG. 47) that meet the MRTS Network's R (β, $) transfer criteria are ranked by the MRTS. The MRTS then effects R (β, $) transfer(s) automatically on behalf of the accountholder via the pre-approval granted by the accountholder in the control panel shown in FIG. 59. The accountholder then receives confirmation, via the accountholder's preferred means, of the completed REI transfer(s).

Finally, in the “Automatic Unrestricted” iteration of Method “D” all participating institutions' accounts/products that meet the MRTS R (β, $) transfer criteria are ranked by the MRTS Network. The MRTS then effects R (β, $) transfer(s) automatically on behalf of the accountholder, again via the approval granted by the accountholder via the control panel shown in FIG. 59. The accountholder then receives confirmation, via the accountholder's preferred means, of the completed REI transfer(s).

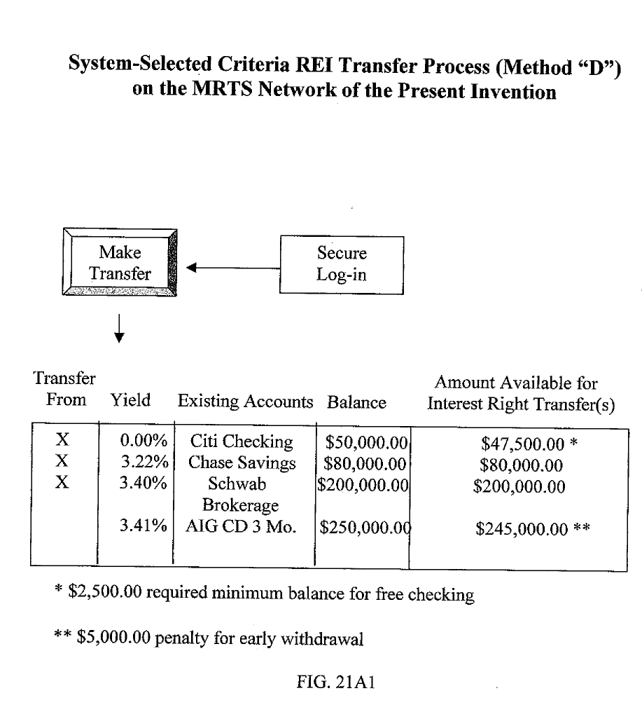

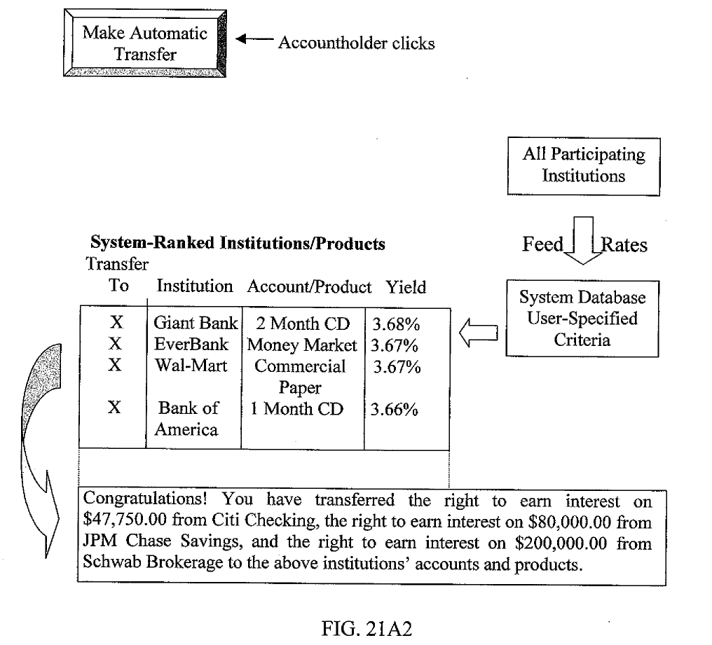

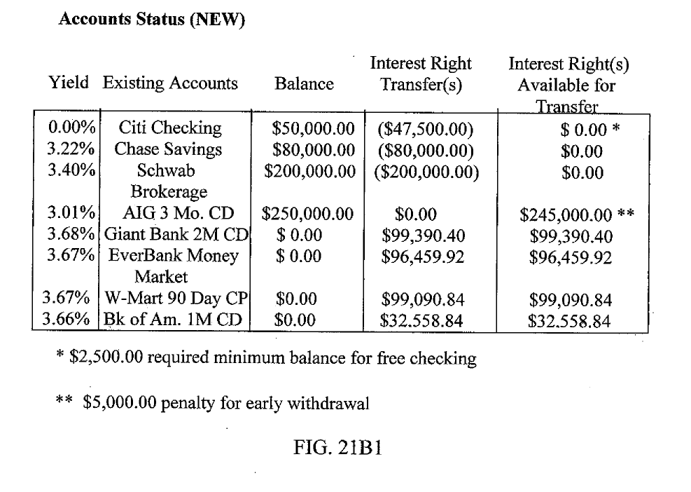

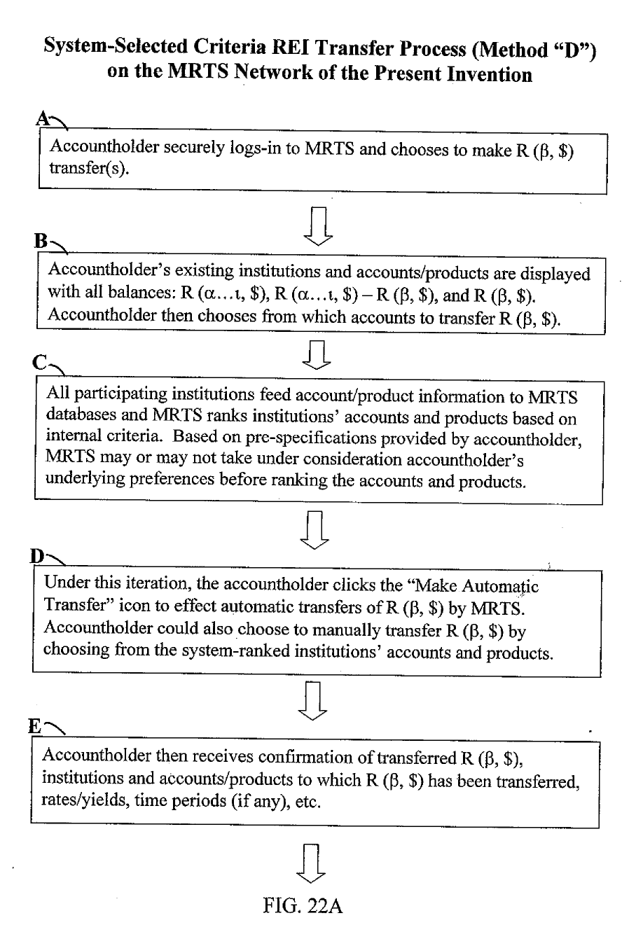

FIGS. 21A and 21B, taken together, set forth a schematic representation of the System-Selected Criteria Right(s) Transfer Process (Method “D”) that allows a system user to turn over the entire REI transfer process to the system of the present invention with automatic transfers of R (β, $) based on the system's own criteria or, to receive the rankings based on the system-selected criteria and then effect manual right(s) transfers, with the MRTS providing account balances, transfer progress and an “Account Status (NEW)” at the end of the right(s) transfer process.

FIGS. 21A1 through 21B1 show a schematic representation of the MRTS System-Selected Criteria Right(s) Transfer Process (Method “D”) that allows an MRTS accountholder to utilize the proprietary R (β, $) transfer criteria of the MRTS to effect R (β, $) transfers. The example shown is the “Automatic Unrestricted” iteration of Method “D”.

After logging-in and deciding to effect an R (β, $) transfer, the MRTS accountholder is then presented with a screen (FIG. 21A1) that provides the accountholder with all existing account information as known to the MRTS. From this screen the accountholder then selects from which account(s)/product(s) to transfer the accountholder's R (β, $).

The accountholder then clicks on the “Make Automatic Transfer” icon to effect the “Automatic Unrestricted” R (β, $) transfer process.

FIG. 21A2, a new screen presented to the accountholder, shows all participating institutions' accounts/products that meet the MRTS R (β, $) transfer criteria, ranked for the benefit of the accountholder. As the MRTS is effecting the automatic R (β, $) transfer(s) on behalf of the accountholder, the next thing the accountholder sees is the message confirming all of the relevant details of the MRTS automatic R (β, $) transfer(s).

The accountholder is then presented with a new screen, “Accounts Status (NEW)”, as shown in FIG. 21B1, that displays the accountholder's new accounts/products, balances, interest rates/yields, etc., post-automated R (β, $) transfer(s).

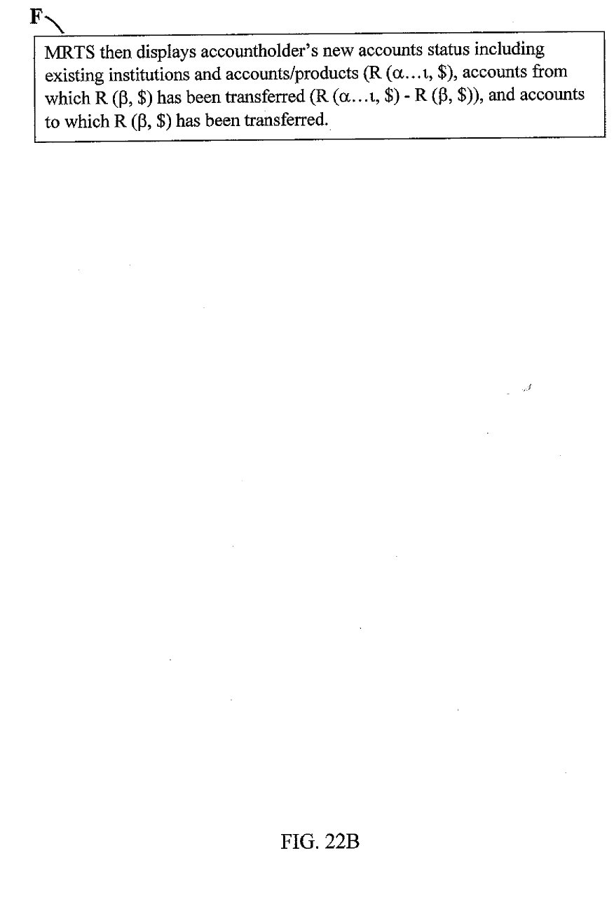

FIGS. 22A and 22B, taken together, set forth a flow chart that depicts the various steps in the System-Selected Criteria Right(s) Transfer Process (Method “D”) that allow a system user to automatically, semi-automatically or manually transfer R (β, $) based on MRTS Network-selected criteria that ranks various participating institutions' accounts and products based on the MRTS' own internal criteria, and features constant updates on account balances, transfer progress and an “Accounts Status (NEW)” at the completion of the transfer process.

As indicated at Block A of FIGS. 22A and 22B, an MRTS Network accountholder securely logs-in to the MRTS Network and chooses to make an R (β, $) transfer(s). At Block B the MRTS Network's accountholder's existing institutions and accounts/products are displayed with all balances: R (α . . . ι, $), R (α . . . ι, $)−R (β, $), and R (β, $). In the manual REI transfer iterations, the accountholder then chooses from which account(s) to transfer the REI. In the automatic REI transfer iterations the accountholder will pre-choose from which accounts the MRTS will automatically transfer the accountholder's REI. At Block C, all participating, registered institutions feed account/product information to the MRTS Network databases and the MRTS Network then ranks institutions' accounts/products based on the MRTS Network's internal REI transfer criteria. Based on pre-specifications provided by the MRTS accountholder, the MRTS Network may, or may not, take under consideration an accountholder's underlying REI transfer preferences before ranking the institutions' accounts and products. AT Block D, the accountholder clicks the “Make Automatic Transfer” icon to have the system effect automatic REI transfers. Conversely, an MRTS Network accountholder could also choose to make a manual REI transfer based MRTS Network's rankings of the institutions' accounts/products. At Block E, the MRTS Network accountholder receives confirmation of R (β, $) transfer(s) including institutions and accounts/products to which the accountholder's R (β, $) has been transferred, rates/yields, time periods (if any), etc. At Block F, the MRTS Network then displays the accountholder's new accounts status including existing institutions and accounts/products (R (α . . . ι, $), accounts from which the accountholder's R (β, $) has been transferred (R (α . . . ι, $)−R (β, $)), and accounts to which the accountholder's R (β, $) has been transferred.

### “Internal” REI Transfer Processes According To the Present Invention (Method “E”)

Referring to FIGS. 10B, 23, 24A, 24B, 25A, 25B, and 59. REI Transfer Method “D” will be described in greater detail.

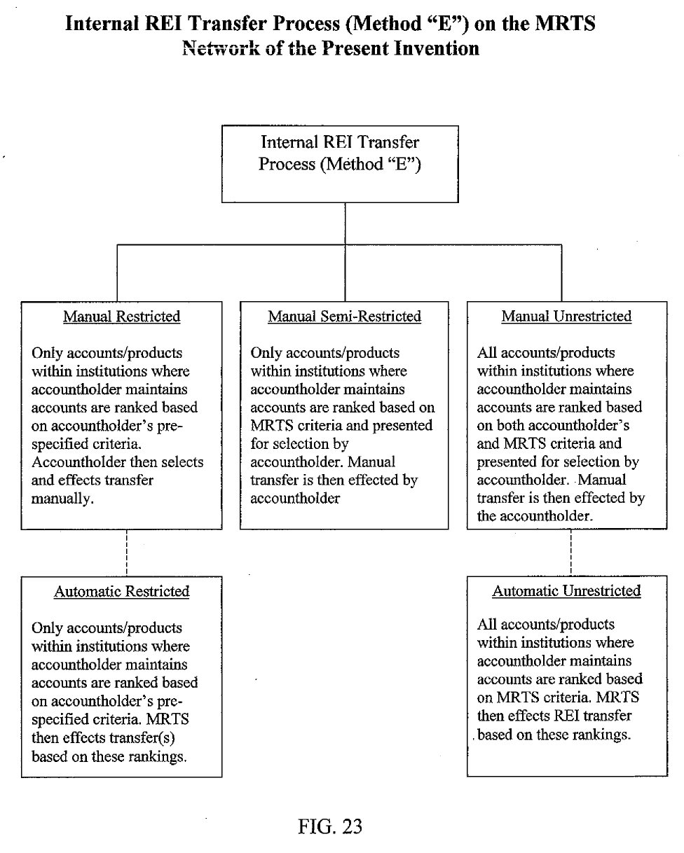

FIG. 23 is a flow chart is a flow chart depicting the MRTS Network Internal REI Transfer Process (Method “E”) and five of the different iterations of Method “D”, including both manual and automatic REI transfer options. Method “E” allows an MRTS accountholder to transfer the accountholder's R (β, $) internally, among “home” institutions' accounts/products where the accountholder's R (β, $) currently resides. This method is also applicable to “external” institutions to which an accountholder's R (β, $) has been transferred, and are thus considered new “internal” institutions.

In the “Manual Restricted” iteration of Method “E”, only institutions' accounts/products where the MRTS accountholder currently maintains accounts/products are ranked by the MRTS based on the accountholder-specified R (β, $) transfer criteria. From the ranked, displayed accounts/products, the accountholder selects and effects the R (β, $) transfer(s) manually. The accountholder then receives confirmation, via the accountholder's preferred means, of the completed REI transfer(s).

In the “Manual Semi-Restricted” iteration of Method “E” only the institutions' accounts/products within institutions where the MRTS accountholder currently maintains accounts/products are ranked based on the MRTS proprietary R (β, $) transfer criteria and presented for selection by the accountholder. The MRTS accountholder then selects account(s)/product(s) and effects the R (β, $) transfer(s) manually. The accountholder then receives confirmation, via the accountholder's preferred means, of the completed REI transfer(s).

In the “Manual Unrestricted” iteration of Method “E” all institutions' accounts/products where an MRTS accountholder maintains accounts/products are ranked based on both the accountholder's and on the MRTS proprietary R (β, $) transfer criteria and displayed for selection by the MRTS accountholder. The accountholder then selects accounts/products based on either, or both, criteria and effects the R (β, $) transfer(s) manually. The accountholder then receives confirmation, via the accountholder's preferred means, of the completed REI transfer(s).

In the “Automatic Restricted” iteration of Method “E” only accounts/products within institutions where an MRTS accountholder maintains accounts accounts/products are ranked based on accountholder's pre-specified R (β, $) transfer criteria. The MRTS then effects transfers automatically, having given pre-approval for automatic REI transfers via the control panel shown in FIG. 59, based on these rankings, on behalf of the MRTS accountholder. The accountholder then receives confirmation, via the accountholder's preferred means, of the completed REI transfer(s).

In the “Automatic Unrestricted” iteration of Method “E” all accounts/products within institutions where an MRTS accountholder currently maintains accounts/products are ranked based on the MRTS proprietary R (β, $) transfer criteria. The MRTS then effects the accountholder's R (β, $) transfer automatically based on the MRTS proprietary R (β, $) transfer criteria rankings. Again, pre-approval for the automatic REI transfer is provided by the MRTS accountholder via the control panel shown in FIG. 59. The accountholder then receives confirmation, via the accountholder's preferred means, of the completed REI transfer(s).

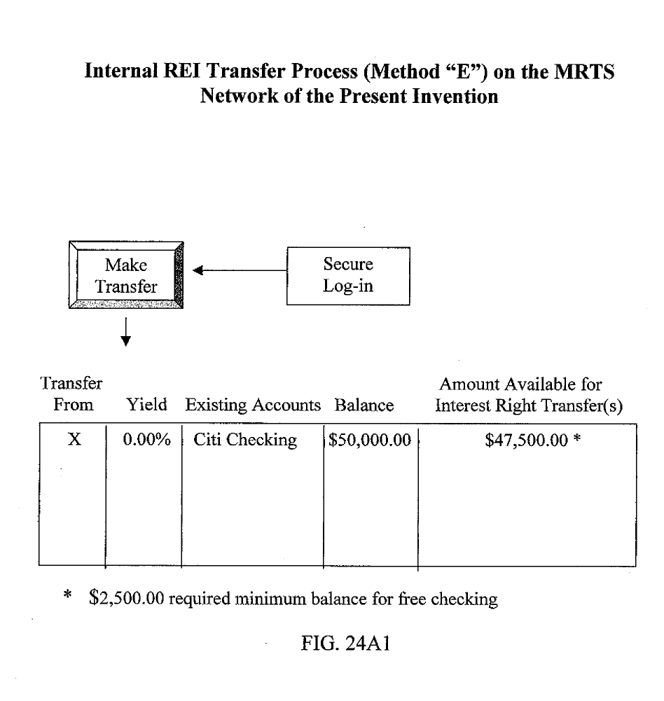

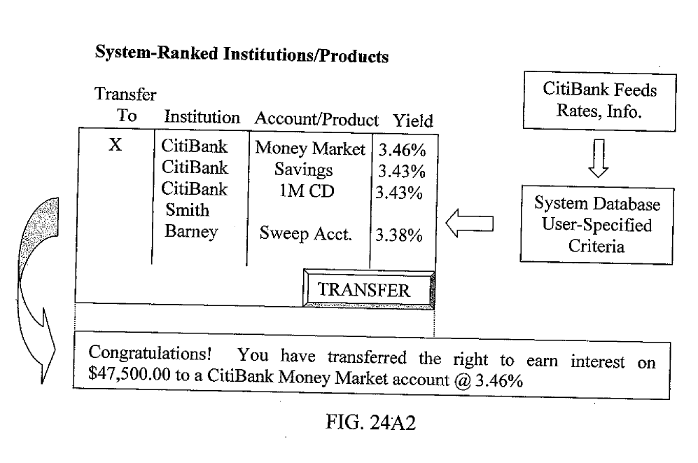

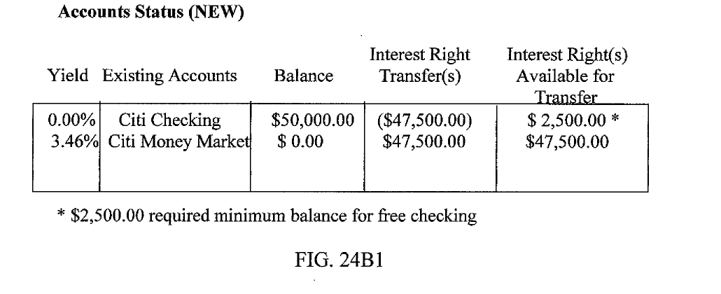

FIGS. 24A and 24B show a schematic representation of the MRTS Internal Right(s) Transfer Process (Method “E”) that allows a system user to transfer the right to earn interest (R (β, $)) (or other right(s)) internally within the “home” or “external” (new “internal”) institution's accounts/products where the R (β, $) resides, such process allowing a system user to manually transfer R (β, $), semi-automatically transfer R (β, $) or, to specify that the system automatically transfer R (β, $) based on user's pre-specified transfer criteria, all the while providing the system user with account balances, transfer progress and, at completion, an “Accounts Status (NEW)” showing update account balances. The example shown is the “Manual Restricted” iteration of Method “E”.

After securely logging-in to the MRTS site and opting to conduct an R (β, $) transfer, the accountholder sees a screen (FIG. 24A1) that displays all of the accountholder's present institutions' accounts/products information including balances, rates/yields, and the amount of R (β, $) available for transfer that is unencumbered by any restrictions. The accountholder then selects from which account to transfer the accountholder's R (β, $).

FIG. 24A2 displays all internal accounts/products as ranked by the MRTS Network based on the accountholder's pre-specified R (β, $) transfer criteria. The accountholder then selects to which account to transfer the accountholder's R (β, $) and clicks on the “TRANSFER” icon. The MRTS Network accountholder then receives a message confirming all the relevant financial details of the completed R (β, $) transfer.

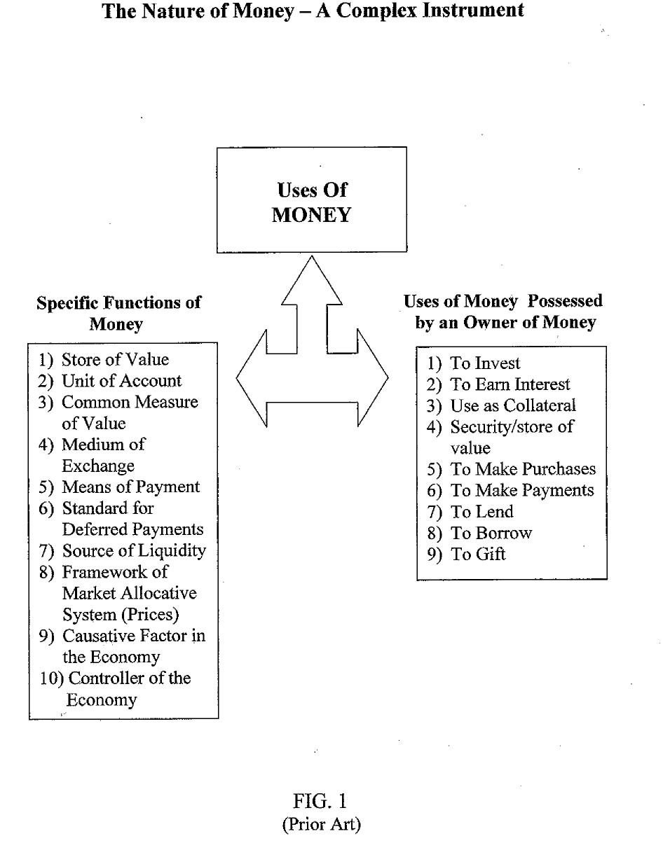

Finally, the accountholder sees a new screen (FIG. 24B-1), “Accounts Status (NEW), that shows all of the updated, post-R (β, $) transfer, account balances, rate/yields, etc.

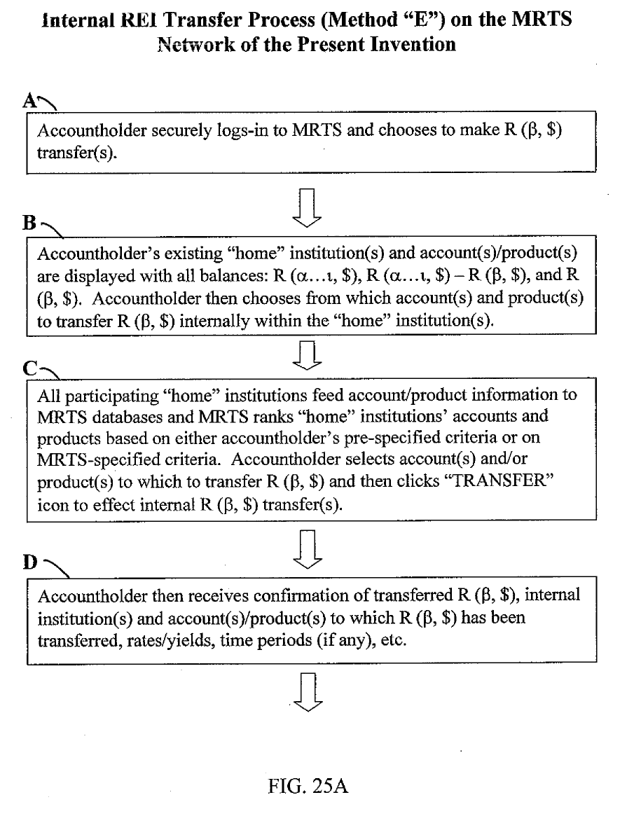

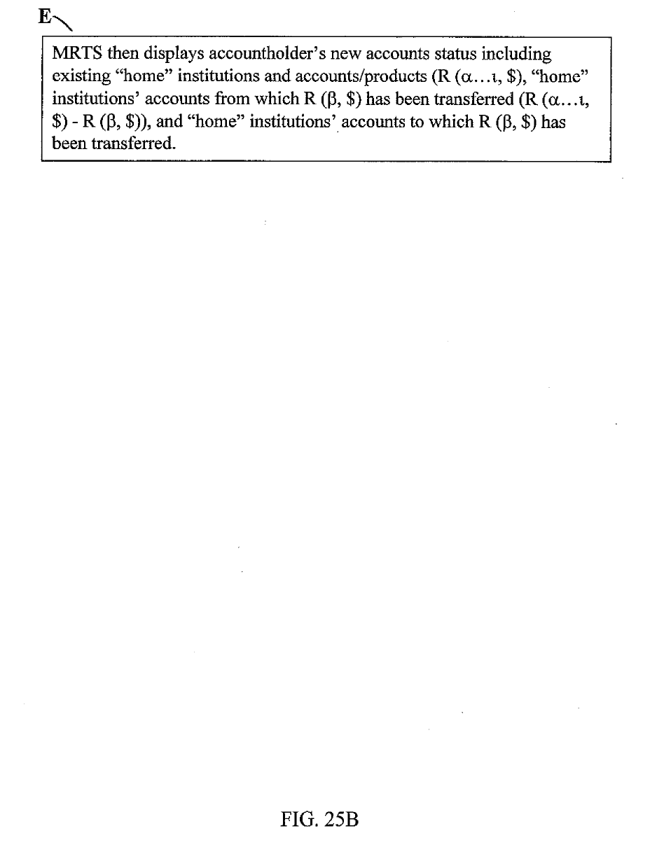

FIGS. 25A through 25B, taken together, set forth a flow chart depicting the various steps in Method E allowing a system user to automatically, semi-automatically or manually transfer R (β, $) internally within the “home” or “external” (new “internal”) institution(s) accounts and products where R (β, $) resides, either manually, semi-automatically or automatically, and features constant updates on account balances, transfer progress and an “Accounts Status (NEW)” at the completion of the transfer process.

Now referring to FIG. 25A, at Block A, the MRTS Network accountholder securely logs-in to the MRTS Network and chooses to make an R (β, $) transfer(s). At Block B, the MRTS accountholder's existing “home” institution(s) accounts and products are displayed will all balances: R (α . . . ι, $), R (α . . . ι, $)−R (β, $), and R (β, $). The MRTS accountholder then chooses from which account(s) and/or product(s) to transfer R (β, $) internally, within the “home” institution(s). AT Block C, all participating “home” institutions feed account/product information to the MRTS Network databases and the MRTS Network ranks the “home” institutions' accounts and products base on, in this example, the MRTS accountholder's pre-specified REI transfer criteria (it could, in other iterations, be based on the MRTS Network's REI transfer criteria). The MRTS accountholder then selects account(s) and/or product(s) to which to transfer the accountholder's R (β, $) and then clicks the “TRANSFER” icon to effect internal R (β, $) transfer(s). At Block D, the accountholder then receives confirmation of the transferred R (β, $), internal institutions' account(s)/product(s) to which the R (β, $) has been transferred along with rates/yields, time periods (if any), etc. At Block E (FIG. 25B), the MRTS Network then displays the MRTS accountholder's new account(s) status including existing “home” institutions' accounts/products (R (α . . . ι, $), “home” institutions' accounts/products from which accountholder's R (β, $) has been transferred (R (α . . . ι, $)−R (β, $)), and “home” institutions' accounts/products to which accountholder's R (β, $) has been transferred.

### Rate Collection and Display Processes Supported On The MRTS Network of the Present Invention

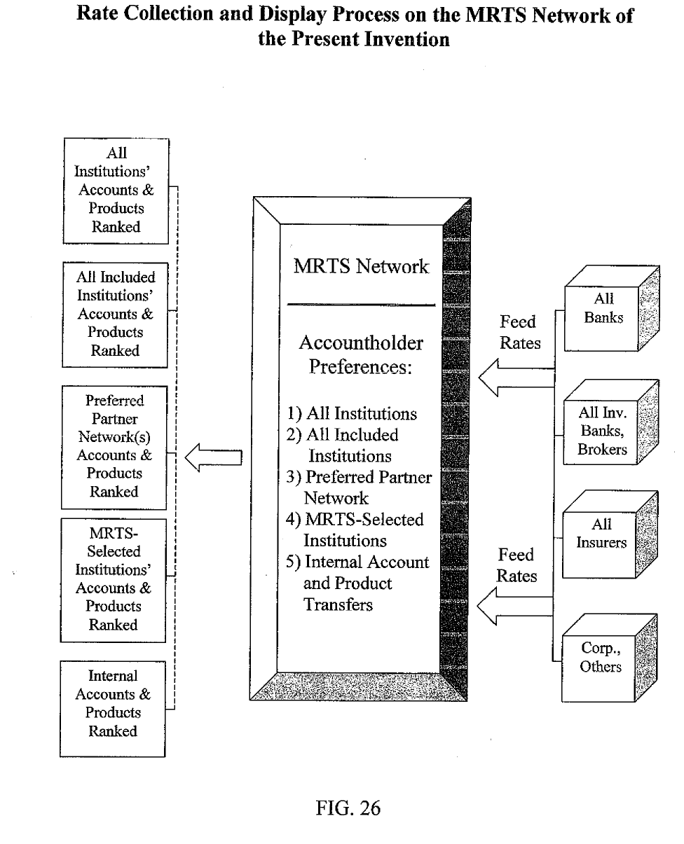

Referring to FIGS. 6, 7, 26 and 27, the Rate Collection and Display Processes supported on the MRTS Network will now be described in greater detail.

In general, the function of the Rate Collection and Display Process is to facilitate data collection on/by the MRTS Network to enable participating financial (or non-financial) institutions to provide information to the relational database management systems (RDBMS) of the MRTS Network, and wherein these RDBMS then sort and rank the data inputs and display the ranked data in different means according to the user/accountholder's preference(s) so that the system user/accountholder can then effect a transfer of the right to earn interest (R (β, $)) on monies owned, using the various transfer methods supported on the MRTS Network. Similarly, the MRTS Network utilizes the information supplied and updated by participating institutions in order to rank various criteria and then to effect automatic REI transfers based on the MRTS Network's own REI transfer criteria.

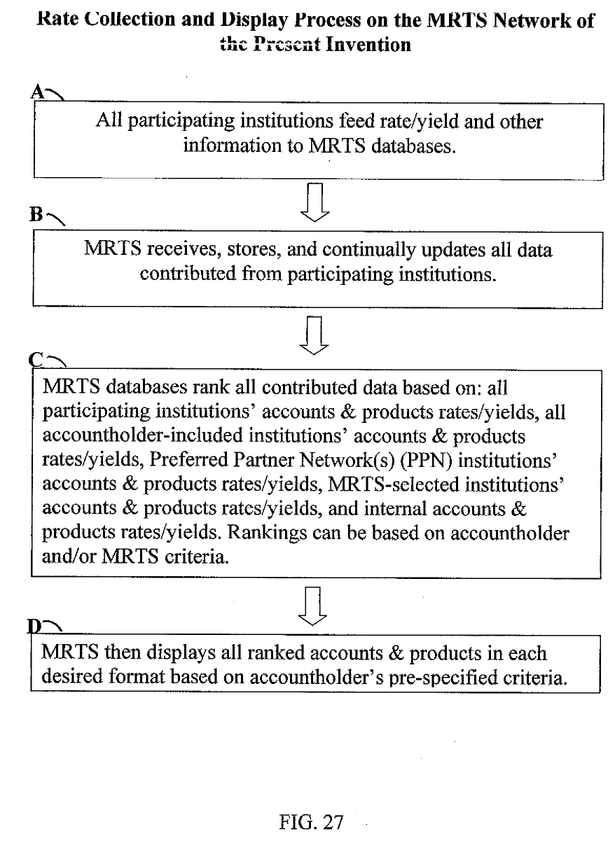

FIG. 27 is a flow chart that describes the steps involved in the MRTS Rate Collection and Display Process beginning with the financial institutions' rate feeds to the RDBMS's of the MRTS Network, and culminating in the transfer of the right to earn interest (R (β, $)) by the system user/accountholder using one of the preferred transfer method(s).

Now, referring to FIG. 27, at Block A, all participating institutions feed rate/yield and other account/product data/information to the MRTS databases. At Block B, the MRTS Network receives, stores in databases, and continually updates all data contributed by participating institutions. At Block C, the MRTS Network databases rank all contributed data based on, but not limited to: all participating institutions' accounts and products rates/yields, all accountholder-included institutions' accounts and products rates/yields, Preferred Partner Networks (PPN) institutions' accounts and products rates/yields, MRTS-selected institutions' accounts and products rates/yields, and internal accounts and products rates/yields. Rankings can be based on accountholder-specified and/or on MRTS Network-specified criteria and may be based on factors other than highest rates/yields. AT Block D, the MRTS Network then displays all ranked accounts and products in each desired format based on the accountholder's, or on the MRTS Network's, pre-specified REI transfer criteria.

### REI Transfer Process Coincident With Purchases, Payments, and Withdrawals (Commerce Facilitation) on The MRTS Network of the Present Invention

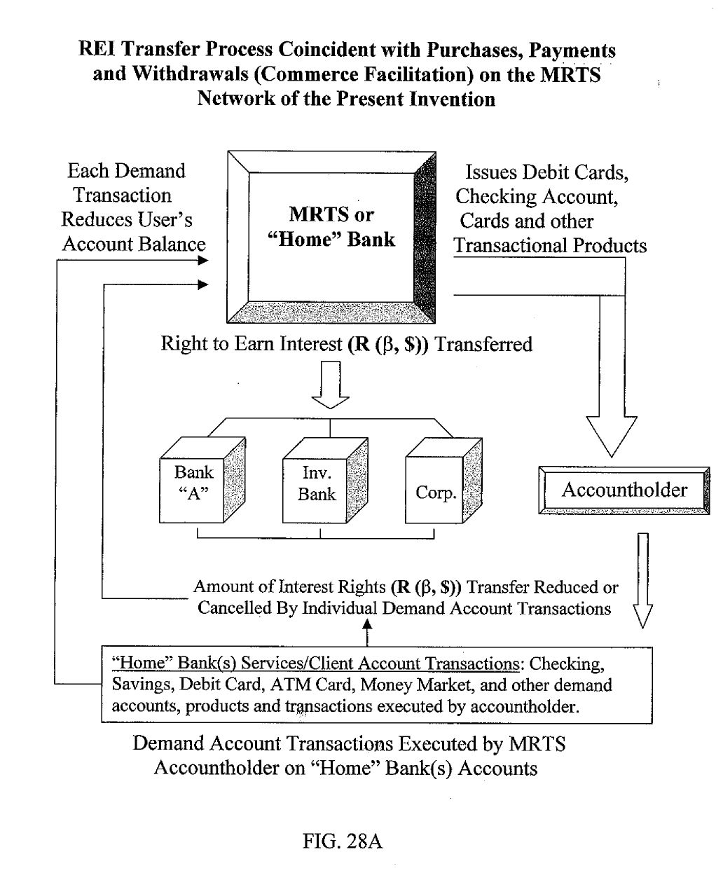

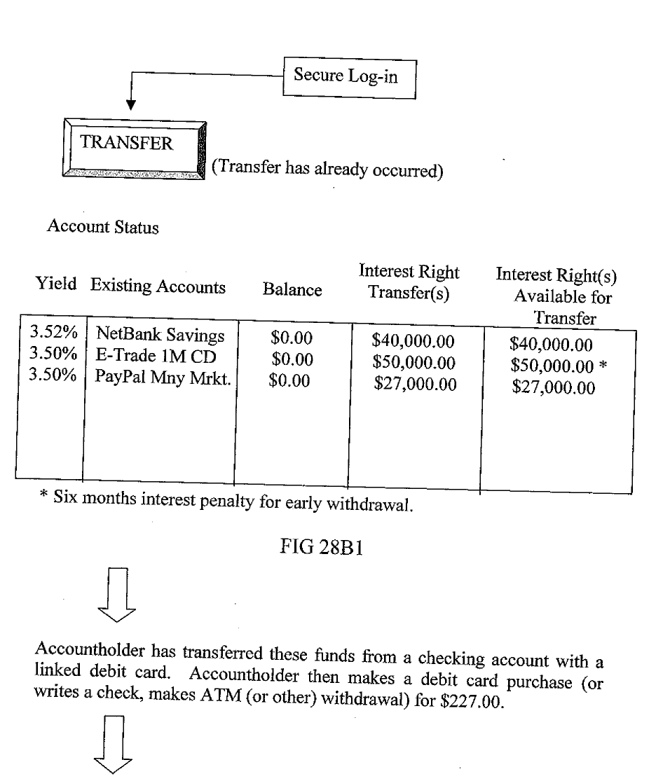

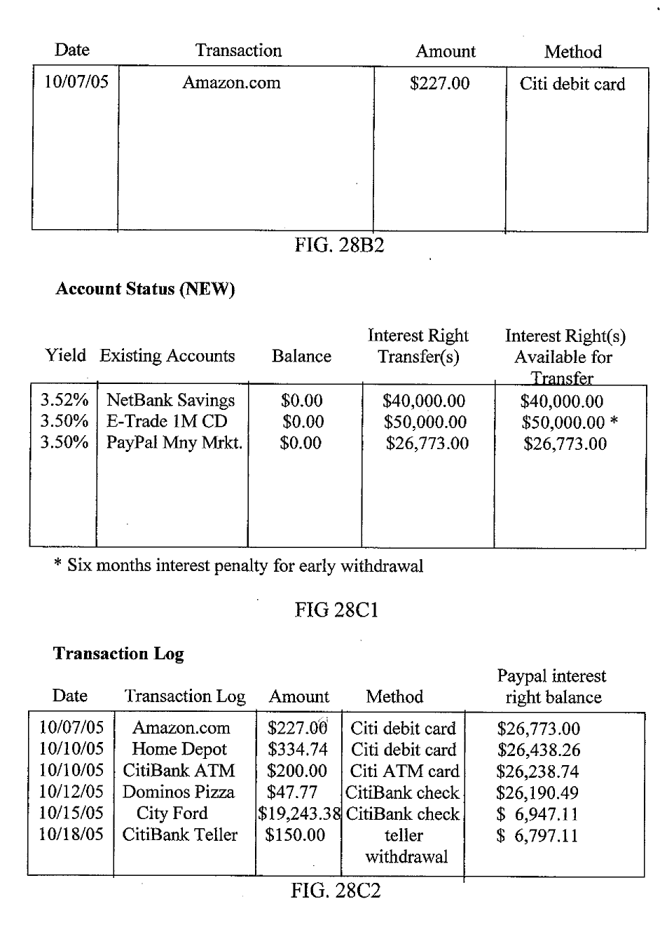

Referring to FIGS. 28A, 28B, 28C, 43 and 44, the REI Transfer Process Coincident with Purchases, Payments and Withdrawals (Commerce Facilitation) on the MRTS Network of the Present Invention, supported on the MRTS Network, will now be described in greater detail.

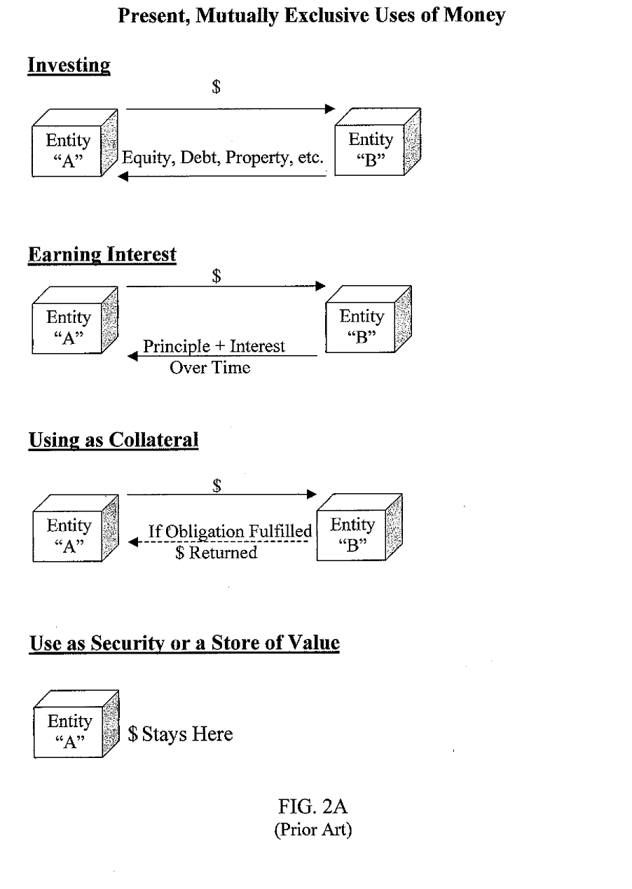

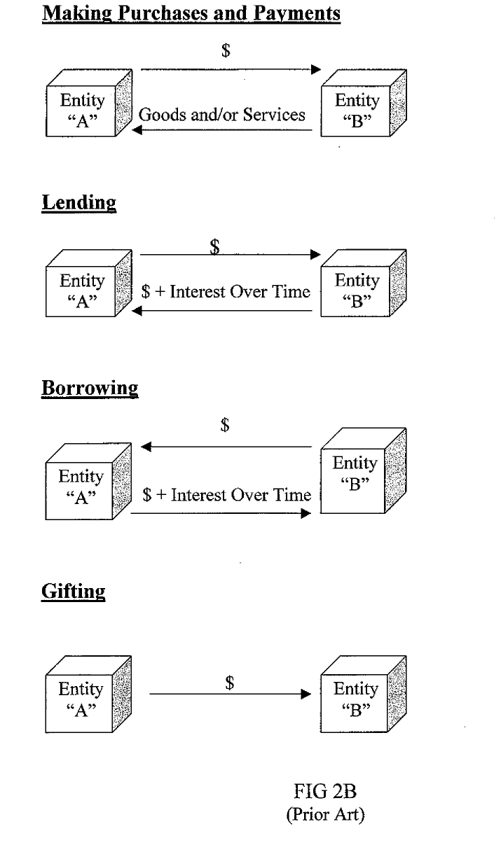

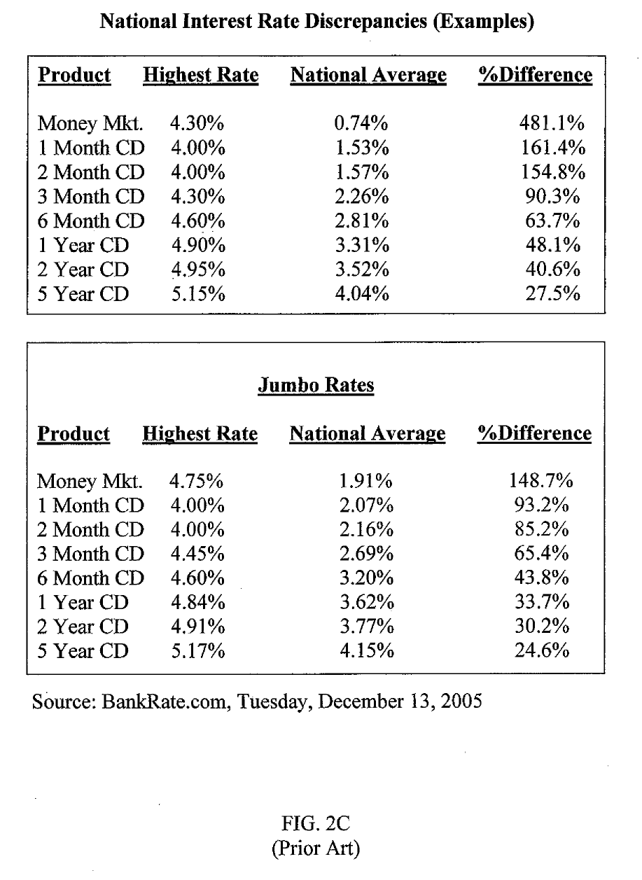

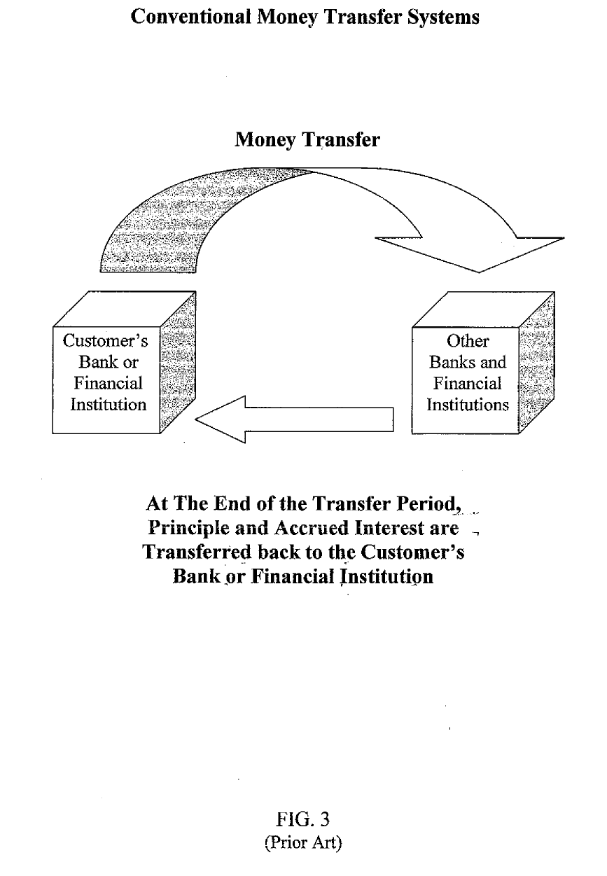

FIGS. 28A through 28C-2, taken together, set forth a schematic representation of the process supported by the MRTS Network of the present invention, for transferring of the monetary right to earn interest (R (β, $)) coincident with user/accountholder's exercise of the right to make purchases (R (ε, $)) utilizing the right to make payments (R (φ, $) and the right to make withdrawals (hold money as a store of value) (R (δ, $)) wherein a system user/accountholder transfers R (β, $) in order to earn higher interest rates/yields but, as the system user utilizes the other, non-mutually exclusive rights associated with holding money through demand account transactions (R (ε, $)), (R (φ, $)), and (R (δ, $)), the amount of R (β, $) is reduced or cancelled commensurately, thereby allowing a system user to maximize the utility of money held.

FIG. 28A-C is one of the processes by which the system and methods of the invention allow an MRTS accountholder to maximize the utility of money owned by separating, and simultaneously utilizing, the individual, non-mutually exclusive, monetary rights (R (α . . . ι, $)) as defined in “Recognition of the Set of Rights Possessed by an Owner of Money in Accordance with the Principles of the Present Invention” (FIGS. 4A-B). In this process, the MRTS accountholder's “home” bank(s) (or the MRTS Network itself) issues demand accounts and products to the MRTS accountholder in the form of checking accounts, savings accounts, debit/credit cards, ATM cards and any and all other transactional products.

In FIG. 28A, the MRTS accountholder transfers the right to earn interest (R (β, $)) to any of the participating institutions in order to earn additional interest. During the course of normal, everyday commerce the MRTS accountholder utilizes one of the transactional products to make purchases, pay bills, withdraw funds, etc. from accounts/products maintained at the accountholder's “home” bank(s) or within the MRTS system. Coincident with the MRTS accountholder's use of a transactional product, the accountholder's transferred R (β, $) is reduced commensurately with the amount of the purchase(s) and/or payment(s).

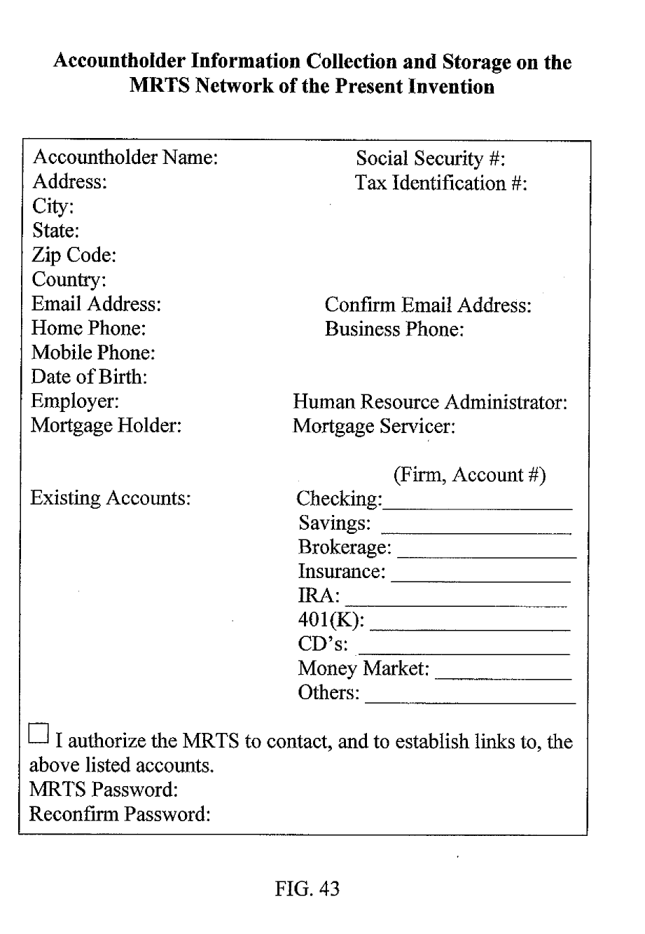

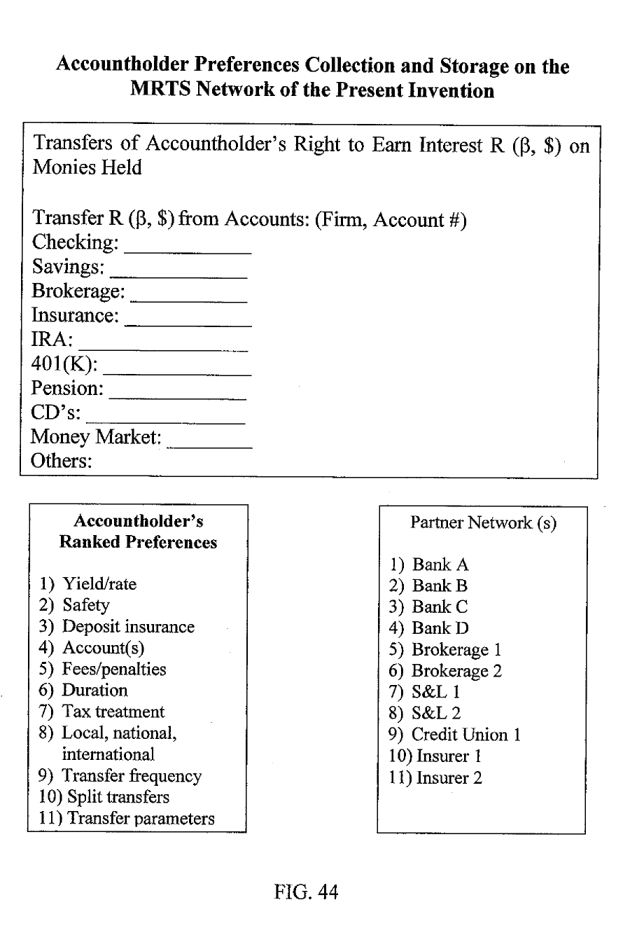

Now, referring to FIG. 28B1, the MRTS Network provides an MRTS accountholder with a screen showing all of the accountholder's R (β, $) transfers; such screen including the institutions and accounts/products to which the accountholder's R (β, $) has been transferred, the various account(s) balances, rate/yields, etc. Upon execution of a demand transaction (FIG. 28B2), an electronic signal is sent to the MRTS Network of the present invention, as the accountholder has previously provided sufficient “home” institution(s) account/product information (see FIGS. 43 and 44) to cause a “linking” of the demand account(s) to the accountholder's account(s) within the MRTS. Upon receiving the signal that a demand transaction has been effected, the MRTS Network automatically reduces or cancels the accountholder's transferred R (β, $) commensurate with the amount of the demand transaction (FIG. 28B2). If the accountholder has multiple R (β, $) transfers, the MRTS will reduce or cancel the transferred R (β, $) in an account(s) based on the user's pre-specified transfer criteria. This process can be repeated multiple times in any time period.

All R (β, $) (or other right(s)) transfers, or transfer reductions or cancellations, will be reflected in the accountholder's “Accounts Status (NEW)” (FIG. 28C1), and includes a transactional log(FIG. 28C2) of all of the accountholder's MRTS transactional activities.

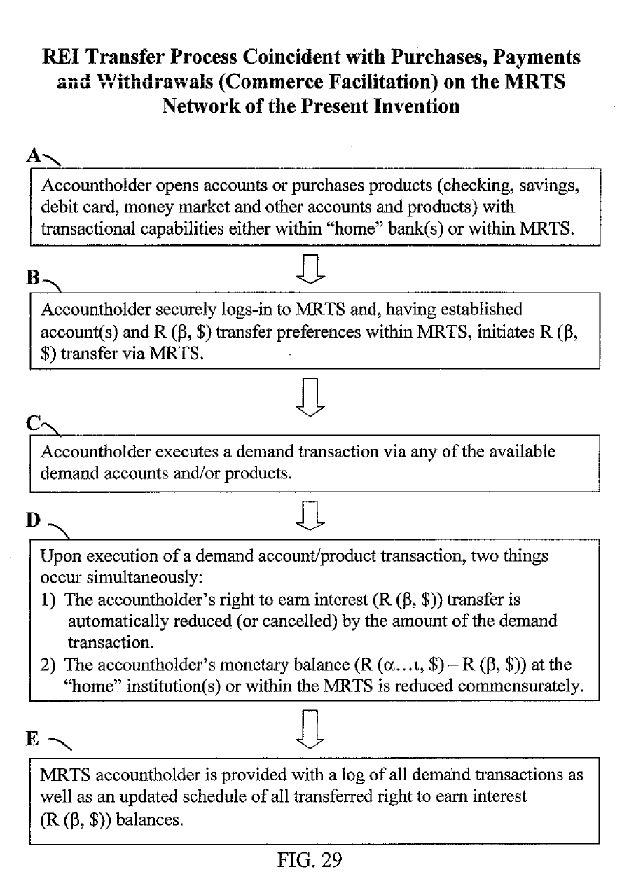

FIG. 29 is a flow chart depicting the various steps carried out by the Commerce Facilitation Process shown in FIGS. 28A through 28C-2, allowing a system user/accountholder to both transfer the right to earn interest R (β, $) and, at the same time, conduct commerce by utilizing other, separable rights associated with money ownership.

Now referring to FIG. 29, at Block A, an MRTS Network accountholder opens accounts and/or purchases products (checking, savings, debit card, money market, stored value cards, gift cards, and other accounts and/or products with transactional capabilities, either within the “home” institution(s) or within the MRTS Network. At Block B, the MRTS accountholder securely logs-in to the MRTS Network and, having established account(s) and R (β, $) transfer preferences within the MRTS Network, initiates R (β, $) transfer(s) via the MRTS Network. At Block C, the MRTS accountholder executes a demand transaction via any of the available demand accounts and/or transactional products. At Block D, upon execution of a demand account/transactional product transaction, two things occur simultaneously: the MRTS accountholder's R (β, $) transfer is automatically reduced (or cancelled) commensurate with the amount of the demand transaction and, the MRTS accountholder's monetary balance (R (α . . . ι, $)−R (β, $)) in the demand account (or in the transactional product) at the “home” institution(s), or within the MRTS Network, is reduced commensurately by the amount of the demand transaction. The recipient of the demand transaction payment thus receives the entire set of monetary rights (R (α . . . ι, $)) associated with money ownership. At Block E, the MRTS Network accountholder is provided with a log of all demand transactions as well as an updated schedule of all transferred right to earn interest (R (β, $)) balances.

### Tax Recognition and Reporting Processes Supported on the MRTS Network of the Present Invention

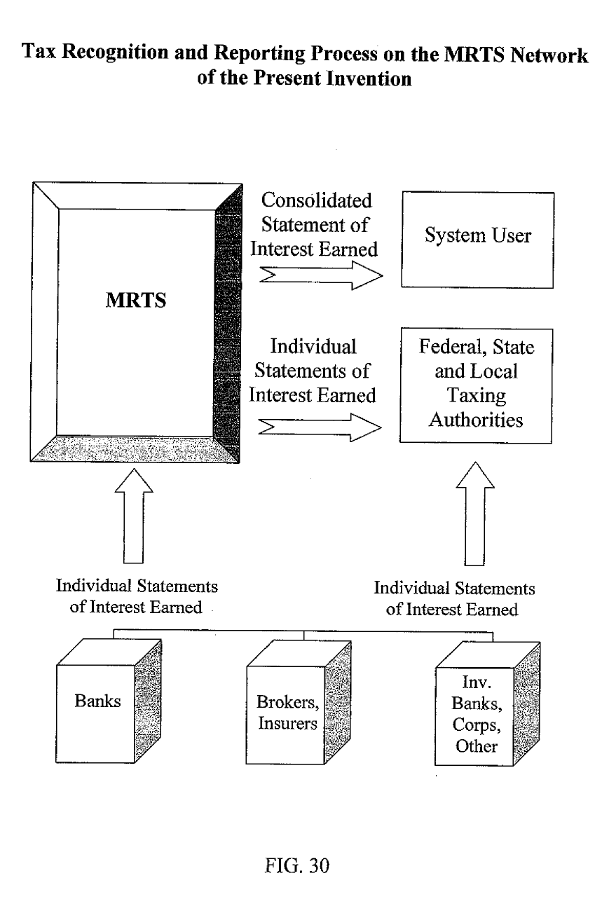

Referring to FIGS. 6,7 30 and 31, the Tax Recognition and Reporting Processes supported on the MRTS Network will now be described in greater detail. FIG. 30 is a schematic representation of the Tax Recognition and Reporting Process supported by the MRTS Network of the present invention, whereby the MRTS Network coordinates the collection and distribution of information pertaining to taxable interest earned by users of the MRTS Network.

FIG. 30 represents the “Tax Recognition and Reporting Process within the MRTS” in the form of a flow chart. After having earned interest on transferred R (β, $), the individual participating institution(s), to which the MRTS accountholder's R (β, $) has been transferred, provide individual statements of taxable interest earned by the MRTS accountholder both to the relevant taxing authorities and to the MRTS Network which then provides an MRTS Network accountholder a consolidated statements of interest earned at various institution. As a confirmation of the taxable interest earned on transferred R (β, $) at each institution to which the MRTS accountholder transferred R (β, $), the MRTS also provides, on a periodic basis, the relevant taxing authorities with individual statements of taxable interest earned by the MRTS accountholder. The MRTS then provides the MRTS accountholder with a consolidated statement of taxable interest earned for income reporting purposes. The MRTS accountholder can also check, at any time, transactional logs maintained by the MRTS to ascertain taxable interest earned at any time.

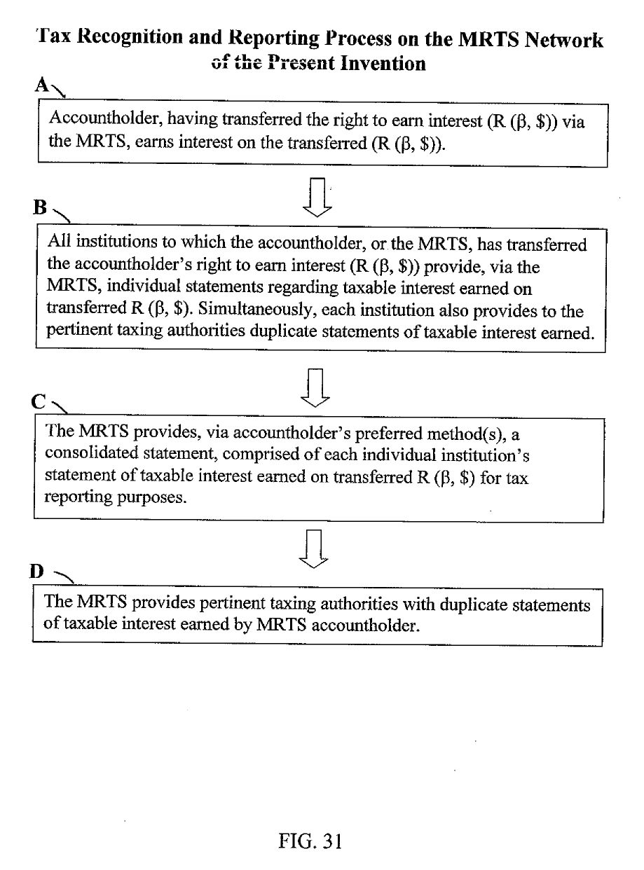

Now referring to FIG. 31, FIG. 31 is a flow chart depicting the various steps involved in the Tax Recognition and Reporting Process illustrated in FIG. 30. At Block A, the MRTS accountholder, having transferred the right to earn interest (R (β, $)) via the MRTS Network, earns interest on the transferred R (β, $). At Block B, all institutions, to which the MRTS Network accountholder (or the MRTS Network) has transferred the accountholder's R (β, $), provide, via the MRTS Network, individual statements regarding taxable interest earned on the accountholder's transferred R (β, $). Simultaneously, each institution also provides, to the pertinent taxing authorities, duplicate statements of taxable interest earned. At Block C, the MRTS Network provides, via the MRTS accountholder's preferred method(s), a consolidated tax statement comprised of each institution's statement of taxable interest earned on transferred R (β, $) for tax reporting purposes. At Block D, the MRTS Network provides all pertinent taxing authorities with duplicate statements of taxable interest earned by an MRTS Network accountholder.

### Mortgage Interest Right Process Supported on the MRTS Network of the Present Invention

Referring to FIGS. 6, 7, 9, 32A, 32B, 32C, 33A, and 33B, the Mortgage REI Transfer Process supported on the MRTS Network will now be described in greater detail.

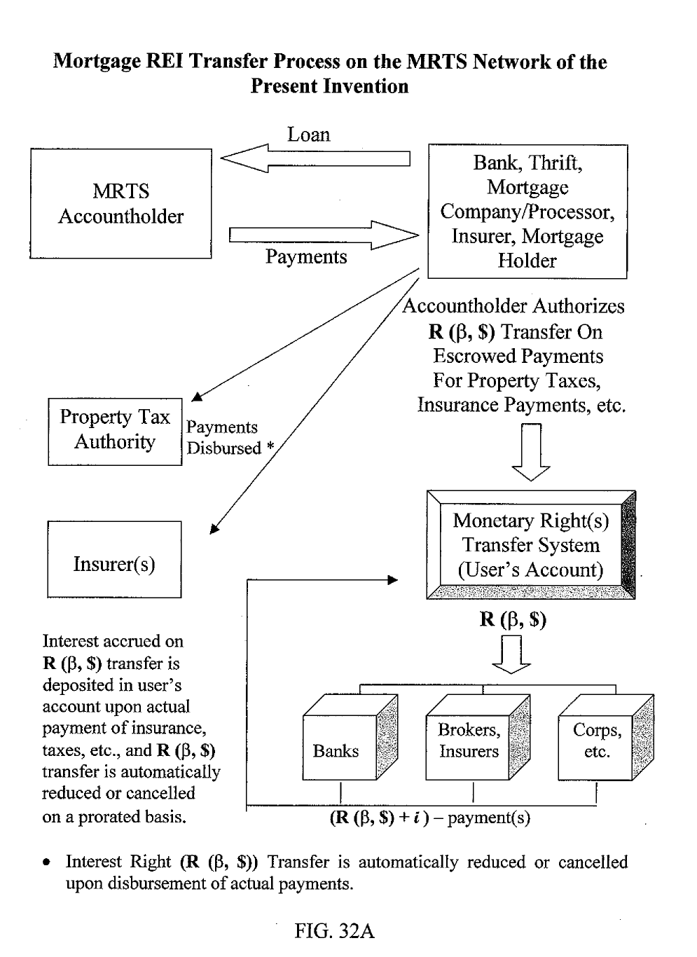

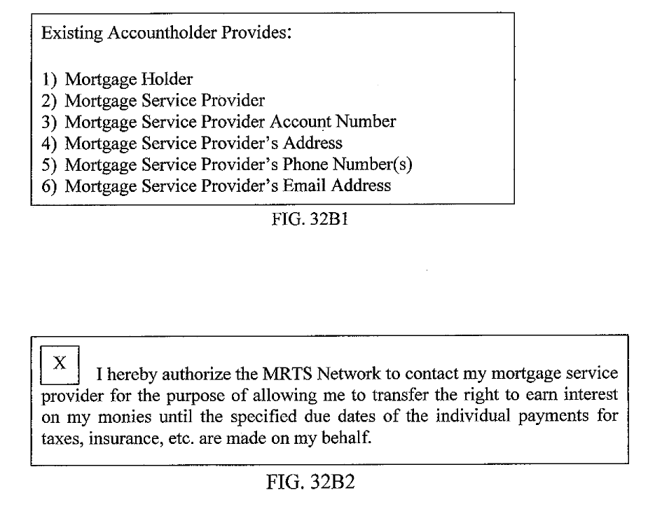

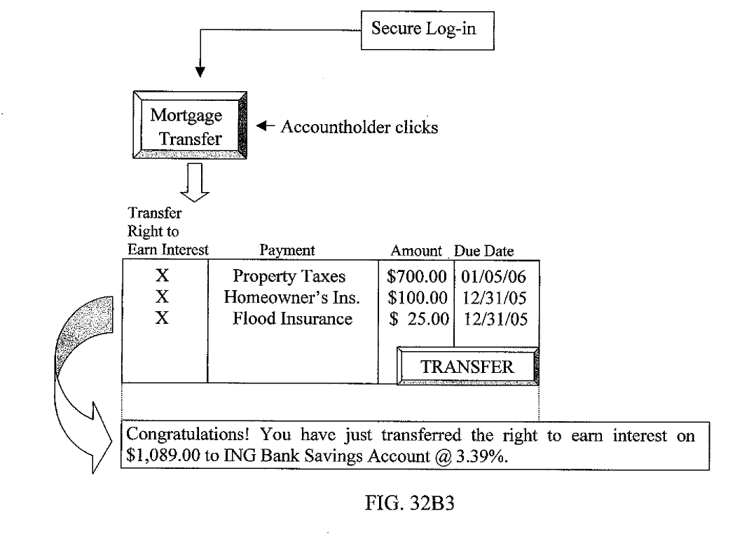

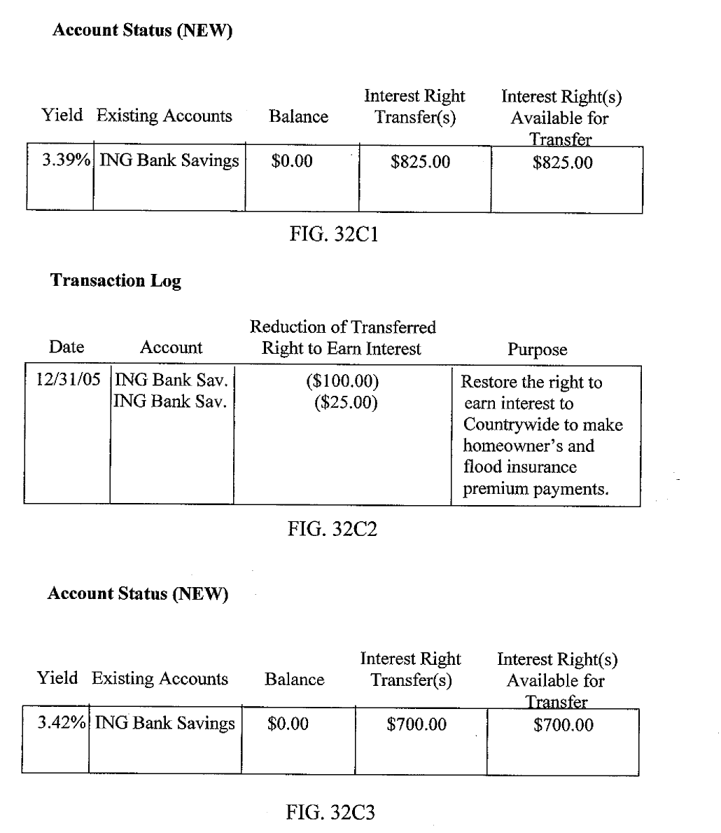

FIGS. 32A through 32C3, set forth a schematic representation of the Mortgage Interest Right Process supported on the MRTS Network of the present invention, enabling an MRTS Network user/accountholder to transfer the right to earn interest (R (β, $)) on monies paid to, and escrowed by, a mortgage issuer or mortgage service provider to cover the user/accountholder's future obligations with regard to property taxes, insurance and other mortgage related expenses, and thereby allowing a system user/accountholder to earn additional interest on those monies prior to the individual payment(s) due date(s).

Now, referring to FIG. 32B1, an MRTS Network accountholder first provides to the MRTS Network all relevant information relating to the accountholder's mortgage holder and/or mortgage service provider including: name of mortgage holder/mortgage service provider, mortgage account number(s), mortgage service provider's contact information, etc. Additionally, via the approval process provided in FIG. 32B2, the MRTS accountholder authorizes the MRTS Network to contact the accountholder's mortgage service provider for the purpose of allowing the MRTS accountholder to transfer the REI on monies held by the mortgage service provider until the specified due dates of each individual payment collected by the mortgage service provider.

After securely logging-in to the MRTS Network, an accountholder clicks the “Mortgage Transfer” icon and is then shown a new screen (FIG. 32B3) where the accountholder can pick the individual components of a mortgage payment on which to transfer the accountholder's R (β, $) until such time as each individual payment is due (“payment due date”). After effecting an R (β, $) transfer via any of available methods and their iterations, FIG. 32C1 presents the accountholder with a new screen showing the accountholder's “Account Status (NEW)” detailing the new account(s), the rate/yield earned, the amount of the interest right transfer, etc.

As individual payments become due, the accountholder is shown a new screen, “Transaction Log” (FIG. 32C2), that details the amount of any reduction of the transferred REI in order to restore the right to earn interest (R (β, $)) on the “payment due date” to the original payment made to the mortgage service provider of R (α . . . ι, $)−R (β, $). Reducing or canceling the withheld R (β, $) has the same effect of restoring it to the original payment of R (α . . . ι, $)−R (β, $), thus providing the mortgage service provider with the entire set of monetary rights (R (α . . . ι, $)).

The MRTS accountholder then sees a new screen, “Account Status (NEW)” shown in FIG. 32C3 that shows the MRTS accountholder's new balance(s), REI transfer(s), the rate/yield earned, etc.

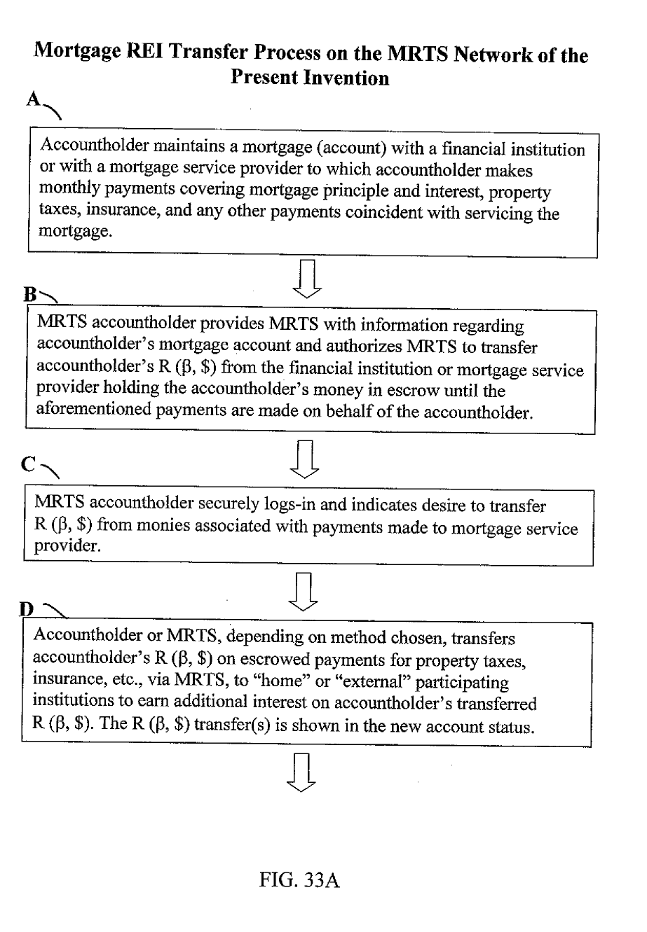

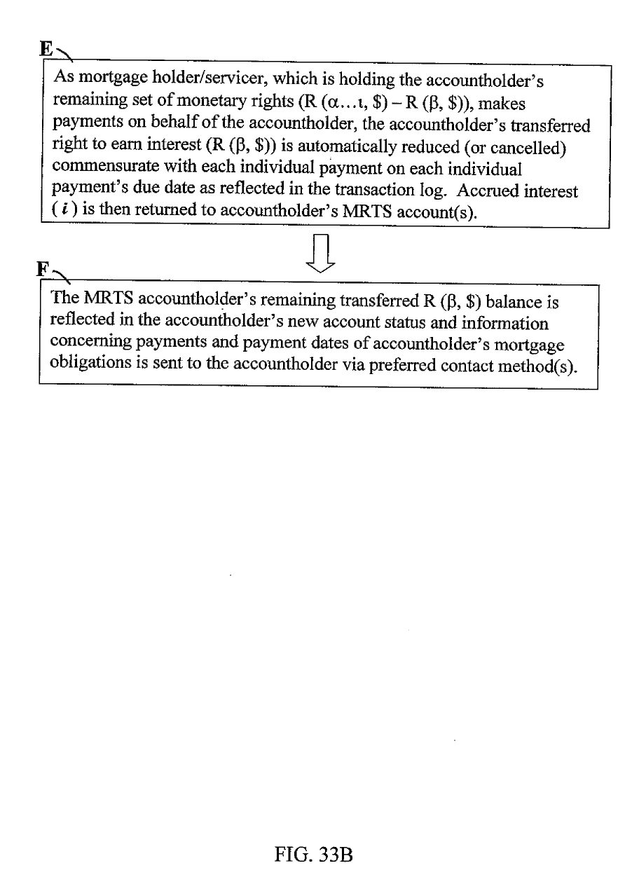

Now referring to FIGS. 33A and 33B, both figures comprise a flow chart that details the Mortgage REI Transfer Process supported on the MRTS Network. At Block A, an MRTS accountholder maintains a mortgage (account) with a financial institution or with a mortgage service provider, to which, the accountholder makes monthly (or other periodic payments) covering mortgage principle and interest, property taxes, property insurance, and any other payments coincident with servicing the accountholder's mortgage. At Block B, the MRTS accountholder provides the MRTS Network with information regarding the accountholder's mortgage account and authorizes the MRTS Network to contact the accountholder's mortgage service provider for the purpose of transferring the accountholder's R (β, $) from the financial institution or mortgage service provider holding the accountholder's money in escrow until the aforementioned payments are made on behalf of the MRTS accountholder. At Block C, the MRTS accountholder securely logs-in to the MRTS Network and indicates a desire to transfer the accountholder's R (β, $) from the monies associated with payments made to the mortgage service provider. At Block D, the MRTS accountholder or, the MRTS Network, depending on the R (β, $) transfer method chosen, transfers the accountholder's R (β, $) on escrowed mortgage payments for property taxes, property insurance, etc., via the MRTS Network to either the accountholder's “home” or “external” participating institutions in order to earn additional interest on the accountholder's transferred R (β, $). The R (β, $)transfer(s) is shown in the accountholder's new account status screen. At Block E, as the mortgage holder/servicer, which is holding the MRTS accountholder's remaining set of monetary rights (R (α . . . ι, $)−R (β, $)), makes payments on behalf of the MRTS accountholder, the accountholder's transferred R (β, $) is automatically reduced (or cancelled) commensurately with each individual payment on each individual “payment due date” as reflected in the “Transaction Log”. Accrued interest (i) is then returned to the MRTS accountholder's MRTS account(s). At Block F, the MRTS accountholder's remaining transferred R (β, $) balance is reflected in the accountholder's new account status and information concerning payments and payment dates of accountholder's mortgage obligations is sent to the accountholder via the accountholder's preferred contact method(s).

### Human Resources Interest Right Process Supported on the MRTS Network of the Present Invention

Referring to FIGS. 6, 7, 9, 34A, 34B, 34C, 35A, and 35B, the Human Resources REI Transfer Process supported on the MRTS Network will now be described in greater detail.

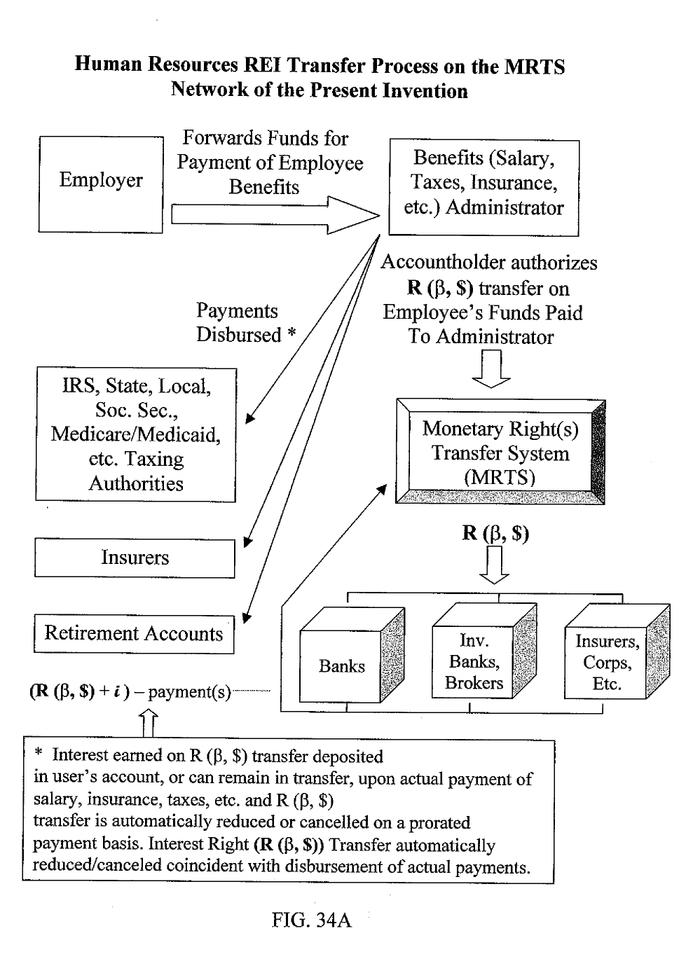

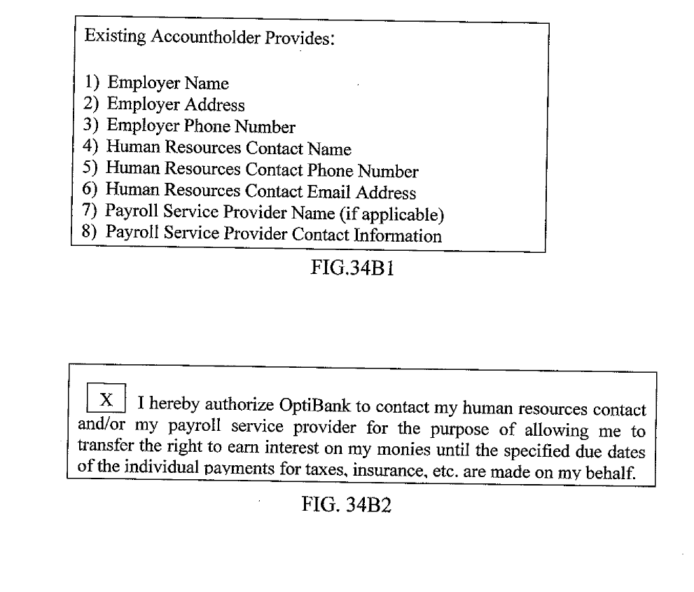

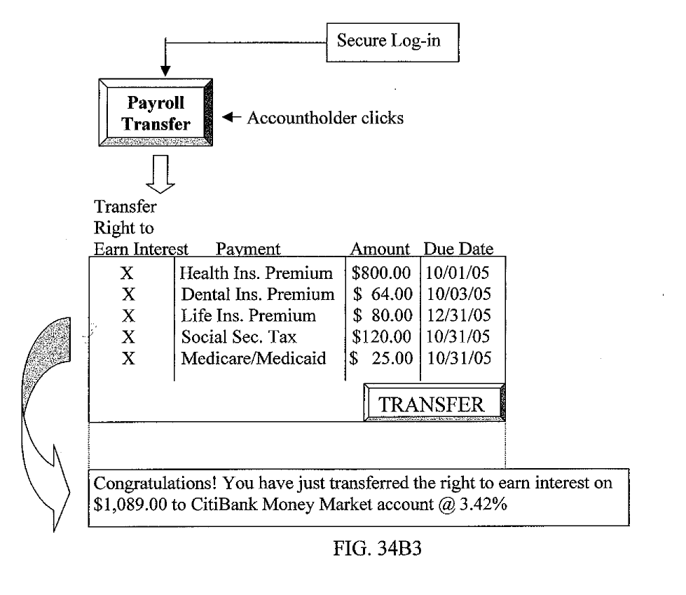

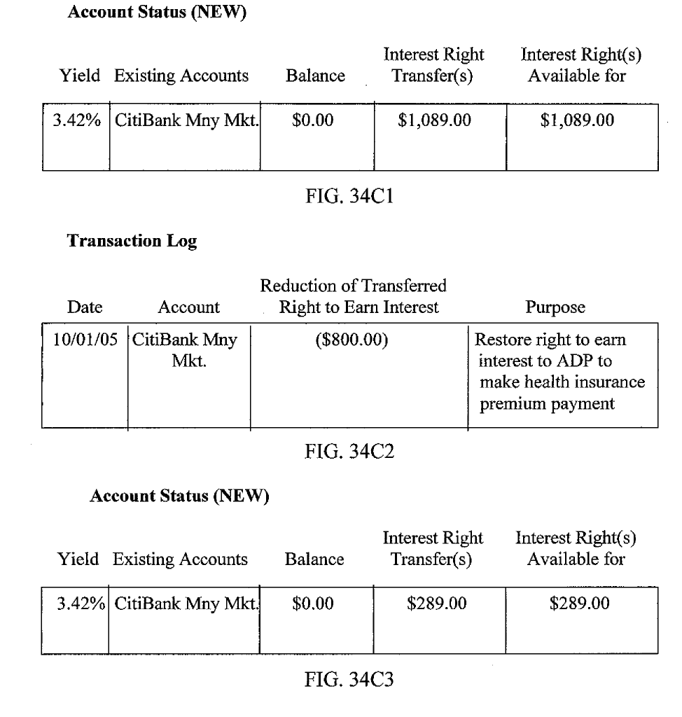

FIGS. 34A through 34C, taken together, set forth a schematic representation of Human Resources Interest Right Process supported on the MRTS Network of the present invention, enabling an MRTS accountholder (employee) to transfer the right to earn interest (R (β, $)) on monies collected from an employee (MRTS Network accountholder) by an employer or payroll services provider to pay the employee's future obligations for such things as taxes, insurance, other employee-related expenses, and other benefits payments that are collected and held in escrow, by an employer of payroll services provider, and thereby allowing the employee to earn additional interest on the monies collected to pay for future employee obligations by an employer or payroll services provider until each individual “payment due date”.

As an employee earns periodic paychecks (or other compensation like bonuses, etc.) from an employer, either the employer or a payroll service provider (collectively the “benefits administrator”) withholds monies from each paycheck for various taxes, insurance premium payments, etc., on behalf of the employee. These monies are held in escrow by the “benefits administrator” until such payments are due, allowing the “benefits administrator” to earn interest on monies legally belonging to the employee until such payments are effected on the employee's behalf.

This process will allow an employee, having previously supplied all relevant employment information (FIG. 34B1) and appropriate authorization to the MRTS (FIG. 34B2), to transfer the R (β, $) on the employee's/accountholder's monies held in escrow by the “benefits administrator”. Once the MRTS accountholder authorizes the transfer of R (β, $) on these monies (FIG. 34B2), the MRTS notifies the “benefits administrator” of the transfer and effects the transfer, based on the accountholder's (or MRTS) pre-specified transfer criteria, by transferring the accountholder's R (β, $) to any participating institution(s) (FIG. 34B3). The accountholder then receives a message confirming the right transfer.

The accountholder then sees, in FIG. 34C1, the “Account Status (NEW)” screen. The accountholder's R (β, $) transfer remains in effect until an individual payment on behalf of the employee/accountholder is due. On the due date of an individual payment, the accountholder's transferred R (β, $) is reduced (or cancelled) commensurately with the payment amount; any accrued interest can remain in transfer or be returned to the accountholder's MRTS account(s). This activity is reflected in the “Transaction Log” (FIG. 34C2). This allows the employee's/accountholder's transferred R (β, $) to be returned to the “benefits administrator” to effect “full” payment on the employee's behalf, yet allows the employee/accountholder to earn interest on all monies up until the due date of each individual payment made for the employee's benefit.

As in previous examples, the MRTS provides the accountholder with an “Accounts Status (NEW)” screen (FIG. 34C3) allowing the accountholder to track items such as account/product balances, right(s) transfers, payments and payment dates, interest earned, etc.

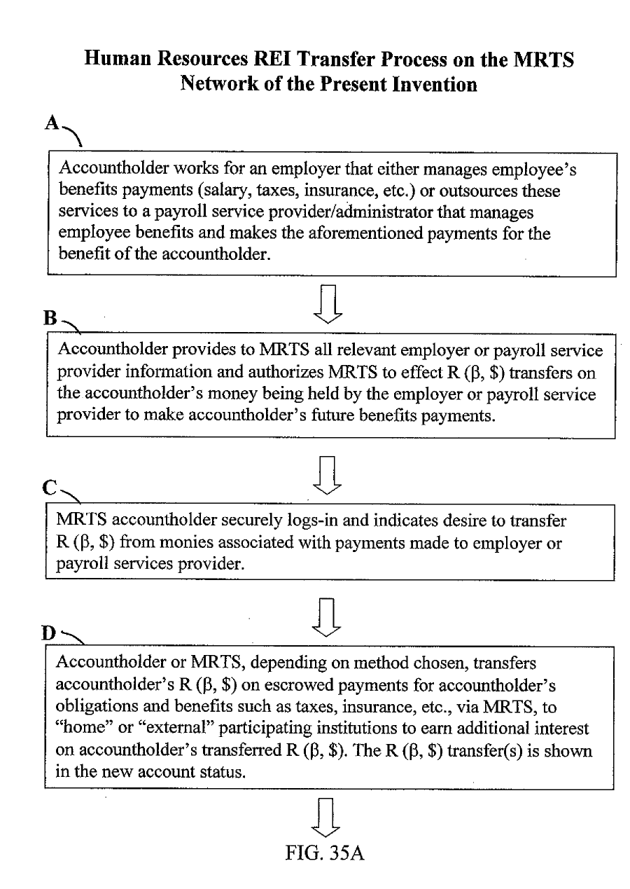

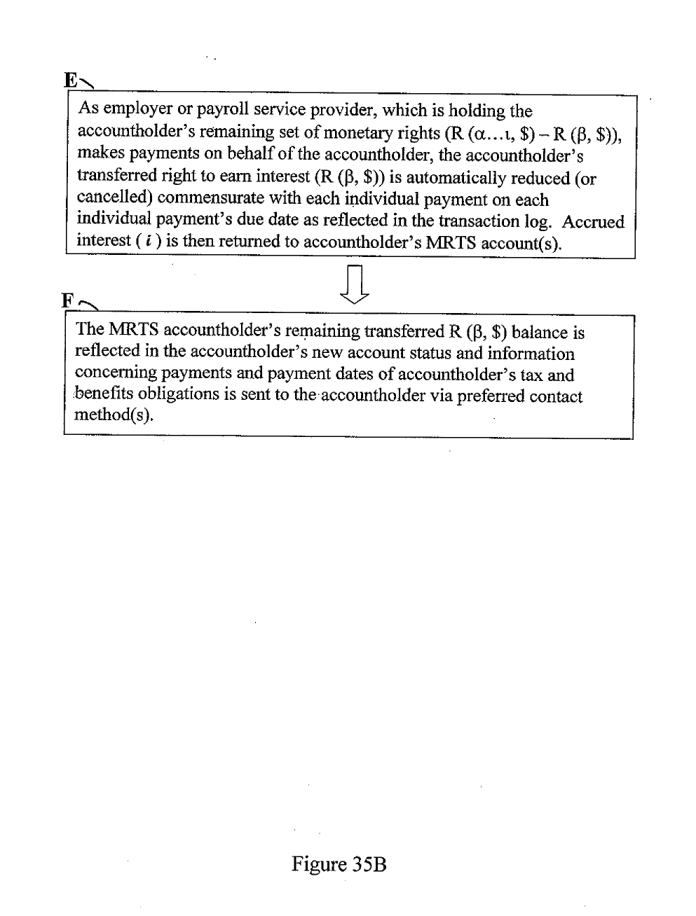

FIGS. 35A through 35B, taken together, set forth a flow chart depicting the Human Resources Interest Right Process represented in FIGS. 34A through 34C, enabling an employee to transfer the right to earn interest (R (β, $)) on monies (still owned by the employee) collected and held by an employer or payroll services provider to pay an employee's future obligations, until each individual “payment due date”.

Now, referring to FIGS. 35A and 35B, at Block A, an MRTS Network accountholder/employee works for an employer that either manages the employee's benefits payments (salary, taxes, insurance, etc.) or outsources these services to a payroll services provider/administrator that manages employee benefits and makes the aforementioned payments for the benefit of the accountholder/employee. At Block B, the MRTS accountholder/employee provides to the MRTS Network all relevant employer or payroll service provider information and authorizes the MRTS Network to effect to effect automatically (or the accountholder can effect manually) R (β, $) transfers on the accountholder's monies held by the employer or the payroll service provider to make the accountholder's/employee's future benefits payments. AT Block C, the MRTS accountholder/employee securely logs-in to the MRTS Network and indicates a desire to transfer R (β, $) from the monies held by the employer or payroll service provider associated with payments for the accountholder's/employee's benefit. At Block D, either the accountholder or the MRTS Network, depending on the transfer method and iteration chosen, transfers the accountholder's/employee's R (β, $) on escrowed payments for the accountholder's obligations and benefits such as taxes, insurance, etc., via the MRTS Network, to “home” or “external” participating institutions to earn additional interest on the accountholder's transferred R (β, $). The R (β, $)transfer(s) is shown in the new account status screen. At Block E, as the employer or payroll service provider, which is holding the accountholder's/employee's remaining set of monetary rights (R (α . . . ι, $)−R (β, $)), makes the payments on behalf of the accountholder, the accountholder's transferred R (β, $) is automatically reduced (or cancelled) commensurately with each individual payment made on each individual payment's due date as reflected in the “Transaction Log”. Accrued interest (i) is then returned to the accountholder's/employee's MRTS account(s). AT Block F, the MRTS Accountholder's remaining transferred R (β, $) balance is reflected in the accountholder's new account status screen and information concerning payments and payment due dates of the accountholder's taxes and benefits obligations is sent to the accountholder via the accountholder's preferred contact method(s).

Method of Payment Involving the Withholding of the Right to Earn Interest (R (β, $)) until Payment Due Date Supported on the MRTS Network of the Present Invention

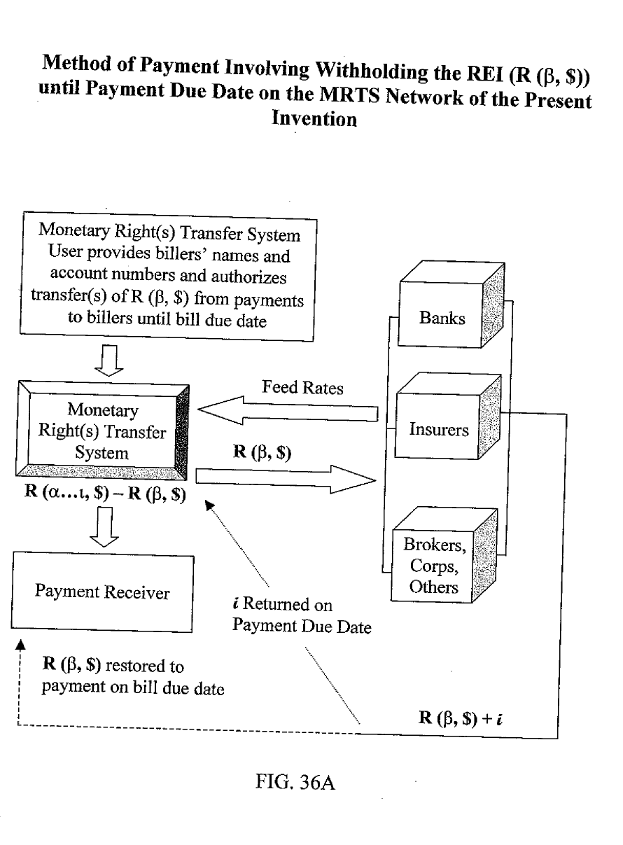

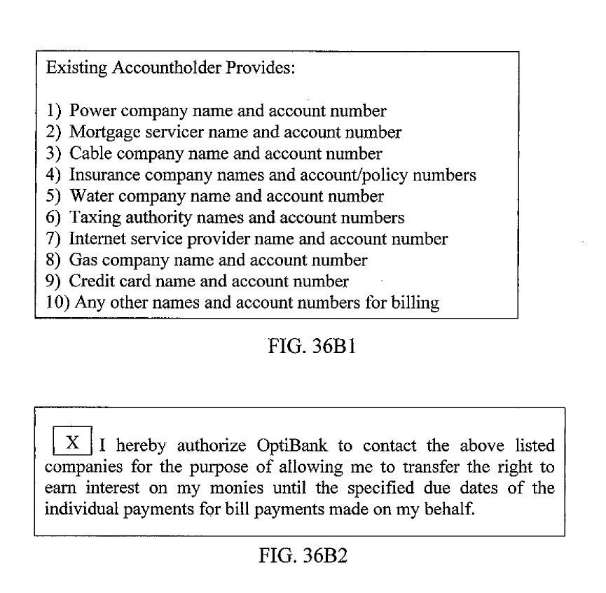

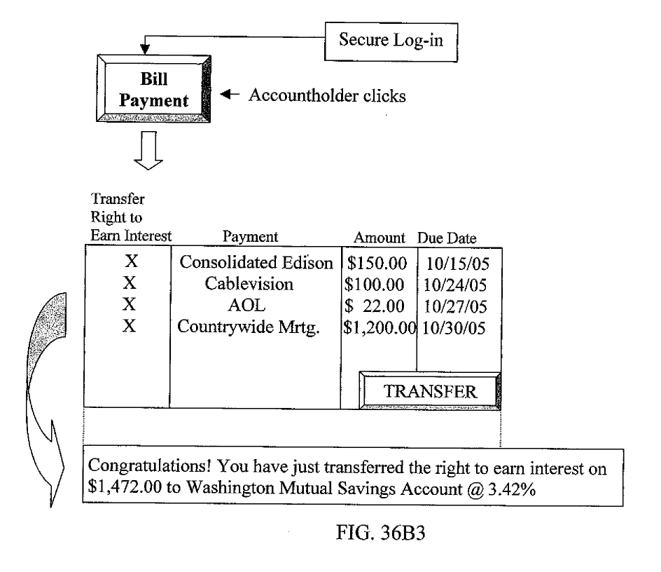

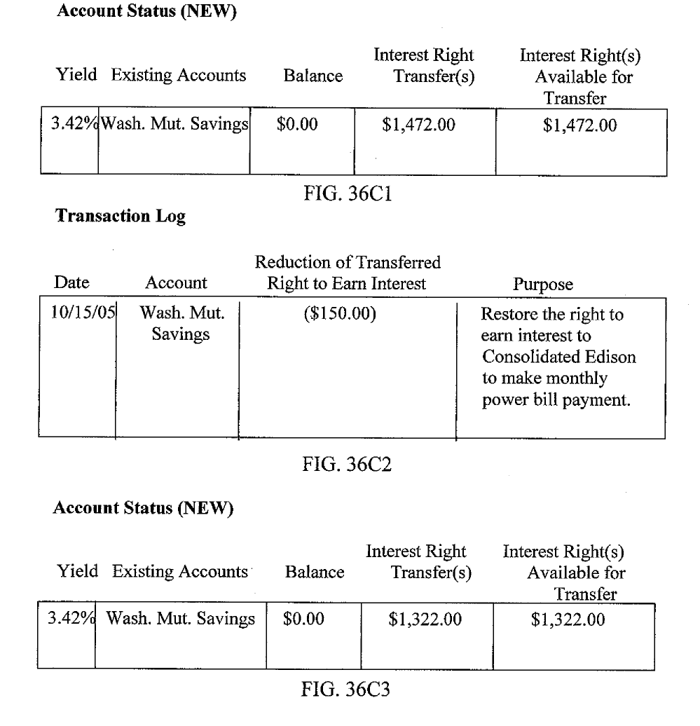

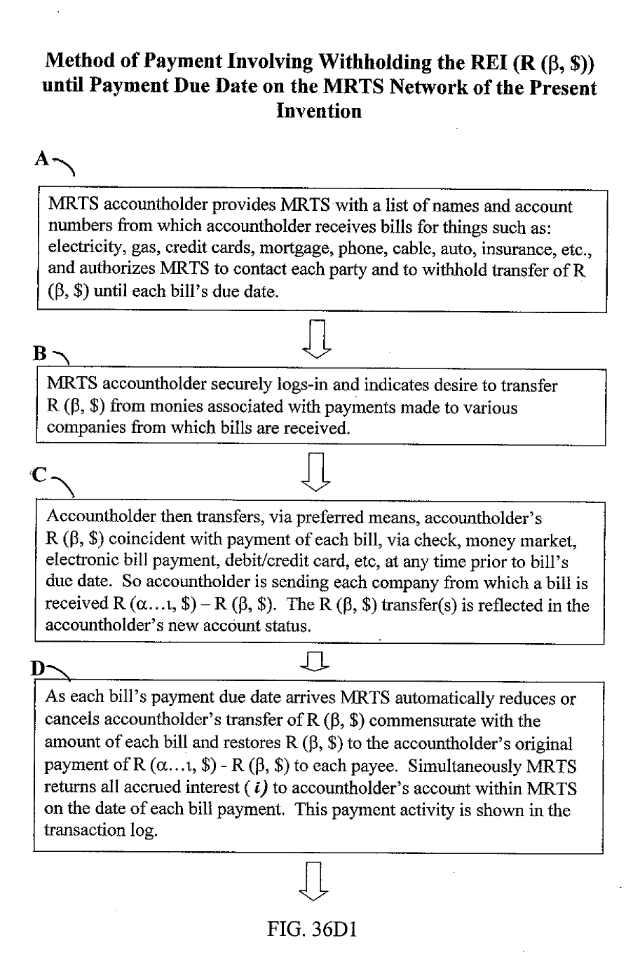

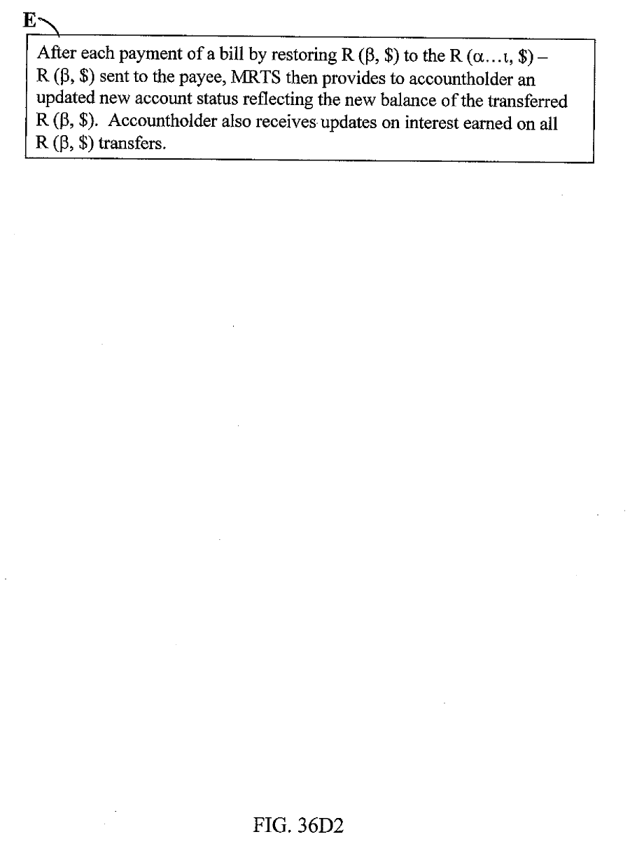

FIGS. 36A through 36C-3 is a schematic representation of the Payment Method Withholding the Right to Earn Interest (R (β, $)) until Payment Due Date supported on the MRTS Network of the present invention, enabling a system user/accountholder to remit payment on a bill received, by any means, at any date prior to the bill's due date such that the payment remitted consists of R (α . . . ι, $)−R (β, $), allowing the MRTS accountholder to transfer R (β, $) and earn additional interest up to a bill's payment due date, at which time the R (β, $) is restored to the user's original payment of (R (α . . . ι, $)−R (β, $)) and, simultaneously, the user's R (β, $) transfer is cancelled commensurately with the amount of the bill payment, with any accrued interest (i) returned to the user's account within the MRTS or to the user's “home” and/or “external” institution(s).

FIG. 36D1 through 36D2, sets forth a flow chart depicting the Payment Method Withholding the Right to Earn Interest R (β, $) until Payment Due Date, enabling a system user/accountholder to withhold R (β, $) from payments and transfer the R (β, $) to earn additional interest until the payment's actual due date.

An MRTS accountholder provides to the MRTS all pertinent information with regard to accountholder's bills received including, but not limited to, company name, account number(s), contact information, payment due date, etc., that will allow the MRTS to establish an electronic link with each individual bill sender (FIG. 36B1). The MRTS accountholder also authorizes the MRTS to transfer accountholder's R (β, $) from payments sent to biller until the each bill's due date, at which time the accountholder's R (β, $) is returned to the original payment of R (α . . . ι, $)−R (β, $), allowing the MRTS accountholder to earn additional interest until each payment's due date (FIG. 36B2).

As in previous embodiments of the system of the invention, participating institutions submit rate feeds to the MRTS via an electronic network (Internet). The incoming institutions' account/product information is then ranked by the system's databases and displayed for the accountholder. The accountholder can then choose from among the various right(s) transfer methods offered by the MRTS and indicate the intent to transfer the R (β, $) from various payments made at any time prior to a bill's due date. While this process can be effected manually by an accountholder, an accountholder also has the option to put this payment method in automatic mode whereby the system will automatically withhold and transfer the accountholder's R (β, $) from each payment made from an account within the MRTS to one of the bill senders as previously specified by an accountholder.

When an accountholder effects bill payment via this process, the MRTS sends the payment as R (α . . . ι, $)−R (β, $), withholding and transferring the accountholder's R (β, $) (FIG. 36B3) per the accountholder's chosen transfer option(s) (FIG. 36C-1). On an individual payment's due date, the MRTS reduces or cancels the accountholder's R (β, $) transfer(s) commensurately with the amount of the bill payment (FIG. 36C2) shown in the “Transaction Log”. R (β, $)+(i) is then split, with accrued interest (i) being returned to the accountholder's MRTS account(s), and R (β, $) returned to the bill payment receiver thus restoring R (β, $) to the accountholder's original payment of R (α . . . ι, $)−R (β, $) and restoring the full set of monetary rights (R (α . . . ι, $)) to the payment receiver on the bill's due date.

As in previous embodiments, the accountholder is provided with a “Accounts Status (NEW)” screen (FIG. 36C3) at the end of this process that apprises the MRTS accountholder of account balances, transfers, bill payments and payment dates, and all information relevant to the transfer and payment process.

This process allows an MRTS accountholder to pay, at any date prior to a bill's due date, in full, yet withhold the right to earn interest R (β, $) from that payment in order to maximize interest earned until the bill's actual due date, allowing the MRTS accountholder, not the payment recipient, to earn interest on the accountholder's monies until the last possible date prior a bill's payment due date.

An MRTS accountholder pre-designates specific accounts, either within or via the MRTS or within the accountholder's “home” bank(s)/institution(s) from which to effect payments withholding accountholder's R (β, $) until payment due date. Via this process, the accountholder can pre-specify from which account(s) to effect such payments and also pre-specify whether to effect these payments automatically or, whether accountholder will effect them manually. If the accountholder chooses to effect them electronically, then the MRTS or “home” bank(s)/institution(s) will restore the accountholder's R (β, $) to the original payment of R (α . . . ι, $)−R (β, $) on the payment due date while simultaneously returning any accrued interest (i) to the accountholder's account(s) within the MRTS or the accountholder's “home” bank(s)/institution(s). However, should the accountholder choose to effect these payments manually, the MRTS (or accountholder's “home” bank(s)/institution(s)) will automatically withhold the equivalent R (β, $) from the manual payment, as the accountholder has already provided biller's account numbers, contact information, and authorizations to the MRTS, until the payment's due date at which time the accountholder's R (β, $) will be restored to the original payment of R (α . . . ι, $)−R (β, $). Again, any accrued interest (i) will be returned to the accountholder's MRTS or “home” account(s).

Now, referring to FIGS. 36D1 and 36D2, at Block A, an MRTS accountholder provides the MRTS Network with a list of names and account numbers from which the accountholder receives bills for such things as: electricity, natural gas, credit cards, mortgage payments, phone service, auto insurance, health insurance, etc., and authorizes the MRTS Network to contact each identified party and to withhold transfer of the accountholder's R (β, $) until each payment's due date. At Block B, the MRTS accountholder securely logs-in to the MRTS Network and indicates a desire to transfer the accountholder's R (β, $) from monies associated with payments made to the various companies from which the accountholder receives bills. At Block C, the accountholder then transfers, via preferred means, the accountholder's R (β, $) coincident with the payment of each bill, via check, money market account, electronic bill payment, debit/credit card, etc. at any time prior to a bill's due date. Thus, the accountholder is remitting to each company from which a bill is received R (α . . . ι, $)−R (β, $). The R (β, $) transfer is reflected in the accountholder's new account status screen. At Block D, as each bill's payment due date arrives, the MRTS Network automatically reduces (or cancels) the accountholder's transfer(s) of R (β, $) commensurately with the amount of each bill and restores R (β, $) to the accountholder's original payment of received R (α . . . ι, $)−R (β, $) to each payee. Simultaneously, the MRTS Network returns all accrued interest (i) to the accountholder's account(s) within the MRTS Network on the date of each bill payment. This payment activity is shown in the transaction log. At Block E, after each payment of a bill by restoring the withheld R (β, $) to the original payment of received R (α . . . ι, $)−R (β, $) originally remitted to the payee, the MRTS Network then provides to the accountholder a new account status screen reflecting the new balance(s) of the transferred R (β, $). The accountholder also receives update on interest earned on all R (β, $) transfers.

“Account-Specific” Payment Method Withholding the Right to Earn Interest (R (β, $)) until Payment Due Date Supported on the MRTS Network of the Present Invention

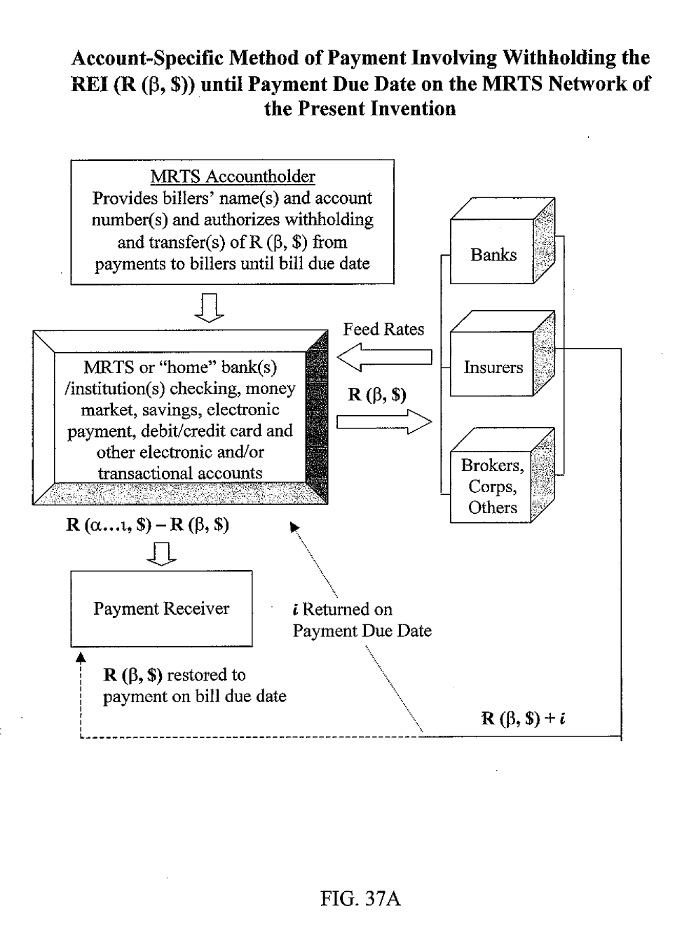

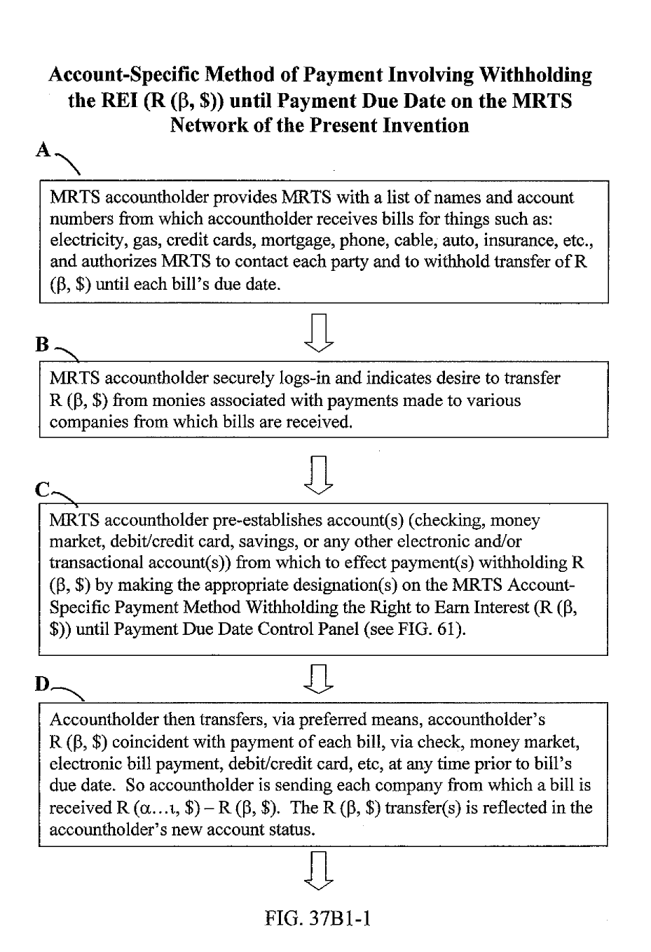

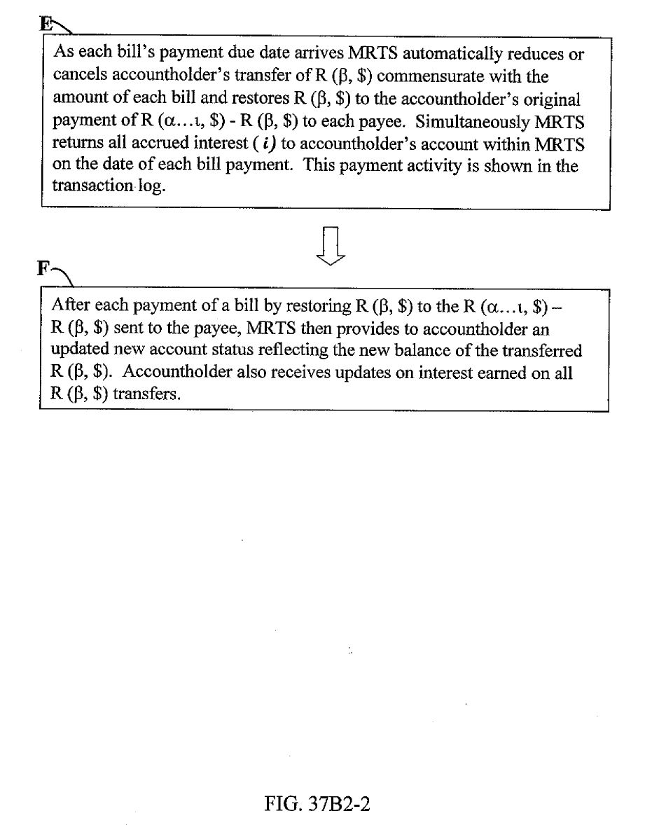

FIG. 37A is a schematic representation of the “Account-Specific” Payment Method Withholding the Right to Earn Interest (R (β, $)) until Payment Due Date supported on the MRTS Network of the present invention, enabling a system user/accountholder to remit payment on a bill received at any date prior to the bill's due date such that the payment remitted consists of R (α . . . ι, $)−R (β, $), and thereby allowing the system user/accountholder to transfer R (β, $) and earn additional interest up to a bill's payment due date at which time R (β, $) is restored to the user's original payment and, simultaneously, the user's R (β, $) transfer is cancelled with any accrued interest (i) returned to the user's account within the MRTS or the user's “home” and/or “external” institution(s).

FIG. 37B1-1 through 37B2-2, taken together, sets forth a flow chart depicting the Account-Specific Payment Method Withholding the Right to Earn Interest R (β, $) until Payment Due Date supported on the MRTS Network of the present invention, enabling a system user/accountholder to withhold R (β, $) from payments and transfer the R (β, $) to earn additional interest until the payment's actual due date.

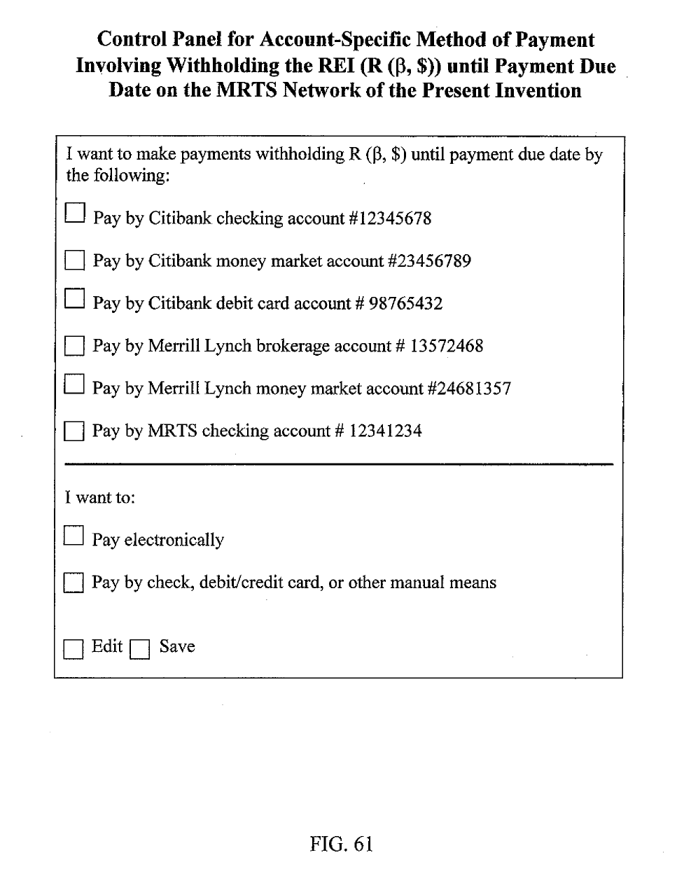

Now, referring to FIGS. 37B1-1 and 37B2-2, at Block A, an MRTS accountholder provides the MRTS Network with a list of names and account numbers from which the accountholder receives bills for such things as: electricity, natural gas, credit cards, mortgage payments, phone service, auto insurance, health insurance, etc., and authorizes the MRTS Network to contact each identified party and to withhold transfer of the accountholder's R (β, $) until each payment's due date. At Block B, the MRTS accountholder securely logs-in to the MRTS Network and indicates a desire to transfer the accountholder's R (β, $) from monies associated with payments made to the various companies from which the accountholder receives bills. At Block C, the accountholder pre-establishes account(s) (checking, money market, debit/credit card, savings or any other electronic and/or transactional account(s) from which to effect payment(s) withholding the accountholder's R (β, $) by making the appropriate designations on the MRTS Network Account-Specific Payment Method Withholding R (β, $) until Payment Due Date Control Panel as shown in FIG. 61. At Block D, the accountholder then transfers, by preferred means, the accountholder's R (β, $) coincident with the payment of each bill, via check, money market account, electronic bill payment, debit/credit card, etc., at any time prior to a bill's due date. The accountholder is remitting, to each company from which a bill is received, R (α . . . ι, $)−R (β, $). The R (β, $) transfer(s) is reflected in the accountholder's new account status screen. At Block E, as each bill's payment due date arrives, the MRTS Network automatically reduces (or cancels) the accountholder's transfer(s) of R (β, $) commensurately with the amount of each bill and restores R (β, $) to the accountholder's original payment of received R (α . . . ι, $)−R (β, $) to each payee. Simultaneously, the MRTS Network returns all accrued interest (i) to the accountholder's account(s) within the MRTS Network on the date of each bill payment. This payment activity is shown in the transaction log. At Block F, after each payment of a bill by restoring the withheld R (β, $) to the original payment of received R (α . . . ι, $)−R (β, $) originally remitted to the payee, the MRTS Network then provides to the accountholder a new account status screen reflecting the new balance(s) of the transferred R (β, $). The accountholder also receives update on interest earned on all R (β, $) transfers.

### Right of First Refusal Right(s) Transfer Process Supported on MRTS Network of the Present Invention

Referring to FIGS. 38A, 38B, 38C, 38D, 39, and 60, the Right-of-First-Refusal REI Transfer Process supported on the MRTS Network will now be described in greater detail.

FIGS. 38A, 38B, 38C, and 38D, is a schematic representation of the Right-of-First Refusal Process supported on the MRTS Network of the present invention, that is available as an accountholder's option to both “home” and “external” banks and financial institutions, whereby the system of the present invention notifies the institution(s) (“home”) holding an accountholder's R (β, $) that the user has requested a transfer of R (β, $), at which point the institution may, at the discretion of the system user, have an opportunity to improve the interest rate/yield offered or, to match or beat the competitor's rate/yield to which a system accountholder has requested the transfer with the amount of time for the institution holding the system user's R (β, $) to improve, match or beat a competitor's offer determined by the system user; if the system user accepts the offer, no transfer is effected.

FIG. 38B is a schematic representation of the MRTS Right of First Refusal Right(s) Transfer Process through which either an MRTS accountholder or the MRTS itself (depending on R (β, $) method(s) chosen by the MRTS accountholder) provides an accountholder's “home” bank(s) or institution(s) with the opportunity to match, beat, or counter R (β, $) transfer offers received by the MRTS accountholder or the MRTS itself.

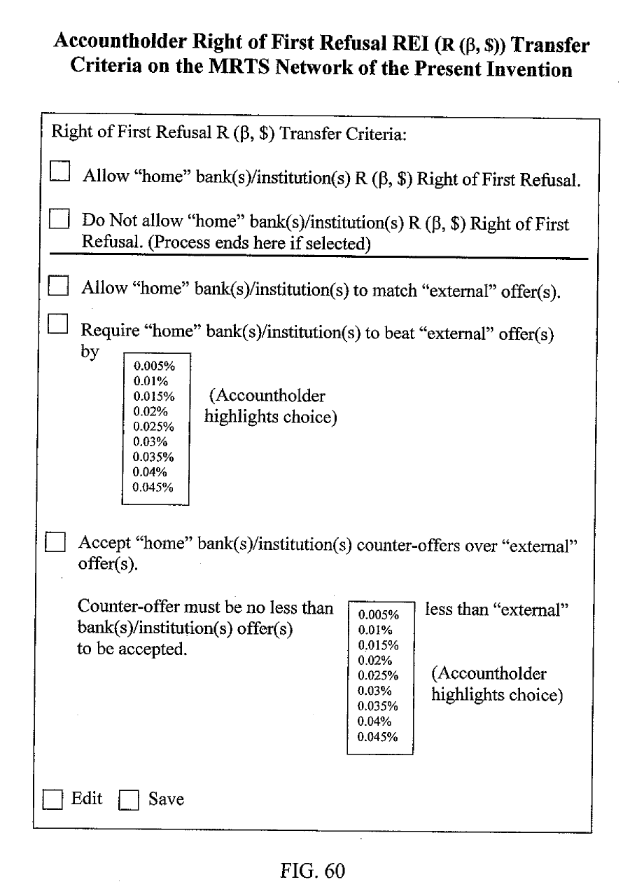

Via the MRTS, the accountholder or the MRTS Network initiates an R (β, $) transfer. The MRTS notifies the accountholder's “home” bank(s)/institution(s) of the initiation of the transfer process and of the associated transfer terms. Accompanying the R (β, $) transfer notification is a menu of choices by which the “home” bank(s)/institution(s) can choose to match, beat, or counter, the offer(s) received by the MRTS accountholder. If the “home” bank(s)/institution(s) chooses to match or beat the competing offer(s), the MRTS accountholder's R (β, $) will remain with the “home” bank(s)/institution(s). In the event the “home” bank(s)/institution(s) chooses to beat the competing offer (this may be the only option afforded the “home” bank(s)/institution(s) by an MRTS accountholder via the control panel shown in FIG. 60), a drop-down menu will appear allowing the “home” bank(s)/institution(s) to highlight the interest rate/yield it will offer.

If the MRTS accountholder has chosen to provide the “home” bank(s)/institution(s) with an opportunity to provide a counter-offer (see FIG. 60), the “home” bank(s)/institution(s) will have a “window” in which to provide its counter-offer. In the event the “home” bank(s)/institution(s) provides a counter-offer, the MRTS will decide, based on the MRTS accountholder's pre-specified criteria, whether to leave the MRTS accountholder's R (β, $) with the “home” bank(s)/institution(s) or transfer the MRTS accountholder's R (β, $) to an “external” bank(s)/institution(s).

Finally, the “home” bank(s)/institution(s) may choose not to match, beat, or counter, an offer received by the MRTS accountholder. In this case, the MRTS accountholder's R (β, $) will be transferred to an “external” bank(s)/institution(s) by the MRTS.

FIG. 38C is a flow chart depicting the Right-of-First Refusal Right(s) Transfer Process Counter-Offer Method in which the “home” bank(s)/institution(s) counter-offer is accepted and the MRTS accountholder's R (β, $) remains at the “home” bank(s)/institution(s). In this example, the MRTS accountholder has specified that the MRTS accept the “home” bank(s)/institution(s) counter-offer if it is two basis points (0.02%) or less lower than the “external” bank(s)/institution(s) offer(s). The MRTS notifies the MRTS accountholder's “home bank(s)/institution(s) of the offer received, and the accountholder's “home bank(s)/institution(s) counters with an acceptable offer based on the accountholder's pre-specified R (β, $) transfer criteria. Once notified of an acceptable counter-offer, the MRTS leaves the accountholder's R (β, $) at the “home” bank(s)/institution(s) and does not effect an R (β, $) transfer to an “external” bank(s)/institution(s).

FIG. 38D is a flow chart depicting the MRTS Right of First Refusal Right(s) Transfer Process Counter-Offer Method in which the “home” bank(s)/institution(s) counter-offer is rejected and the MRTS effects an R (β, $) transfer to an “external” bank(s)/institution(s). In this example the MRTS accountholder has also specified that the MRTS accept the “home” bank(s)/institution(s) counter-offer if it is two basis points (0.02%) or less lower than the “external” bank(s)/institution(s) offer(s). However, the “home” bank(s)/institution(s) counter-offer is more than two basis points (0.02%) lower than the offer received from an “external” bank(s)/institution(s), so the MRTS effects the an R (β, $) transfer on behalf of the MRTS accountholder with the “external” bank(s)/institution(s).

As in previous embodiments, the accountholder has constant access to all relevant account(s) information regarding balances, transfers, etc.

FIG. 39 is a flow chart depicting the Right-of-First Refusal Process supported on the MRTS Network of the present invention, enabling a system accountholder to provide a bank or institution holding the user's R (β, $) (“home” bank(s) or institution(s)) with the opportunity to match, beat, or counter, a competing offer prior to system accountholder or the MRTS Network transferring the R (β, $) from that institution.

Now, referring to FIG. 39, at Block A, an MRTS accountholder pre-approves the MRTS Network to contact the accountholder's “home” or “external” financial institution(s) from which a transfer of the accountholder's R (β, $) is being contemplated either by the accountholder or by the MRTS Network on the accountholder's behalf. At Block B, upon indication by an accountholder or by the MRTS Network of the intent to conduct a transfer of the accountholder's R (β, $), the institution(s) holding the accountholder's R (β, $) may be given the opportunity by the accountholder (time period determined by the accountholder) to match, beat, or counter a competing offer received by the accountholder via the MRTS Network. At Block C1, if the institution(s) holding the accountholder's R (β, $) matches or beats the competing offer(s) or, if a counter-offer is accepted based on the accountholder's pre-specified criteria (see FIG. 60), no transfer of the accountholder's R (β, $) is effected. At Block C2, however, if the institution(s) holding the MRTS accountholder's R (β, $) doesn't match or beat a competing offer(s) or, a counter-offer is rejected based on the accountholder's pre-specified criteria (see FIG. 60), then the R (β, $) transfer is effected via the MRTS Network. AT Block D, provided that the R (β, $) transfer is effected via Block C2, the MRTS Network provides the accountholder with a transaction log detailing all transfers of the accountholder's R (β, $).

### Foreign Entities and Foreign Exchange Conversion (GBP) Process Supported on the MRTS Network of the Present Invention

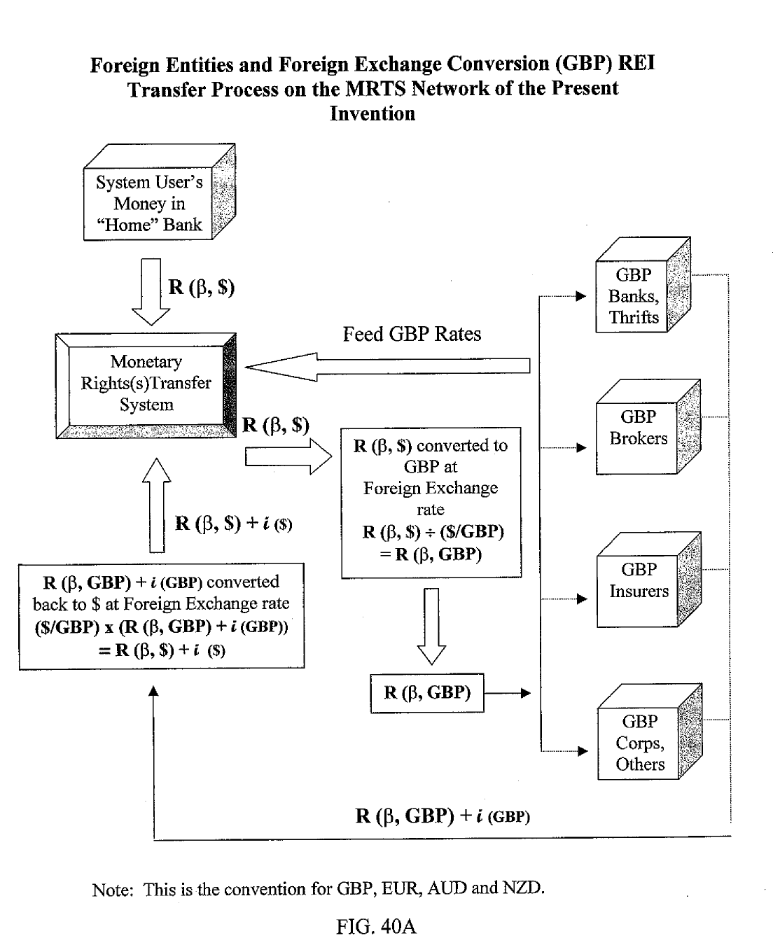

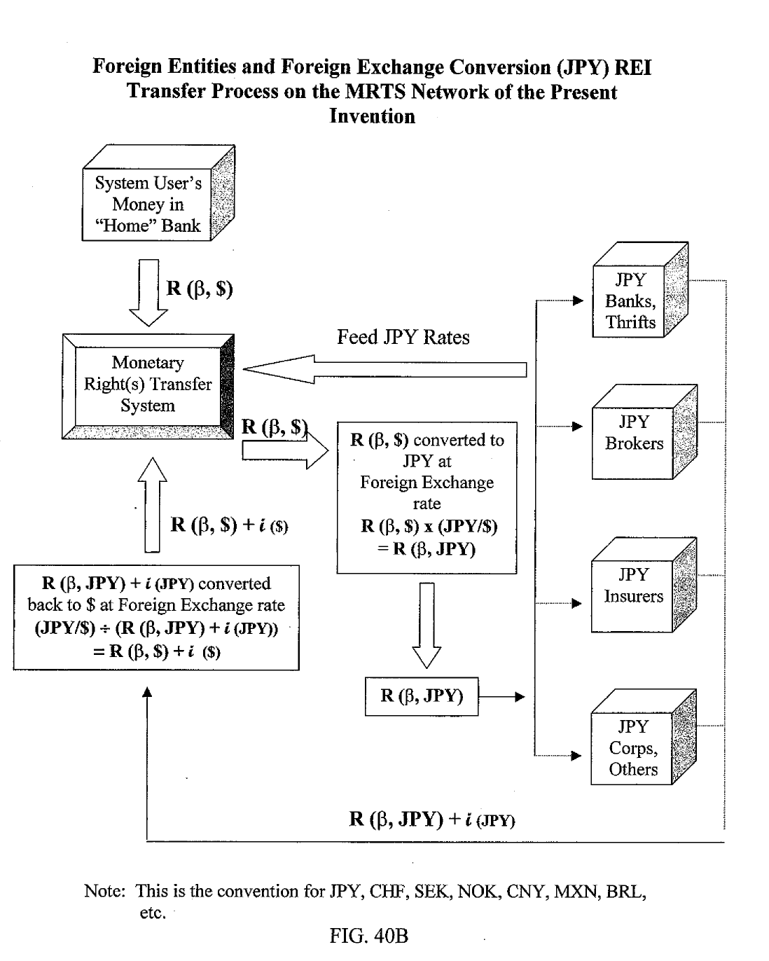

Referring to FIGS. 40A, 40B, 41, and 46, the Foreign Entities and Foreign Exchange Conversion REI Transfer Processes supported on the MRTS Network will now be described in greater detail.

FIG. 40A is a schematic representation of the Foreign Entities and Foreign Exchange Conversion (GBP) Process supported on the MRTS Network of the present invention, enabling a system user/accountholder to transfer R (β, $) to foreign participating institutions that provide rate feeds to the MRTS by first converting the R (β, $) to R (β, GBP) via a market-based foreign exchange conversion rate and then, upon transfer back to a domestic institution, by converting R (β, GBP)+(i, GBP) back to R (β, $)+(i, $) via a similar foreign exchange market-based conversion rate. Due to foreign exchange quoting convention, this example also serves for the Euro, the Australian Dollar and the New Zealand Dollar.

Similarly, FIG. 40 B is a schematic representation of the Foreign Entities and Foreign Exchange Conversion (JPY) Process supported on the MRTS Network of the present invention, enabling a system user/accountholder to transfer R (β, $) to foreign participating institutions that provide rate feeds to the MRTS by first converting the R (β, $) to R (β, JPY) via a market-based foreign exchange conversion rate and then, upon transfer back to a domestic institution, by converting R (β, JPY)+(i, JPY) back to R (β, $)+(i, $) via a similar foreign exchange market-based conversion rate. Due to foreign exchange quoting convention, this example also serves for the Swiss Franc, the Swedish Krona, the Norwegian Krona, the Chinese Yuan, the Mexican Peso, the Brazilian Real, and many other currencies.

FIGS. 40A-B is a schematic representation of the MRTS Foreign Entities and Foreign Exchange Conversion Process. This process allows an MRTS accountholder to effect foreign R (β, $) (and other right(s)) transfers via the system and methods of the present invention.

An MRTS accountholder maintains accounts at “home” institution(s) where the accountholder's individual, separable set of monetary rights (R (α . . . ι, $)) reside. The MRTS receives foreign rate feeds from various foreign financial institutions and ranks and displays them in the same manner as it ranks and displays domestic institutions' accounts and products.

The MRTS accountholder (or the MRTS, depending on the accountholder's pre-specified criteria) initiates an R (β, $) transfer to a foreign institution. Prior to receipt by a foreign institution, the R (β, $) is converted to R (β, foreign currency (fc)) by using a market-derived foreign exchange conversion rate which can be “time-stamped” to assure that the accountholder is receiving a fair conversion rate. After the conversion to R (β, fc), the transfer is placed with the foreign institution(s) until such time as the accountholder or the MRTS recalls the R (β, fc) or transfers the R (β, fc) to another institution in another country.

If the R (β, fc) is recalled, then R (β, fc)+(i, fc) must be converted back to R (β, $)+(i, $) by again utilizing a market-derived foreign exchange conversion rate, which can again be “time-stamped” to assure a fair conversion rate. Once this conversion back to R (β, $)+(i, $) has taken place the accrued interest is placed in the accountholder's MRTS account(s), the R (β, $) is restored to the accountholder's MRTS account(s) and the process can begin anew.

In the event the accountholder (or the MRTS) chooses to transfer the R (β, fc) to another foreign institution, the (i, fc) can be transferred as well or converted back to (i, $) and deposited in the accountholder's MRTS account. The R (β, fc) can be transferred to another institution and, if necessary, can be converted to another R (β, fc) via the aforementioned process.

Depending on the foreign currency conversion, there are two separate conventions that are used to convert the R (β, $) and the (i, $) to their foreign currency equivalents, and back; both are shown in FIGS. 40A-B.

FIG. 41 is a flow chart depicting the Foreign Entities and Foreign Exchange Conversion Processes, illustrated in FIGS. 40A and 40B, and enabling a system user/accountholder to make foreign transfers of R (β, $ (or other currencies)) in order to seek potentially higher rates/yields offered by foreign institutions.

Now, referring to FIG. 41, at Block A, participating foreign financial institutions feed rate/yield and account/product information to the MRTS Network databases where the information is collected and ranked both by the pre-specified criteria supplied by the accountholder and by the MRTS Network-specified criteria. At Block B, the MRTS accountholder indicates, via the MRTS Network, the desire to effect an R (β, $) to account(s)/product(s) at foreign financial institutions. At Block C, the MRTS Network transfers the accountholder's R (β, $) to foreign institution(s) account(s)/product(s) using a foreign exchange conversion rate to convert R (β, $) to R (β, foreign currency (fc)) and, per earlier embodiments, notifies the accountholder of rate/yield and other details of the foreign transfer(s). At Block D, when the accountholder wants to effect another transfer of what is now R (β, fc) back to an account/product within the U.S. (or other foreign country) the MRTS Network now converts R (β, fc)+i (fc) back to R (β, $)+i ($) (or other foreign currency) using a foreign exchange conversion rate and effects the transfer either at the command of the accountholder or automatically. At Block E, the MRTS Network then provides to the accountholder a transaction log detailing all R (β, $) transfers, amounts, rates/yields, etc., as well as all R (β, fc)+i (fc) earned along with all foreign exchange conversion rates used in the REI transfer process.

### Transaction Logs on the MRTS Network of the Present Invention

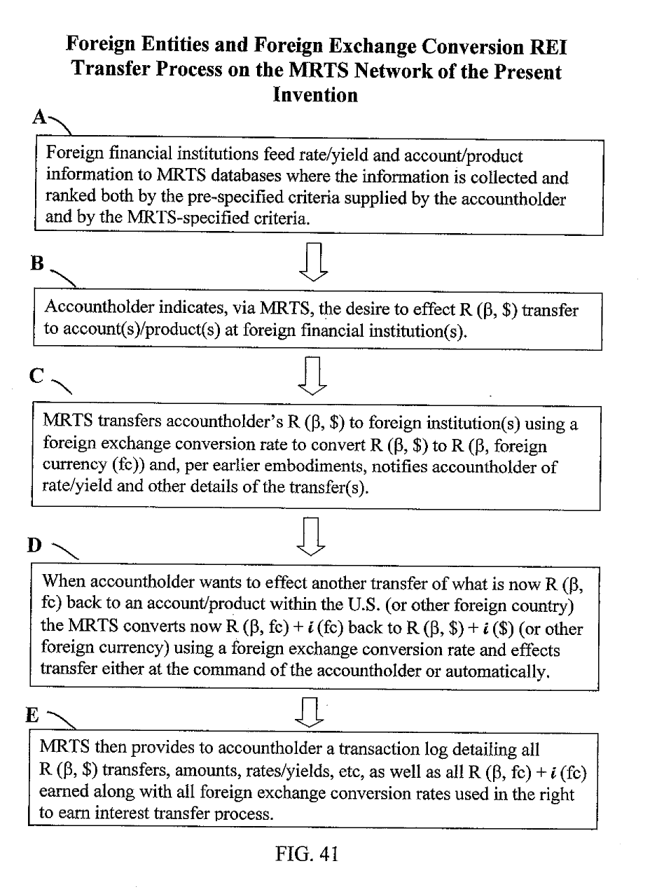

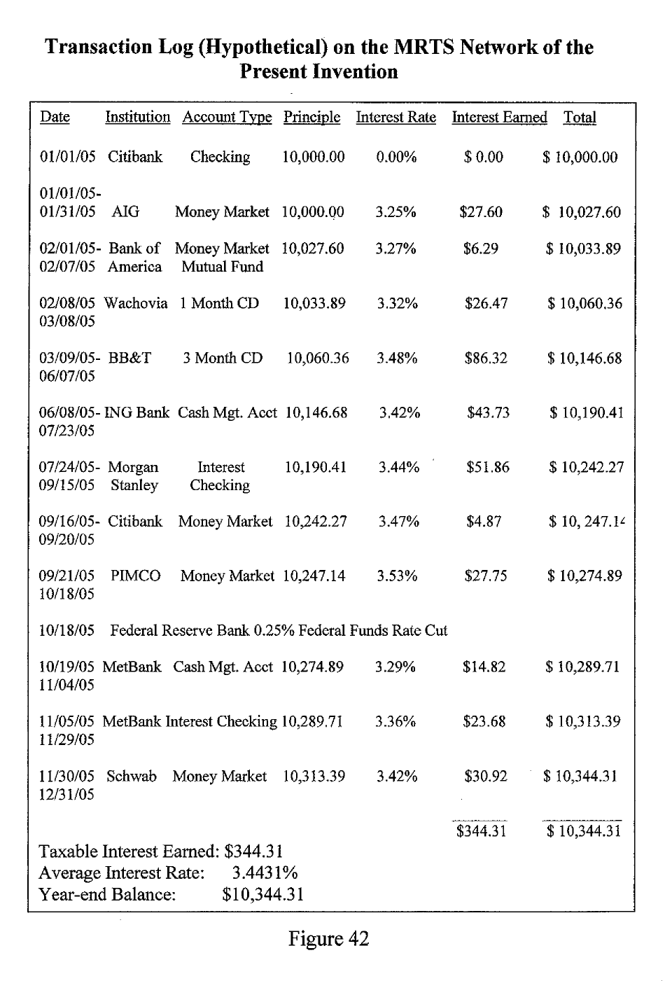

FIG. 42 is a schematic representation of an exemplary transaction log based on hypothetical transfers of R (β, $) by an user/accountholder on the MRTS Network.

The MRTS Transaction Log provides the pertinent details of each right(s) transfer, in this case the right to earn interest R (β, $) possessed by an owner of money. While the R (β, $) transfer can be accomplished through a number of different methods employed by the MRTS, the relevant details of each right(s) transfer can be viewed by an MRTS accountholder in the transaction log.

The transaction log includes, but is not limited to, the following information: the date of each right(s) transfer, the institution to which the right(s) was transferred, the type of account or product where the right(s) was placed, the amount (principle) of the right(s) transfer, the interest rate or yield afforded by the account or product, the total interest earned for each right(s) transfer, and the accountholder's total right(s) transfer balance (R (β, $)+(i)). In addition, the transaction log may include the accountholder's total taxable interest earned, the average interest rate/yield received on R (β, $) transfers and a periodic balance of balance (R (β, $)+(i)).

The transaction log may also include additional entries that denote central bank rate cuts/hikes and other information that may help to explain large interest rate/yield discrepancies on the accountholder's transaction log.

### GUI-Based Control Panels Enabling the Delivery of Services On the MRTS Network of the Present Invention

Having described the structure, function and operation of the MRTS Network of the illustrative embodiment, it is appropriate at this juncture to briefly describe some exemplary GUI-Based Control Panels that can be used to enable the delivery the services supported on the MRTS Network of the present invention.

FIG. 43 is a schematic representation of an exemplary Accountholder Information Collection and Storage form that can be used by the MRTS Network of the present invention, in order to collect and store relevant information relating to the opening and maintenance of an account on the MRTS Network of the present invention.

FIG. 44 is a schematic representation of an exemplary Accountholder Preference Collection and Storage form that can be used by the MRTS Network to allow an accountholder to supply account data to the system, rank display and transfer criteria, and provide institution and/or account/product data for the accountholder's Preferred Partner Network (PPN). The first section of the form allows an accountholder to establish from which registered account(s)/product(s) to transfer the accountholder's R (β, $). The second part of the form allows an MRTS accountholder to rank the various R (β, $) transfer criteria that will be used in the aforementioned methods and their various iterations to transfer an accountholder's R (β, $). The final form allows an MRTS accountholder to establish Preferred Partner Network(s) that can specify to which institutions' accounts/products to transfer accountholder's R (β, $).

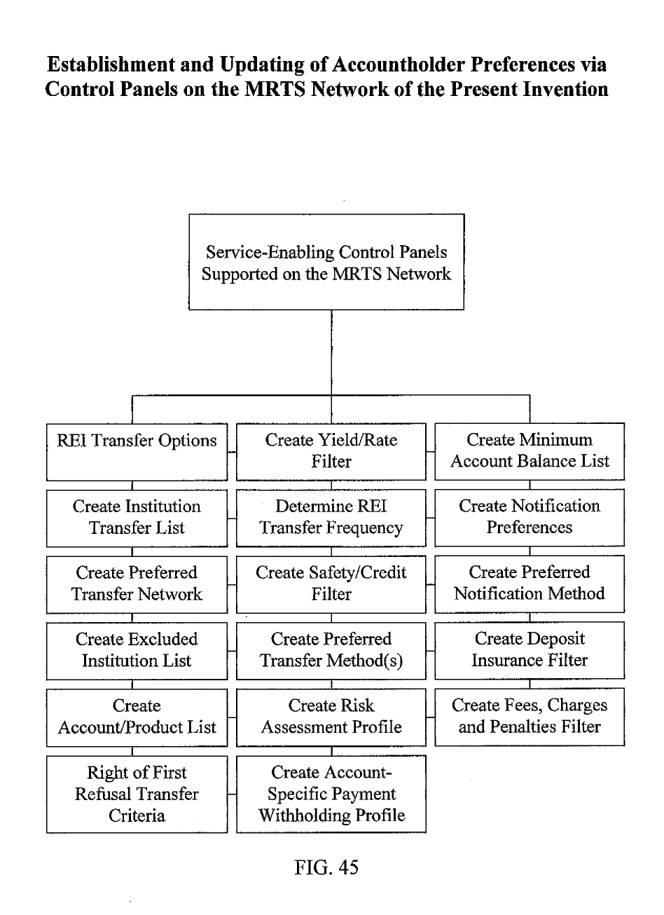

FIG. 45 is a schematic representation of a Web-based control panel that allows an accountholder on the MRTS Network to specify the method(s) by which to transfer the accountholder's right to earn interest (R (β, $)) on accounts registered with the MRTS Network. The first section of the form allows an accountholder to establish from which registered account(s)/product(s) to transfer the accountholder's R (β, $). The second part of the form allows an MRTS accountholder to rank the various R (β, $) transfer criteria that will be used in the aforementioned methods and their various iterations to transfer an accountholder's R (β, $). The final form allows an MRTS accountholder to establish Preferred Partner Network(s) that can specify to which institutions' accounts/products to transfer accountholder's R (β, $).

This is the MRTS Network control panel by which an accountholder establishes R (β, $) transfer options. This panel allows an accountholder to establish preferences for conducting the accountholder's R (β, $) transfers by signifying which institutions and networks to include and exclude in the R (β, $) transfer process.

FIG. 46 is a schematic representation of a Web-based control panel that allows an accountholder on the MRTS Network to specify which institutions to include when the MRTS ranks, for the purpose of facilitating a R (β, $) transfer, participating institutions via absolute rate/yield, the accountholder's pre-specified criteria and/or the system's criteria.

FIG. 47 is a schematic representation of an MRTS Network Web-based control panel that allows an MRTS accountholder to choose certain institutions (or groups of institutions) to which to transfer the accountholder's R (β, $) (or other right(s)). When an accountholder chooses a certain group, a drop-down menu appears listing all participating institutions in that particular category. As the accountholder highlights individual institutions they appear in the “Institutions Added” list. When an accountholder has completed this process the accountholder then has the option to “edit” or “save” the choices made. In the future, the accountholder can return to this control panel to edit the “Institutions Added” list at any time.

FIG. 48 is a schematic representation of a Web-based control panel that allows an accountholder on the MRTS Network to specify which banks and/or institutions, and/or accounts and products, to include in the accountholder's Preferred Partner Network (PPN) for the purpose of effecting transfers of R (β, $). The mechanics of the control panel are very similar to those of the control panel shown in FIG. 47.

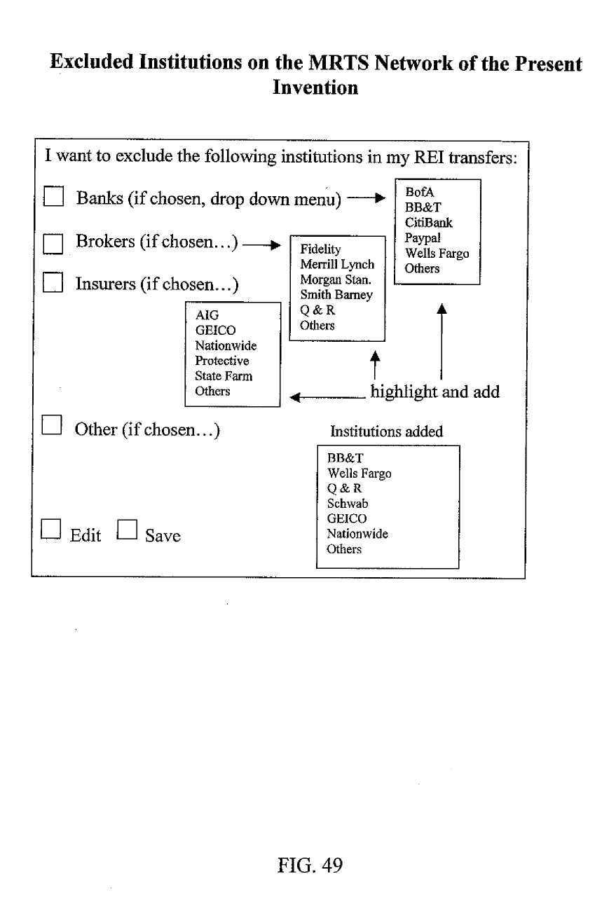

FIG. 49 is a schematic representation of a Web-based control panel that allows an accountholder on the MRTS Network to exclude certain institutions, or groups of institutions, from consideration for ranking and from consideration for receiving R (β, $) transfers. As in previous control panels, the accountholder can save these preferences and then come back at any point in the future and edit them.

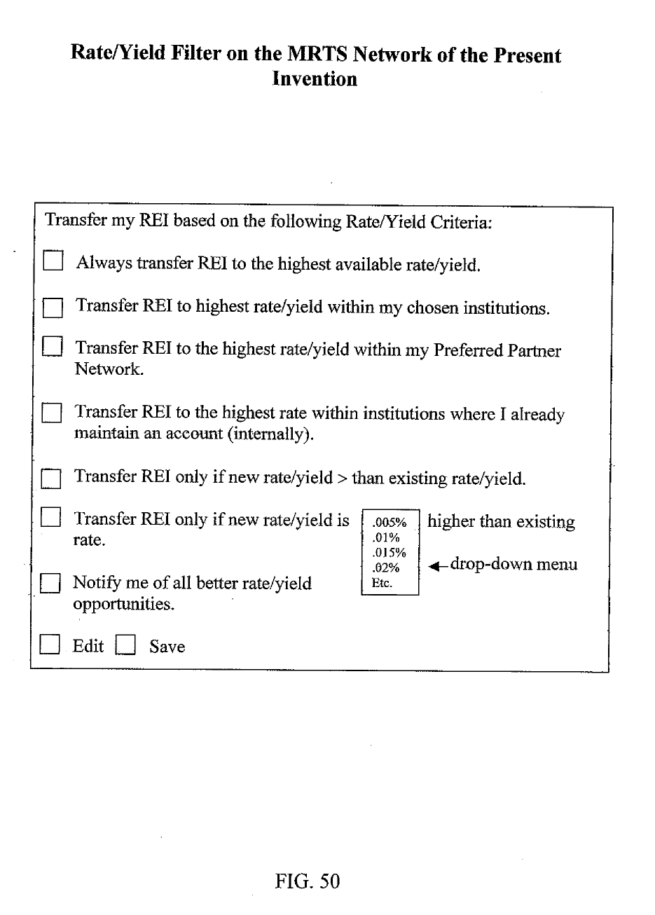

FIG. 50 is a schematic representation of a Web-based control panel that allows an accountholder on the MRTS Network to specify the various interest rate/yield criteria as they relate to R (β, $) transfers via the system of the present invention. The MRTS Network Rate/Yield Filter control panel allows an MRTS accountholder to establish criteria based on interest rates/yields by which to conduct the accountholder's R (β, $) transfers. The criteria established in this control panel will be important in ranking institutions' accounts/products either by the other pre-specified criteria supplied by the accountholder or by the criteria utilized by the MRTS to rank institutions' accounts and products. After making the various selections on this control panel, the accountholder can then “edit” or “save” them. As with other control panel embodiments, the accountholder can always come back to this panel at any point in the future to edit saved choices.

FIG. 51 is a schematic representation of a Web-based control panel that allows an accountholder on the MRTS Network to specify the frequency with which automatic R (β, $) transfers are effected on the accountholder's behalf by the system. This MRTS Network control panel allows an accountholder to establish the frequency with which the MRTS conducts automated transfers on the accountholder's behalf. After making the desired selections, the accountholder can then “edit” or “save” the selections as per previous control panels.

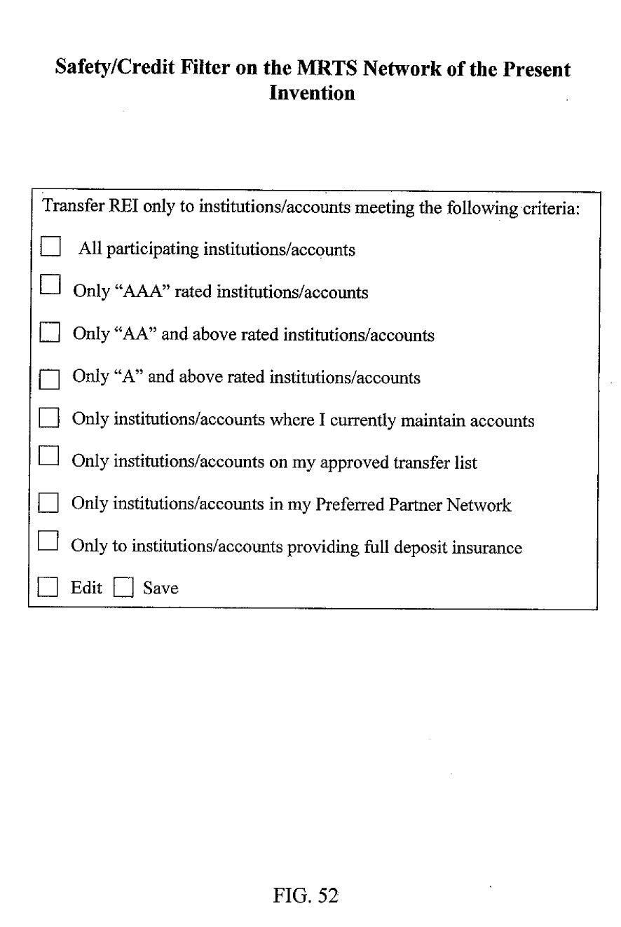

FIG. 52 is a schematic representation of a Web-based control panel that allows an accountholder on the MRTS Network to specify minimum safety/credit criteria for institutions and/or accounts and products to which to transfer accountholder's R (β, $). This MRTS Network Safety/Credit Filter control panel enables an accountholder to determine the credit rating(s) or safety ratings for institutions with which to conduct R (β, $) transfers. The MRTS Network will also take these selections into account when ranking and displaying either transfer methods employing the accountholder-specified transfer criteria or the MRTS-specified transfer criteria, where the MRTS-specific criteria can exclude all institutions with which the accountholder chooses not to conduct R (β, $) transfers, allowing this one critical aspect to override potential selections by the MRTS-specific criteria.

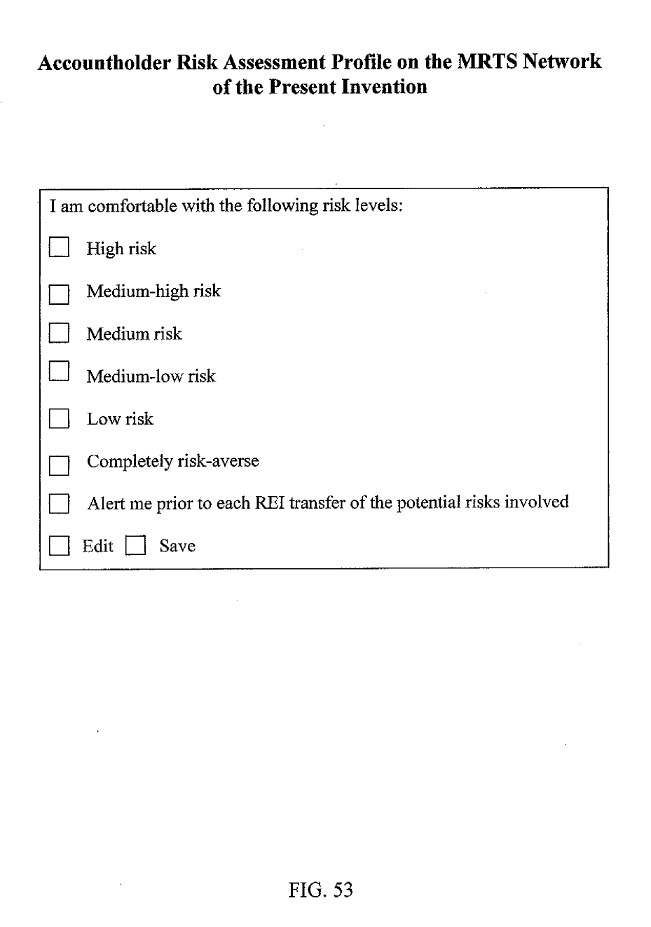

FIG. 53 is a schematic representation of a Web-based control panel that allows an accountholder on the MRTS Network to establish R (β, $) transfer risk levels that will serve to govern automatic (and other) transfers of R (β, $) via the MRTS Network. This MRTS Network control panel that allows an accountholder to define a risk profile that will then be taken into account when displaying and ranking either accountholder-specified R (β, $) transfer criteria and/or MRTS-specified transfer criteria.

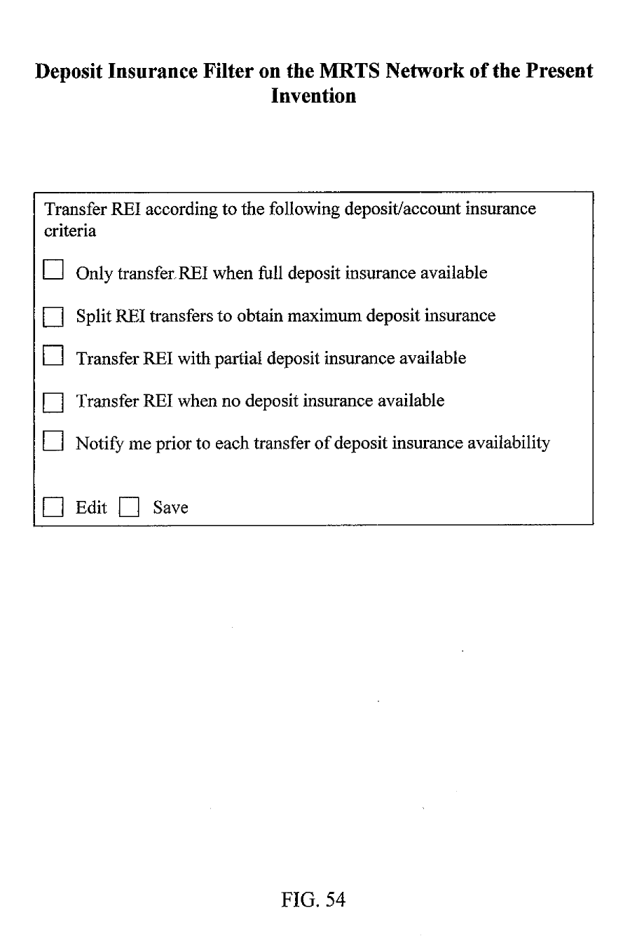

FIG. 54 is a schematic representation of A Web-based control panel n for a Deposit Insurance Filter supported on the MRTS Network, allowing an accountholder on the MRTS Network to establish parameters regarding deposit insurance afforded to the transfers of the right to earn interest (R (β, $)). This MRTS Network Deposit Insurance Filter control panel allows an accountholder to specify R (β, $) transfer criteria by which an accountholder can receive the maximum allowable deposit insurance afforded by each account/product to which the accountholder's R (β, $) is transferred. Conversely, the accountholder can also opt to forego some, or all, of the potential deposit insurance available in return for seeking higher interest rates/yields. As is the case with other control panels, the accountholder can choose to either “edit” or “save” choices made and can always come back at any point in the future to modify these choices.

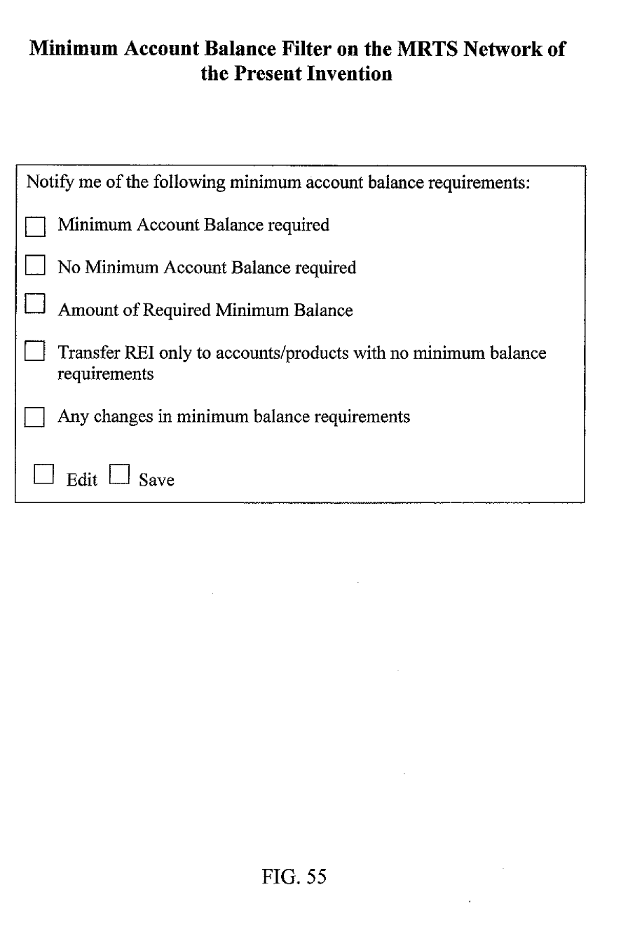

FIG. 55 is a schematic representation of a Web-based control panel for the MRTS Minimum Account Balance Filter supported on the MTLRS Network, allowing an accountholder to establish parameters related to minimum account balances for effecting transfers of the accountholder's right to earn interest (R (β, $)). This MRTS Network control panel allows an accountholder to establish R (β, $) transfer criteria based on whether or not account(s)/product(s) require a minimum balance to avoid fees and/or penalties. By pre-specifying this R (β, $) transfer criteria, an accountholder can assure that no minimum account balance fees or penalties are incurred in the R (β, $) transfer process or, an accountholder may choose to be notified of any minimum balance requirement and may then proceed with an R (β, $) transfer irrespective of any associated fees and/or penalties. As is the case with other control panels, the accountholder can choose to either “edit” or “save” choices made and can always come back at any point in the future to modify these choices.

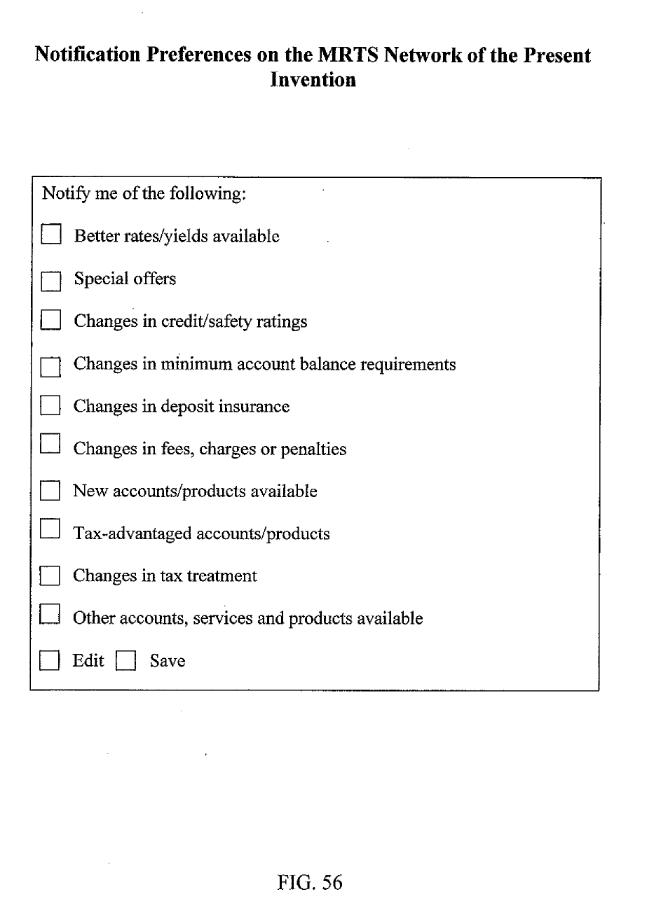

FIG. 56 is a schematic representation of a Web-based control panel for Notification Preferences that allows an accountholder on the MRTS Network to establish criteria, for notification of opportunities and offers supported on the MRTS Network. This MRTS Network control panel by which an accountholder can choose to receive MRTS notification of any potential offerings, new products, special offers, or changes in any of the other criteria that may influence an accountholder's an R (β, $) transfer decisions. The accountholder can then “edit” or “save” these choices and can come back to this control panel at any point in the future to modify choices.

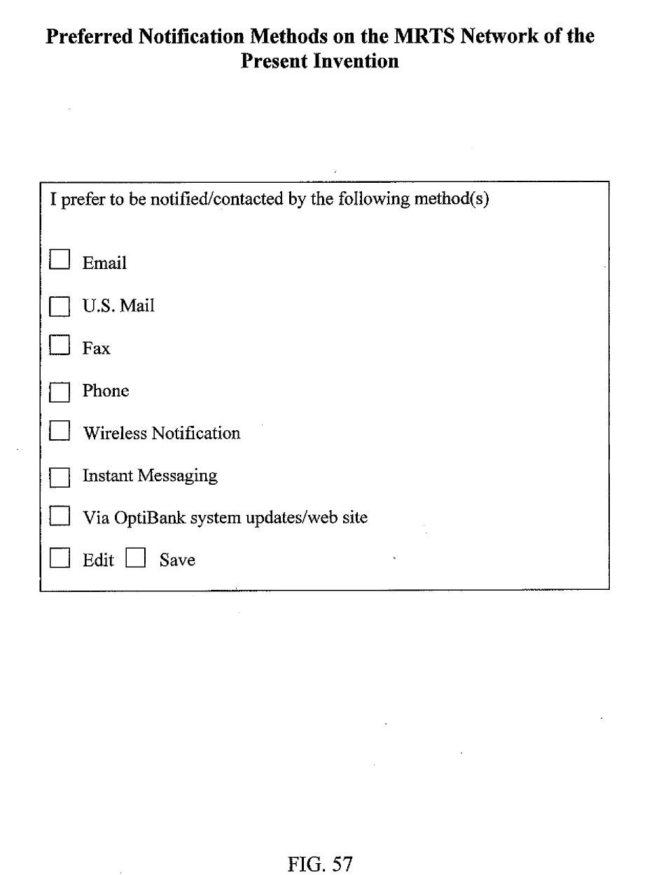

FIG. 57 is a schematic representation of a Web-based control panel for Preferred Notification Methods that allows an accountholder to specify method(s) by which an accountholder on the MRTS Network prefers to be contacted/notified. This MRTS Network control panel allows an accountholder to define preferred notification methods by the MRTS. The choices made in this control panel will dictate how the MRTS contacts the accountholder to apprise the accountholder of R (β, $) transfers, offers, tax statements, etc. As with other control panels, the accountholder can edit and save these changes.

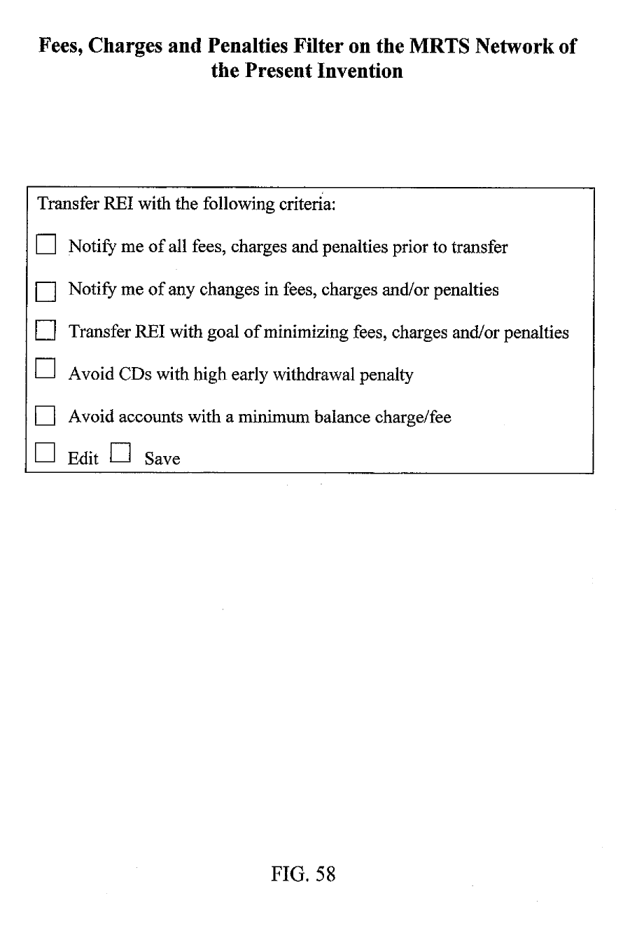

FIG. 58 is a schematic representation of a Web-based control panel for the Fees, Charges and Penalties Filter that allows an accountholder on the MRTS Network to establish criteria related to fees, charges and penalties for notification and transfer of the accountholder's right to earn interest (R (β, $)). This MRTS Network control panel, by which an accountholder can define terms under which the MRTS notifies the accountholder of potential charges, fees, and/or penalties associated with any potential R (β, $) transfer(s) or with any account(s)/product(s) ranked and displayed by the MRTS. It also allows an accountholder to establish criteria by which to conduct potential R (β, $) transfers with an objective of avoiding or minimizing charges, fees and/or penalties. An accountholder can then “edit” and/or “save” these preferences for future revision.

FIG. 59 is a schematic representation of Web-based control panel for the Preferred Transfer Method(s) that allows an accountholder on the MRTS Network to specify the preferred method(s) by which to transfer the accountholder's right to earn interest (R (β, $)). This MRTS Network control panel allows an accountholder to specify the preferred means by which to transfer the accountholder's R (β, $) (or other monetary right(s)). The MRTS accountholder can choose the last option to always conduct transfers manually, or the accountholder can “edit” and “save” choices at any time to reflect a change in the accountholder's preferred transfer method.

FIG. 60 is a schematic representation for a Web-based control panel for the Accountholder Right-of-First Refusal REI (R (β, $)) Transfer Criteria that allows an accountholder on the MRTS Network to establish criteria which will (will not) allow “home” bank(s)/institution(s) to match, beat, or counter, offers received by an MRTS accountholder from “external” bank(s)/institution(s). This MRTS Network control panel allows an MRTS accountholder to pre-establish criteria that will or will not allow the accountholder's “home” bank(s)/institution(s) to match, beat, or counter, offers from “external” bank(s)/institution(s) via the MRTS Right-of-First Refusal REI (R (β, $)) Transfer Process.

First the MRTS accountholder can decide whether or not to allow “home” bank(s)/institution(s) to have the opportunity to match, beat or counter offers received via the MRTS from “external” institutions. Assuming the MRTS accountholder chooses to accept counter-offers, the MRTS accountholder can then allow a “home” bank(s)/institution(s) to only match “external” offers, require the “home” bank(s)/institution(s) to beat “external” offers, or accept the “home” bank(s)/institution(s) counter-offers.

If the MRTS accountholder allows a “home” bank(s)/institution(s) to beat “external” offers, then a drop-down menu appears that allows the accountholder to determine by what amount of basis points the “home” bank(s)/institution(s) must beat the “external” offer to retain the accountholder's R (β, $). The accountholder highlights the choice from the drop-down menu.

If the MRTS accountholder allows the “home” bank(s)/institution(s) to make a counter-offer(s), again a drop-down menu appears that allows the accountholder to determine by what amount of basis points the “home” bank(s)/institution(s) offer(s) can be less than that of the “external” offer(s) (If the amount is 0.000% then the accountholder would choose the “match” option), and still be acceptable to the MRTS accountholder. Again, the accountholder chooses this amount from the drop-down menu.

These choices are not mutually exclusive, as the MRTS accountholder's choices here are not known to the “home” bank(s)/institution(s), and the “home” bank(s)/institution(s) must make their best offer and see if it is accepted based on the MRTS accountholder's criteria. However, if the MRTS accountholder is operating in a completely manual mode, the accountholder may override the pre-established criteria and allow an R (β, $) transfer to occur that would normally be rejected by the MRTS accountholder (or the MRTS) based on the accountholder's pre-established criteria.

As in previous embodiments, after making choices in this control panel the accountholder then can either edit or save choices made.

FIG. 61 is a schematic representation for a Web-based control panel for the Account-Specific Payment Method Withholding the Right to Earn Interest (R (β, $)) until payment Due Date Pre-Specifications that allows an accountholder on the MRTS Network to pre-specify from which account(s) to make payments withholding R (β, $) until a payment's due date, and to pre-specify whether to make said payment by electronic means or by manual means. This MRTS Network control panel allows an MRTS accountholder to pre-designate from which accounts to make bill payments (or payments of any type) via the MRTS Account-Specific Payment Method Withholding the Right to Earn Interest (R (β, $)) until Payment Due Pre-Specifications.

This control panel provides an MRTS accountholder with specific payment options with (R (α . . . ι, $)−R (β, $)) being paid by an MRTS accountholder at any time prior to a bill's actual payment due date, allowing the accountholder to transfer the withheld R (β, $) and earn interest until the actual payment due date. The accountholder chooses from accounts already registered with the MRTS by the accountholder (See FIG. 44) from which to make the payments withholding the right to earn interest (R (β, $)) until the payment(s) due date.

Then the MRTS accountholder pre-specifies whether to pay electronically, which may be effected either by the MRTS or by the accountholder's “home” bank(s)/institution(s), or whether to pay manually from one (or more) of the already-specified accounts.

Should the MRTS accountholder choose to pay manually, the MRTS, having already been provided the accountholder's account number(s) with each bill sender, the bill sender's contact information, and the proper authorization to establish contact with each bill sender, will automatically withhold the accountholder's R (β, $) from payments the accountholder chooses to make manually until the actual payment(s) due date(s) at which time the withheld R (β, $) will be restored to the accountholder's initial payment of (R (α . . . ι, $)−R (β, $)). This will allow MRTS accountholders who are more comfortable paying bills manually to still withhold, and transfer, their R (β, $) until each payment's due date.

As in previous embodiments of control panels, the accountholder always has the ability to edit and/or save any choices made in this panel.

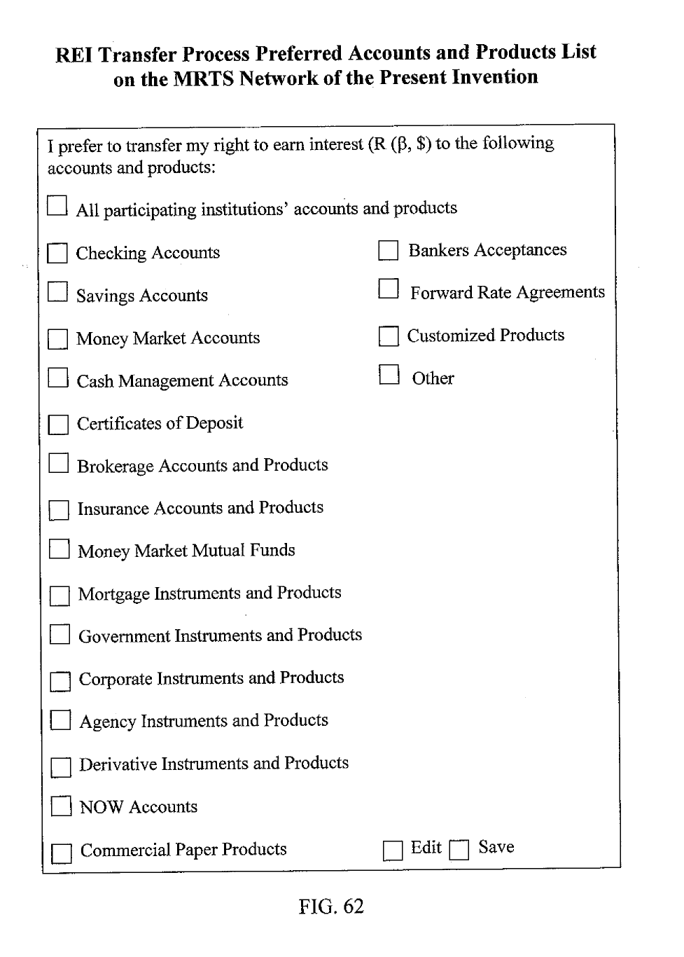

FIG. 62 is a schematic representation for a Web-based control panel for the Right(s) Transfer Preferred Accounts and Products List that allows an accountholder on the MRTS Network to specify to which accounts and products the accountholder prefers to transfer the accountholder's monetary right to earn interest R (β, $) possessed by an owner (or borrower) of money. This MRTS Network control panel allows an MRTS accountholder to pre-specify types of accounts and products to which to transfer the accountholder's R (β, $). The first option allows the accountholder to pre-specify all participating institutions' accounts and products, which would then preclude all of the other options. However, if an accountholder prefers to pick accounts and products individually, then the accountholder may do so. Once the accountholder has made the preferred choices, as in previous embodiments of the MRTS control panels, the accountholder can at any time either edit or save selections made in this control panel.

It is understood that while the illustrative embodiments of the MRTS Network of the present invention have been described using the example(s) of an accountholder transferring its right to earn interest (R (β, $)) to one “external” bank or financial institution under the accountholder's management, it is understood that in alternative embodiments such monetary right(s) can be transferred among multiple “external” financial institutions (and internally among the “home” institution) in order to maximize earned interest. In such embodiments, the MRTS Network of the present invention will track and account for all such R (β, $) (and other right(s)) transfers as well as the netting of earned interest.

Also, it is understood that the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

What is claimed is:

1. A method of capturing interest on the value of transferred monetary rights managed on an Internet-based Monetary Rights Transfer (MRT) Network, and associated with an amount of money owned by an owner and held in a first account and having a monetary value represented on a stored value device held by a holder and provided by an issuer, wherein said first account is maintained at a home financial institution by said issuer of said stored value device and, wherein said home financial institution is associated with said MRT network operably connected to the infrastructure of the Internet, and said home financial institution, or an external financial institution associated with said MRT network, maintains a second account, interest bearing, for said owner of said amount of money, said method comprising the steps of:
(a) said home financial institution maintaining said first account for said issuer of said stored value device;
(b) said owner of said amount of money, owning said amount of money in said first account maintained by said home financial institution for said issuer of said stored value device;
(c) said MRT network recognizing and accounting for an unbundled and individually transferable set of monetary rights associated with said amount of money held in said first account and possessed by said owner, wherein said unbundled and individually transferable monetary rights (R (α . . . ι, $)) are selected from the group consisting of a monetary right to invest ((R (α, $)), a monetary right to earn interest (R (β, $)), a monetary right to use as collateral (R (χ, $)), a monetary right to hold money as a store of value (R (δ, $)), a monetary right to make purchases (R (ε, $)), a monetary right to make payments (R (φ, $)), a monetary right to lend (R (γ, $));
(d) said home financial institution or an external financial institution associated with said MRT network, maintaining said second account for said owner of said amount of money represented by said monetary value represented in said stored value device;
(e) said owner of said amount of money, transferring from said first account to said second account, one or more of said monetary rights to earn interest (R (β, $)), to invest (R (α, $)) and to lend (R (γ, $)) associated with said amount of money held in said first account and represented by said monetary value represented in said stored value device, while said non-transferred subset of monetary rights associated with said amount of money remain in said first account and serve as full, non-leveraged collateral for said transferred monetary rights; and
(f) said owner of said amount of money, earning an amount of interest on said value of said transferred monetary rights and said amount of interest being deposited in said second account, while said holder of said stored value device enjoys full use of said monetary value represented in said stored value device and held in said first account represented by the said non-transferred subset of monetary rights associated with said amount of money, including the right to make payments (R (φ, $)), the right to make purchases (R (ε, $)), and the right to hold money as a store of value (R (δ, $)).

2. The method of claim 1, wherein said first account is a bank account or an escrow account.

3. The method of claim 1, wherein said first account and said second account are maintained by said home financial institution.

4. The method of claim 1, wherein said first account is maintained by said home financial institution and said second account is maintained by said external financial institution.

5. The method of claim 1, wherein said owner of said amount of money may be a purchaser, or said holder, of said stored value device.

6. The method of claim 1, wherein said owner of said amount of money is said holder of said monetary value represented in said stored value device.

7. The method of claim 1, wherein said owner of said amount of money is separate from said holder of said monetary value represented in said stored value device.

8. The method of claim 1, wherein step (f) further comprises, when said holder of said stored value device exercises one or more of the remaining non-transferred monetary rights associated with said monetary value represented in said stored value device and held in said first account, the value of said transferred subset of monetary rights in said second account is automatically reduced commensurately by the value of the one or more exercised, non-transferred monetary rights associated with said monetary value in said first account.

9. The method of claim 1, wherein during step (f), said holder of said monetary value represented in said stored value device exercises said monetary right to make purchases (R (ε, $)) and uses the whole or partial monetary value represented in said stored value device by the non-transferred subset of monetary rights held in said first account to make purchases.

10. The method of claim 1, wherein during step (f), said holder of said monetary value represented in said stored value device exercises said monetary right to make payments (R (φ, $)) and uses said whole or partial monetary value represented in said stored value device by the non-transferred subset of monetary rights held in said first account to make payments.

11. The method of claim 1, wherein during step (f), said holder of said monetary value represented in said stored value device exercises said monetary right to hold money as a store of value (R (δ, $)) and uses said whole or partial monetary value represented in said stored value device by the non-transferred subset of monetary rights held in said first account to hold money as a store of value.

12. The method of claim 1, wherein said first account is selected from the group consisting of all demand and investment accounts including, but not limited to, checking accounts, savings accounts, money market accounts, stored value accounts and devices, brokerage accounts and products, escrow accounts, insurance accounts and products, certificates of deposit and other savings accounts/products, retirement accounts and products, and any other financial account or product.

13. The method of claim 1, wherein said second account is selected from the group consisting of checking accounts, savings accounts, money market accounts, stored value accounts and devices, stored value accounts, brokerage accounts and products, escrow accounts, insurance accounts and products, certificates of deposit and other savings accounts/products, retirement accounts and products, and any other accounts or products that pay interest.

14. The method of claim 1, wherein said home financial institution is an issuer of said stored value device, and said first account is a bank or escrow account maintained by said issuer of said stored value device.

15. The method of claim 1, wherein said stored value device is selected from a group consisting of prepaid devices including debit cards, gift cards, and other stored value products with transactional capabilities and, in which, monetary value is represented.

16. The method of claim 1, which further comprises: said holder of said stored value device exercising one or more of the remaining non-transferred monetary rights associated with said whole or partial monetary value represented in said stored value device by the non-transferred subset of monetary rights in said first account to do one or more of the following activities selected from the group consisting of making purchases, making payments, holding money as a store of value, or using money as collateral.

17. The method of claim 1, wherein a transactional log is generated for each transactional activity by said holder or by said purchaser of said stored value product on said Internet-based MRT network.
